(19) United States
(12) Patent Application Publication
(10) Pub. No.: US 2023/0007504 A1
(43) Pub. Date: Jan. 5, 2023

(54) METHOD AND APPARATUS FOR SELECTION OF RADIO LINK MONITORING REFERENCE RESOURCE IN NETWORK COOPERATIVE COMMUNICATIONS

(71) Applicant: Samsung Electronics Co., Ltd., Suwon-si (KR)

(72) Inventors: Youngrok JANG, Suwon-si (KR); Youngbum KIM, Suwon-si (KR); Ameha Tsegaye ABEBE, Suwon-si (KR); Seongmok LIM, Suwon-si (KR); Hyoungju JI, Suwon-si (KR)

(21) Appl. No.: 17/837,505

(22) Filed: Jun. 10, 2022

(30) Foreign Application Priority Data
Jun. 10, 2021 (KR) 10-2021-0075579

(51) Int. Cl. H04W 16/28; H04W 24/10; H04L 5/00; H04W 72/02; H04W 72/04

(52) U.S. Cl. CPC H04W 16/28; H04W 24/10; H04L 5/0051; H04W 72/02; H04W 72/046

(57) ABSTRACT

A method of selecting a reference signal for radio link monitoring in a wireless communication system and an apparatus for performing the same are provided. The method performed by a terminal includes receiving an activation information for indicating at least one transmission configuration indicator (TCI) state for a control resource set (CORESET), identifying a first plurality of TCI states corresponding to a first CORESET and a second plurality of TCI states corresponding to a second CORESET, based on the activation information, and selecting a reference signal for radio link monitoring based on the first plurality of TCI states and the second plurality of TCI states.

### CROSS-REFERENCE TO RELATED APPLICATION(S)

This application is based on and claims priority under 35 U.S.C. § 119(a) of a Korean patent application number 10-2021-0075579, filed on Jun. 10, 2021, in the Korean Intellectual Property Office, the disclosure of which is incorporated by reference herein in its entirety.

### BACKGROUND

### 1. Field

The disclosure relates to operations of a user equipment (UE) and a base station (BS) in a wireless communication system. More particularly, the disclosure relates to a method of selecting a reference signal for radio link monitoring in a network coordinate communication and an apparatus for performing the same.

### 2. Description of Related Art

5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz bands (for example, 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of effectively providing a service in a wireless communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving an activation information for indicating at least one transmission configuration indicator (TCI) state for a control resource set (CORESET), identifying a first plurality of TCI states corresponding to a first CORESET and a second plurality of TCI states corresponding to a second CORESET, based on the activation information, and selecting a reference signal for radio link monitoring based on the first plurality of TCI states and the second plurality of TCI states.

In accordance with another aspect of the disclosure, a terminal of a wireless communication system is provided. The terminal includes a transceiver and a processor coupled with the transceiver. The processor is configured to receive, via the transceiver, an activation information for indicating at least one transmission configuration indicator (TCI) state for a control resource set (CORESET), identify a first plurality of TCI states corresponding to a first CORESET and a second plurality of TCI states corresponding to a second CORESET, based on the activation information, and select a reference signal for radio link monitoring based on the first plurality of TCI states and the second plurality of TCI states.

In accordance with another aspect of the disclosure, a method performed by a BS in a wireless communication system is provided. The method includes transmitting an activation information for indicating at least one transmission configuration indicator (TCI) state for a control resource set (CORESET), and identify that a terminal selects a reference signal for radio link monitoring based on the first plurality of TCI states and the second plurality of TCI states. The first plurality of TCI states corresponds to a first CORESET and the second plurality of TCI states corresponds to a second CORESET, based on the activation information.

In accordance with another aspect of the disclosure, a base station of a wireless communication system is provided. The base station includes a transceiver and a processor coupled with the transceiver. The processor is configured to transmit, via the transceiver, an activation information for indicating at least one transmission configuration indicator (TCI) state for a control resource set (CORESET), and identify that a terminal selects a reference signal for radio link monitoring based on the first plurality of TCI states and the second plurality of TCI states. The first plurality of TCI states corresponds to a first CORESET and the second plurality of TCI states corresponds to a second CORESET, based on the activation information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system, according to an embodiment of the disclosure;

FIG. 2 illustrates frame, subframe, and slot structures in a wireless communication system, according to an embodiment of the disclosure;

FIG. 3 illustrates an example of a configuration of a bandwidth part in a wireless communication system, according to an embodiment of the disclosure;

FIG. 4 illustrates an example of a configuration of a control region of a downlink control channel in a wireless communication system, according to an embodiment of the disclosure;

FIG. 5A illustrates a structure of a downlink control channel in a wireless communication system, according to an embodiment of the disclosure;

FIG. 5B illustrates a case in which the UE may have a plurality of physical downlink control channel (PDCCH) monitoring locations within a slot through a span in a wireless communication system, according to an embodiment of the disclosure;

FIG. 6 illustrates an example of a discontinuous reception (DRX) operation in a wireless communication system, according to an embodiment of the disclosure;

FIG. 7 illustrates an example of BS beam allocation according to a transmission configuration indication (TCI) state configuration in a wireless communication system, according to an embodiment of the disclosure;

FIG. 8 illustrates an example of a method of allocating TCI states for a PDCCH in a wireless communication system, according to an embodiment of the disclosure;

FIG. 9 illustrates a TCI indication medium access control (MAC) control element (CE) signaling structure for a PDCCH demodulation reference signal (DMRS) in a wireless communication system, according to an embodiment of the disclosure;

FIG. 10 illustrates an example of a control resource set (CORESET) and search space beam configuration in a wireless communication system, according to an embodiment of the disclosure;

FIG. 11A illustrates a method of selecting a control resource set which can be received in consideration of a priority when the UE receives a downlink control channel in the wireless communication system according to an embodiment of the disclosure;

FIG. 11B illustrates a method of selecting a control resource set which can be received in consideration of a priority when the UE receives a downlink control channel in the wireless communication system according to an embodiment of the disclosure;

FIG. 12 illustrates a method by which a UE and a BS transmit and receive data in consideration of a downlink data channel and rate matching resources in a wireless communication system according to an embodiment of the disclosure;

FIG. 13 illustrates an example of frequency axis resource allocation of a physical downlink shared channel (PDSCH) in a wireless communication system, according to an embodiment of the disclosure;

FIG. 14 illustrates an example of allocation of time axis resources of a PDSCH in a wireless communication system, according to an embodiment of the disclosure;

FIG. 15 illustrates an example of allocation of time-axis resources according to subcarrier spacing of a data channel and a control channel in a wireless communication system, according to an embodiment of the disclosure;

FIG. 16A illustrates a process of beam configuration and activation of a PDSCH according to an embodiment of the disclosure;

FIG. 16B illustrates an example of a MAC-CE structure for activation/deactivation of a TCI state for PDSCH according to an embodiment of the disclosure;

FIG. 17 illustrates an example of a PUSCH repetitive transmission type B in the wireless communication system according to an embodiment of the disclosure;

FIG. 18 illustrates a wireless protocol structure of the BS and the UE in a single cell environment, a carrier aggregation (CA) environment, and a dual connectivity (DC) environment in a wireless communication system, according to an embodiment of the disclosure;

FIG. 19 illustrates a configuration of antenna ports and an example of resource allocation for cooperative communication in a wireless communication system, according to an embodiment of the disclosure;

FIG. 20 illustrates an example for a configuration of downlink control information (DCI) for cooperative communication in a wireless communication system, according to an embodiment of the disclosure;

FIG. 21 illustrates an enhanced PDSCH TCI state activation/deactivation MAC-CE format according to an embodiment of the disclosure;

FIG. 22 illustrates an RLM RS selection process according to an embodiment of the disclosure;

FIG. 23 illustrates a process of generating a PDCCH repeatedly transmitted through two TRPs according to an embodiment of the disclosure;

FIG. 24 illustrates a multi-TRP-based PDSCH single frequency network (SFN) transmission method according to an embodiment of the disclosure;

FIG. 25 illustrates an enhanced PDSCH TCI state activation/deactivation MAC-CE format according to an embodiment of the disclosure;

FIG. 26 illustrates another RLM RS selection process according to an embodiment of the disclosure;

FIG. 27A illustrates operations of the UE for the RLM RS selection method according to an embodiment of the disclosure;

FIG. 27B illustrates operations of the BS for the RLM RS selection method according to an embodiment of the disclosure;

FIG. 28 illustrates a structure of the UE in a wireless communication system, according to an embodiment of the disclosure; and

FIG. 29 illustrates a structure of the BS in a wireless communication system, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A disclosed embodiment provides an apparatus and a method capable of effectively providing a service in a wireless communication system.

Specifically, an embodiment of the disclosure provides a method of selecting a reference signal for monitoring a radio link in network cooperative communication and an apparatus therefor.

In addition, an embodiment of the disclosure provides a method for transmitting and receiving a physical channel based on a single frequency network (SFN) scheme and an apparatus therefor.

According to an embodiment of the disclosure, a reference signal for monitoring a radio link can be selected, and radio link monitoring can be performed using the selected reference signal.

In addition, according to an embodiment of the disclosure, it is possible to transmit and receive a physical channel in the SFN scheme.

Hereinafter, embodiments of the disclosure are described with reference to the accompanying drawings.

In describing the embodiments, descriptions of technical contents that are well known in the technical field to which the disclosure pertains and are not directly related to the disclosure will be omitted. This is to more clearly convey the gist of the disclosure without obscuring the gist of the disclosure by omitting unnecessary description.

For the same reason, in the drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose and inform those skilled in the art of the scope of the disclosure, and the appended claims. Throughout the specification, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a BS is an entity that allocates resources to terminals, and may be at least one of a gNode B, an eNode B, a Node B, a BS, a wireless access unit, a BS controller, and a node on a network. A terminal may include a UE, a mobile station (MS), a cellular phone, a smartphone, a computer, or a multimedia system capable of performing communication functions. In the disclosure, a “downlink” refers to a radio link via which a BS transmits a signal to a terminal, and an “uplink” refers to a radio link via which a terminal transmits a signal to a BS. Further, although the following description may be directed to a long term evolution (LTE) or LTE-A system by way of example, embodiments of the disclosure may also be applied to other communication systems having similar technical backgrounds or channel types to the embodiments of the disclosure. Examples of other communication systems may include 5G new radio (NR) developed beyond LTE-A, and in the following description, “5G” may be a concept that covers exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create a means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed concurrently or the blocks may sometimes be executed in the reverse order, depending upon the functionality involved.

As used herein, “unit” refers to a software element or a hardware element, such as a field programmable gate array (FPGA) or an application specific integrated circuit (ASIC), which performs a predetermined function. However, the term “unit” does not always have a meaning limited to software or hardware. “Unit” may be constructed either to be stored in an addressable storage medium or to execute one or more processors. Therefore, “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may either be combined into a smaller number of elements, or a “unit”, or divided into a larger number of elements, or a “unit”. Moreover, the elements and “units” may be implemented to reproduce one or more CPUs within a device or a security multimedia card. Further, the term “unit” in the embodiments may include one or more processors.

A wireless communication system has developed into a broadband wireless communication system that provides a high-speed and high-quality packet data service according to communication standards such as high-speed packet access (HSPA) of third generation partnership project (3GPP), LTE or evolved universal terrestrial radio access (E-UTRA), LTE-advanced (LTE-A), LTE-Pro, high rate packet data (HRPD) of 3GPP2, ultra mobile broadband (UMB), and 802.16e of the Institute of Electrical and Electronics Engineers (IEEE) beyond the initially provided voice-based service.

An LTE system, which is a representative example of the broadband wireless communication system, employs an orthogonal frequency division multiplexing (OFDM) scheme for a downlink (DL) (the term “downlink” and the term “DL” are used interchangeably throughout the disclosure), and employs a single carrier frequency division multiple access (SC-FDMA) scheme for an uplink (UL) (the term “uplink” and the term “UL” are used interchangeably throughout the disclosure). The uplink is a radio link through which a UE (or an MS) transmits data or a control signal to a BS (or an eNode B), and the downlink is a radio link through which the BS transmits data or a control signal to the UE. In the multiple access schemes as described above, time-frequency resources for carrying data or control information are allocated and operated in a manner to prevent overlapping of the resources, that is, to establish the orthogonality, between users, so as to identify data or control information of each user.

A post-LTE communication system, that is, a 5G communication system, should be able to freely reflect various requirements of a user and a service provider, and thus it is required to support a service which satisfies the various requirements. Services which are considered for the 5G communication system include enhanced mobile broadband (eMBB), massive machine type communication (mMTC), and ultra reliability low latency communication (URLLC).

The eMBB aims to provide a data transmission rate which is improved so as to surpass the data transmission speed supported by conventional LTE, LTE-A, or LTE-Pro. For example, in the 5G communication system, the eMBB should provide a peak downlink data rate of 20 gigabits per second (Gbps) and a peak uplink data rate of 10 Gbps from the viewpoint of one BS. Further, the 5G communication system should provide not only the peak data rate but also an increased user-perceived data rate. In order to satisfy such requirements, improvement of various transmission/reception technologies, including a further improved multi-input multi-output (MIMO) transmission technology, is needed. Further, while the current LTE system uses transmission bandwidths from a bandwidth of 2 GHz to a maximum bandwidth of 20 megahertz (MHz) to transmit signals, the 5G communication system uses a frequency bandwidth wider than 20 MHz in frequency bands of 3 to 6 GHz or higher than or equal to 6 GHz, whereby the data transmission rate required by the 5G communication system can be satisfied.

Also, in order to support an application service such as the IoT, mMTC is considered in the 5G communication system. The mMTC is required to support access of a multitude of UEs within a cell, improve coverage of the UE, increase a battery lifetime, and reduce the costs of the UE in order to efficiently provide IoT technology. IoT technology is used in conjunction with various sensors and devices to provide communication, and thus should support a large number of UEs (for example, 1,000,000 UEs/kilometer2 (km2)) within the cell. Since the UE supporting the mMTC is highly likely to be located in a shaded area, such as a basement of a building, which a cell cannot cover due to service characteristics, the mMTC may require wider coverage than other services provided by the 5G communication system. The UE supporting the mMTC needs to be produced at low cost and it is difficult to frequently exchange a battery thereof. Thus, a long battery lifetime, for example, 10 to 15 years, may be required.

The URLLC is a cellular-based wireless communication service used for a particular (mission-critical) purpose. For example, services used for remote control of robots or machinery, industrial automation, unmanned aerial vehicles, remote health care, and emergency alerts may be considered. Accordingly, communication provided by the URLLC should provide very low latency and very high reliability. For example, services supporting the URLLC should satisfy a radio access delay time (air interface latency) shorter than 0.5 milliseconds and also have a requirement of a packet error rate equal to or smaller than 10-5. Accordingly, for services supporting the URLLC, the 5G system should provide a transmit time interval (TTI) smaller than that of other systems and also have a design requirement of allocating a wide array of resources in a frequency band in order to guarantee reliability of a communication link.

Three services of 5G, namely eMBB, URLLC, and mMTC, may be multiplexed and transmitted in one system. At this time, in order to meet the different requirements of the respective services, different transmission/reception schemes and transmission/reception parameters may be used for the services. Of course, 5G is not limited to the above-described three services.

NR Time-Frequency Resources

Hereinafter, a frame structure of a 5G system is described in more detail with reference to the drawings.

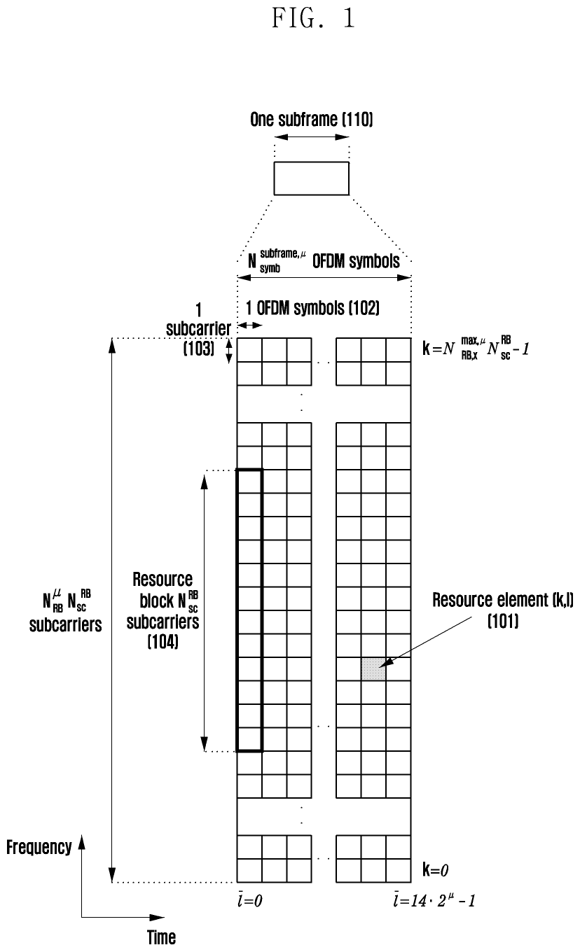

FIG. 1 illustrates a basic structure of a time-frequency domain which is a radio resource domain in one subframe 110 in which data or a control channel is transmitted in a 5G system according to an embodiment of the disclosure.

Referring to FIG. 1, a horizontal axis indicates a time domain and a vertical axis indicates a frequency domain. The basic unit of resources in the time and frequency domain is a resource element (RE) 101 and may be defined as 1 orthogonal frequency division multiplexing (OFDM) symbol 102 in the time axis and 1 subcarrier 103 in the frequency axis. In the frequency domain, N_{IC}^{RB} (for example, 12) consecutive REs may correspond to one resource block (RB) 104.

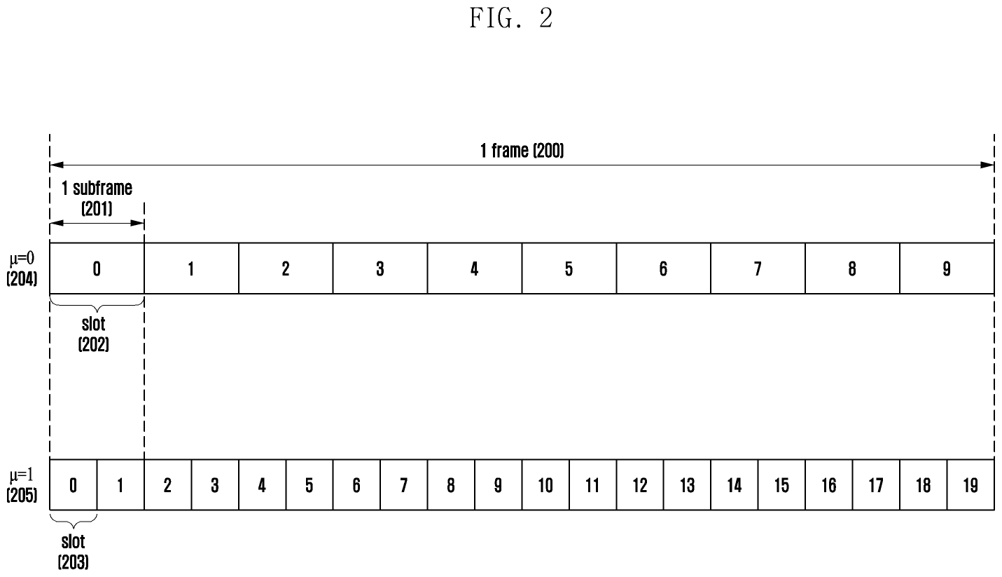

FIG. 2 illustrates frame, subframe, and slot structures in a wireless communication system, according to an embodiment of the disclosure.

Referring to FIG. 2, an example of the structure of a frame 200, a subframe 201, and a slot 202 is illustrated. 1 frame 200 may be defined as 10 milliseconds (ms). 1 subframe 201 may be defined as 1 ms, and accordingly one frame 200 may include a total of 10 subframes 201. 1 slot 202 or 203 may be defined as 14 OFDM symbols (that is, the number symbols N_{symb}^{slot} per slot=14). 1 subframe 201 may include one or a plurality of slots 202 and 203, and the number of slots 202 or 203 per subframe 201 may vary depending on a configuration value μ 204 or 205 for subcarrier spacing. FIG. 2 illustrates the case in which the subcarrier spacing configuration value 204 is μ=0 and the case in which the subcarrier spacing configuration value 205 is μ=1. 1 subframe 201 may include one slot 202 in the case of μ=0 204, and 1 subframe 201 may include 2 slots 203 in the case of μ=1 205. That is, the number (Nₛₗₒₜ^{subframe,μ}) of slots per subframe may vary depending on the configuration value (μ) for subcarrier spacing, and accordingly the number (Nₛₗₒₜ^{frame,μ}) of slots per frame may vary. The number (Nₛₗₒₜ^{subframe,μ}) and the number (Nₛₗₒₜ^{frame,μ}) according to the subcarrier spacing configuration value μ may be defined as shown in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Bandwidth Part (BWP)

Subsequently, a configuration of a bandwidth part (BWP) in a 5G communication system is described in detail with reference to the drawings.

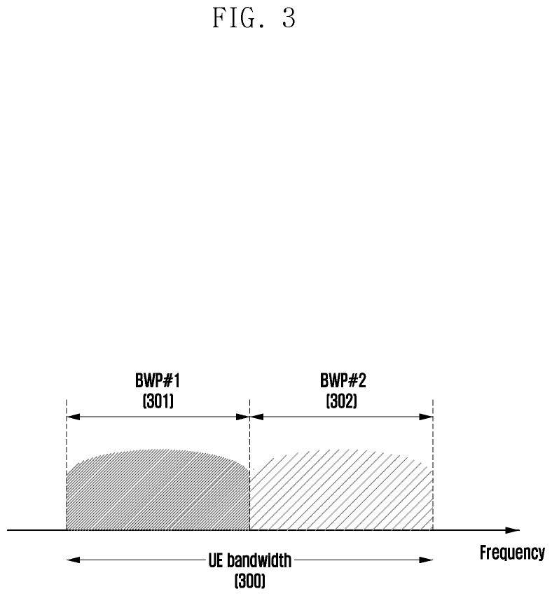

FIG. 3 illustrates an example of a configuration of a bandwidth part in a wireless communication system, according to an embodiment of the disclosure.

Referring to FIG. 3, a UE bandwidth 300 is configured as two bandwidth parts, that is, BWP #1 301 and BWP #2 302. The BS may configure one or a plurality of BWPs in the UE, and the following information provided below in Table 2 may be configured to each BWP.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, |

n5},
(subcarrier spacing)

| | |
|---|---|
| cyclicPrefix | ENUMERATED { extended } |

(cyclic prefix)
}

Of course, the disclosure is not limited to the aforementioned example, and various parameters related to a BWP as well as the configuration information may be configured in the UE. The information may be transmitted to the UE from the BS through higher-layer signaling, for example, radio resource control (RRC) signaling. Among one or a plurality of configured BWPs, at least one BSP may be activated. Information indicating whether to activate the configured BWPs may be semi-statically transferred from the BS to the UE through RRC signaling or may be dynamically transferred through DCI.

According to some embodiments, the UE may receive a configuration of an initial BWP for initial access from the BS through a master information block (MIB) before the RRC connection. More specifically, the UE may receive configuration information for a CORESET (“CORESET” and “control resource set” are used interchangeably throughout the disclosure) and a search space (the term “search space” and the term “SS” are used interchangeably throughout the disclosure) in which a PDCCH for receiving system information (remaining system information (RMSI) or system information block 1 (SIB1)) required for initial access through the MIB can be transmitted in an initial access step. The control resource set and the search space configured as the MIB may be considered as an identity (ID) 0. The BS may inform the UE of configuration information such as frequency allocation information for control resource set #0, time allocation information, and numerology, through the MIB. Further, the BS may inform the UE of configuration information for a monitoring period and an occasion of control resource set #0, that is, configuration information for search space #0 through the MIB. The UE may consider a frequency region configured as control resource set #0 acquired from the MIB as an initial bandwidth part for initial access. At this time, the ID of the initial BWP may be considered as 0.

The configuration for the BWP supported by the 5G system may be used for various purposes.

When a bandwidth supported by the UE is narrower than a system bandwidth, it may be supported through the BWP configuration. For example, the BS may configure a frequency location (configuration information 2) of the BWP in the UE, and thus the UE may transmit and receive data at a specific frequency location within the system bandwidth.

Further, in order to support different numerologies, the BS may configure a plurality of BWPs in the UE. For example, in order to support the UE to perform data transmission and reception using both subcarrier spacing of 15 kilohertz (kHz) and subcarrier spacing of 30 kHz, two BWPs may be configured as subcarrier spacings of 15 kHz and 30 kHz, respectively. Different BWPs may be frequency division-multiplexed, and when data is to be transmitted and received at specific subcarrier spacing, BWPs configured at the corresponding subcarrier spacing may be activated.

In order to reduce power consumption of the UE, the BS may configure BWPs having different sizes of bandwidths in the UE. When the UE supports a very large bandwidth, e.g., 100 MHz, but always transmits and receives data through the bandwidth, a very high power consumption may be generated. Particularly, monitoring an unnecessary downlink control channel through a large bandwidth of 100 MHz in the state in which there is no traffic is very inefficient from the aspect of power consumption. In order to reduce power consumption of the UE, the BS may configure a BWP having a relatively narrow bandwidth, e.g., 200 MHz. The UE may perform a monitoring operation in the bandwidth part of 200 MHz in the state in which there is no traffic, and if data is generated, may transmit and receive data through the bandwidth part of 100 MHz according to an instruction from the BS.

In a method of configuring the BWP, UEs before the RRC connection may receive configuration information for an initial bandwidth part through an MIB in an initial access step. More specifically, the UE may receive a configuration of a CORESET for a downlink control channel in which DCI for scheduling an SIB can be transmitted from an MIB of a physical broadcast channel (PBCH). A bandwidth of the control resource set configured as the MIB may be considered as an initial bandwidth part, and the UE may receive a PDSCH, in which the SIB is transmitted, through the configured initial bandwidth part. The initial BWP may be used not only for reception of the SIB but also other system information (OSI), paging, or random access (RA) (the term “random access” and the term “RA” are used interchangeably throughout the disclosure).

BWP Change

When one or more BWPs are configured in the UE, the BS may indicate a change (or switching or transition) in the BWPs to the UE through a BWP indicator field within the DCI. For example, in FIG. 3, when a currently activated BWP of the UE is BWP #1 301, the BS may indicate BWP #2 302 to the UE through a BWP indicator within DCI and the UE may make a BWP change to BWP #2 302 indicated by the received BWP indicator within DCI.

As described above, since the DCI-based BWP change may be indicated by the DCI for scheduling the PDSCH or the PUSCH, the UE should be able to receive or transmit the PDSCH or the PUSCH scheduled by the corresponding DCI in the changed BWP without any difficulty if the UE receives a BWP change request. To this end, the standard has defined requirements for a delay time (T_{BWP}) required for the BWP change, and may be defined as shown below in Table 3.

TABLE 3

| | |
|---|---|
| NR Slot length | BWP switch delay TBWP (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the smaller SCS between the SCS before BWP switch and the SCS after BWP switch.

The requirements for the BWP change delay time may support type 1 or type 2 according to a UE capability. The UE may report a supportable BWP delay time type to the BS.

When the UE receives DCI including a BWP change indicator in slot n according to the requirements for the BWP change delay time, the UE may complete a change to a new BWP indicated by the BWP change indicator at a time point that is not later than slot n+T_{BWP} and transmit and receive a data channel scheduled by the corresponding DCI in the changed new BWP. When the BS desires to schedule a data channel in the new BWP, the BS may determine time domain resource allocation for the data cannel in consideration of the BWP change delay time (T_{BWP}) of the UE. That is, when scheduling the data channel in the new BWP, the BS may schedule the corresponding data channel after the BWP change delay time using a method of determining the time domain resource allocation for the data channel. Accordingly, the UE may not expect that the DCI indicating the BWP change indicates a slot offset (K₀ or K₂) smaller than the BWP change delay time (T_{BWP}).

If the UE receives DCI indicating the BWP change (for example, DCI format 1_1 or 0_1), the UE may perform no transmission or reception during a time interval from a third symbol of a slot for receiving the PDCCH including the corresponding DCI to a start point of the slot indicated by the slot offset (K0 or K2) indicated through a time domain resource allocation field within the corresponding DCI. For example, when the UE receives DCI indicating the BWP change in slot n and a slot offset value indicated by the corresponding DCI is K, the UE may perform no transmission or reception from the third symbol of slot n to a symbol before slot n+K (that is, the last symbol of slot n+K−1).

SS/PBCH Block

Subsequently, a synchronization signal/PBCH block in a 5G system is described.

The synchronization signal/PBCH block may be a physical layer channel block including a primary synchronization signal (PSS), a secondary synchronization signal (SSS), and a PBCH. A detailed description thereof is made below.
PSS is a signal which is a reference of downlink time/frequency synchronization and provides some pieces of information of a cell ID.
SSS is a reference of downlink time/frequency synchronization and provides the remaining cell ID information which the PSS does not provide. In addition, the SSS serves as a reference signal for demodulation of a PBCH.
PBCH provides necessary system information required for transmitting and receiving a data channel and a control channel by the UE. The necessary system information may include search space-related control information indicating radio resource mapping information of the control channel and scheduling control information for a separate data channel for transmitting system information.
Synchronization signal/PBCH block includes a combination of PSS, SSS, and PBCH. One or a plurality of synchronization signal/PBCH blocks may be transmitted within a time of 5 ms, and each of the transmitted synchronization signal/PBCH blocks may be separated by an index.

The UE may detect the PSS and the SSS in an initial access stage and decode the PBCH. The UE may acquire an MIB from the PBCH and receive a configuration of CORESET #0 (corresponding to a control resource set having control resource set index 0) therefrom. The UE may monitor control resource set #0 on the basis of the assumption that the selected SS/PBCH block and a demodulation reference signal (DMRS) transmitted in control resource set #0 are quasi co-located (QCLed). The UE may receive system information through downlink control information transmitted in control resource set #0. The UE may acquire configuration information related to a random access channel (RACH) required for initial access from the received system information. The UE may transmit a physical RACH (PRACH) to the BS in consideration of the selected synchronization signal/PBCH block index, and the BS receiving the PRACH may acquire the synchronization signal/PBCH block index selected by the UE. The BS may know which block is selected by the UE from among the synchronization signal/PBCH blocks and that CORESET #0 related thereto is monitored.

Related to PDCCH: DCI

Subsequently, DCI in a 5G system is described in detail.

In the 5G system, scheduling information for uplink data (or a physical uplink data channel (a PUSCH)) or downlink data (or a physical downlink data channel (a PDSCH)) is transmitted from the BS to the UE through DCI. The UE may monitor a fallback DCI format and a non-fallback DCI format for the PUSCH or the PDSCH. The fallback DCI format may include a fixed field predefined between the BS and the UE, and the non-fallback DCI format may include a configurable field.

The DCI may be transmitted through a PDCCH via a channel coding and modulation process. A cyclic redundancy check (CRC) may be added to a DCI message payload and may be scrambled by a radio network temporary identifier (RNTI) corresponding to the identity of the UE. Depending on the purpose of the DCI message, for example, UE-specific data transmission, a power control command, or a random access response, different RNTIs may be used. That is, the RNTI is not explicitly transmitted but is included in a CRC calculation process to be transmitted. If the DCI message transmitted through the PDCCH is received, the UE may identify the CRC through the allocated RNTI, and may recognize that the corresponding message is transmitted to the UE when the CRC is determined to be correct on the basis of the CRC identification result.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled with a TPC-RNTI. DCI for scheduling a UE-specific PDSCH or PUSCH may be scrambled by a cell RNTI (C-RNTI).

DCI format 0_0 may be used for fallback DCI for scheduling a PUSCH in which case the CRC may be scrambled by a C-RNTI. DCI format 0_0 in which the CRC is scrambled by the C-RNTI may include, for example, the following information shown below in Table 4.

TABLE 4
Identifier for DCI formats - [1] bit
Frequency domain resource assignment - [┌log₂( N_{RB}^{DL, BWP}(N_{RB}^{DL, BWP} + 1)/2)┐] bits
Time domain resource assignment - X bits
VRB-to-PRB mapping - 1 bit.
Modulation and coding scheme - 5 bits
New data indicator- 1 bit
Redundancy version- 2 bits
HARQ process number- 4 bits
Transmit power control (TPC) command for scheduled PUSCH - [2] bits
UL/supplementary UL (SUL) indicator - 0 or 1 bit

DCI format 0_1 may be used for non-fallback DCI for scheduling a PUSCH in which case the CRC may be scrambled by a C-RNTI. DCI format 0_1 in which the CRC is scrambled by the C-RNTI may include, for example, the following information shown below in Table 5.

TABLE 5
- Carrier indicator-0 or 3 bits
- UL/SUL indicator-0 or 1 bit
- Identifier for DCI formats-[1] bits
- Bandwidth part indicator-0, 1 or 2 bits
- Frequency domain resource assignment
For resource allocation type 0, ┌N_{RB}^{UL,BWP}/P ┐ bits
For resource allocation type ┌log2(N_{RB}^{UL,BWP} (N_{RB}^{UL,BWP} + 1)/2)┐ bits
- Time domain resource assignment-1, 2, 3, or 4 bits
- Virtual resource block (VRB)-to-physical resource block (PRB) mapping-0 or 1
bit, only for resource allocation type 1.
• 0 bit if only resource allocation type 0 is configured;
• 1 bit otherwise.
- Frequency hopping flag-0 or 1 bit, only for resource allocation type 1.
• 0 bit if only resource allocation type 0 is configured;
• 1 bit otherwise.
- Modulation and coding scheme-5 bits
- New data indicator-1 bit
- Redundancy version-2 bits
- HARQ process number-4 bits
- 1st downlink assignment index-1 or 2 bits
• 1 bit for semi-static HARQ-ACK codebook;
• 2 bits for dynamic HARQ-ACK codebook with single HARQ-ACK codebook.
- 2nd downlink assignment index-0 or 2 bits
• 2 bits for dynamic HARQ-ACK codebook with two HARQ-ACK sub-codebooks;
• 0 bit otherwise.
- TPC command for scheduled PUSCH-2 bits
- $SRS resource indicator - ⌈ {log}_{2} ( {\sum }_{k = 1}^{{L}_{max}} ( \begin{matrix}{N}_{S R S} \\ k\end{matrix} ) ) ⌉ or ⌈ {log}_{2} ( {N}_{S R S} ) ⌉ bits$
$⌈ {log}_{2} ( {\sum }_{k = 1}^{{L}_{max}} ( \begin{matrix}{N}_{S R S} \\ k\end{matrix} ) ) ⌉ bits for non - cookbook based PUSCH transmission ;$
• ┌log₂(N_{SRS})┐ bits for codebook based PUSCH transmission.
- Precoding information and number of layers-up to 6 bits
- Antenna ports-up to 5 bits
- SRS request-2 bits
- Channel state information (CSI) request-0, 1, 2, 3, 4, 5, or 6 bits
- Code block group (CBG) transmission information-0, 2, 4, 6, or 8 bits
- Phase tracking reference signal (PTRS)-DMRS association-0 or 2 bits.
- beta_offset indicator-0 or 2 bits
- DMRS sequence initialization-0 or 1 bit

DCI format 1_0 may be used for fallback DCI for scheduling a PDSCH in which case the CRC may be scrambled by a C-RNTI. DCI format 1_0 in which the CRC is scrambled by the C-RNTI may include, for example, the following information shown below in Table 6.

TABLE 6
Identifier for DCI formats - [1] bit
Frequency domain resource assignment -[┌log₂(N_{RB}^{DL, BWP}(N_{RB}^{DL, BWP} + 1)/2)┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUSCH - [2] bits
Physical uplink control channel (PUCCH) resource indicator- 3 bits
PDSCH-to-HARQ feedback timing indicator- [3] bits

DCI format 1_1 may be used for non-fallback DCI for scheduling a PDSCH in which case the CRC may be scrambled by a C-RNTI. DCI format 1_1 in which the CRC is scrambled by the C-RNTI may include, for example, the following information shown below in Table 7.

TABLE 7
Carrier indicator - 0 or 3 bits
Identifier for DCI formats - [1] bits
Bandwidth part indicator - 0, 1 or 2 bits
Frequency domain resource assignment
For resource allocation type 0, ┌N_{RB}^{DL, BWP}/P┐ bits
For resource allocation type 1, ┌log₂( N_{RB}^{DL, BWP}(N_{RB}^{DL, BWP} + 1)/2)┐ bits
Time domain resource assignment -1, 2, 3, or 4 bits
VRB-to-PRB mapping - 0 or 1 bit, only for resource allocation type 1.
0 bit if only resource allocation type 0 is configured;
1 bit otherwise.
Physical resource block (PRB) bundling size indicator - 0 or 1 bit
Rate matching indicator - 0, 1, or 2 bits
Zero power (ZP) channel state information reference signal (CSI-RS)
trFor transport block 1:igger- 0, 1, or 2 bits
Modulation and coding scheme - 5 bits
New data indicator - 1 bit
Redundancy version - 2 bits
For transport block 2:
Modulation and coding scheme - 5 bits
New data indicator - 1 bit
Redundancy version - 2 bits
HARQ process number - 4 bits
Downlink assignment index - 0 or 2 or 4 bits
TPC command for scheduled PUCCH - 2 bits
PUCCH resource indicator - 3 bits
PDSCH-to-HARQ_feedback timing indicator - 3 bits
Antenna ports - 4, 5 or 6 bits
Transmission configuration indication - 0 or 3 bits
SRS request - 2 bits
CBG transmission information (CBGTI) - 0, 2, 4, 6, or 8 bits
CBG flushing out information (CBGFI) - 0 or 1 bit
DMRS sequence initialization - 1 bit

PDCCH: CORESET, REG, CCE, Search Space

Subsequently, a downlink control channel in a 5G communication system is described in more detail with reference to the drawings.

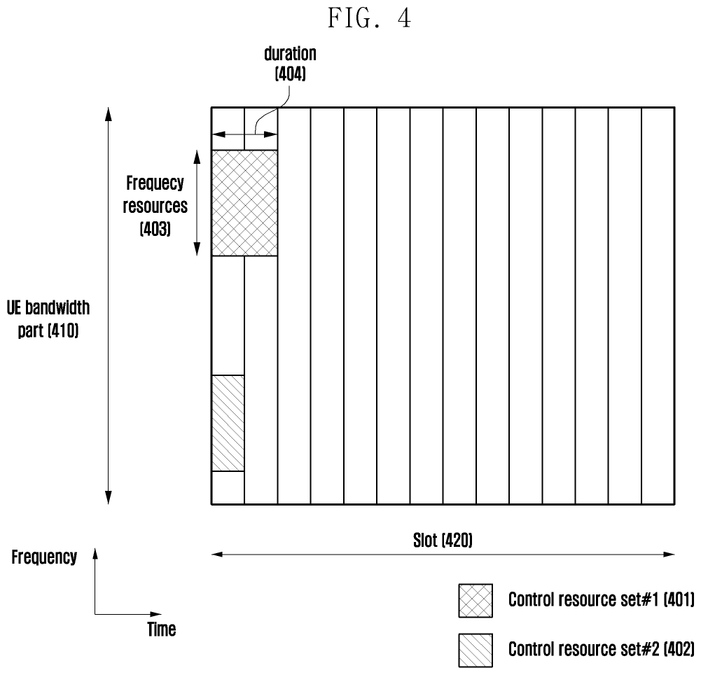

FIG. 4 illustrates an example of a control resource set (CORESET) in which a downlink control channel is transmitted in 5G wireless communication systems according to an embodiment of the disclosure.

FIG. 4 illustrates an example in which a UE bandwidth part 410 is configured in the frequency axis and control resource set #1 401 and control resource set #2 402 are configured within 1 slot 420 in the time axis. The control resource sets 401 and 402 may be configured in specific frequency resources 403 within a total UE BWP 410 in the frequency axis. The control resource set may be configured as one or a plurality of OFDM symbols in the time axis, which may be defined as a control resource set duration 404. Referring to FIG. 4, control resource set #1 401 may be configured as a control resource set duration of 2 symbols, and control resource set #2 402 may be configured as a control resource set duration of 1 symbol.

The control resource sets in the 5G system may be configured through higher-layer signaling (for example, system information, a Master Information Block (MIB), or Radio Resource Control (RRC) signaling) in the UE by the BS. Configuring the control resource set in the UE may mean providing information such as a control resource set identity, a frequency location of the control resource set, and a symbol length of the control resource set. For example, the following information may be included as shown below in Table 8.

TABLE 8

| | |
|---|---|
| ControlResourceSet ::= | SEQUENCE { |

-- Corresponds to L1 parameter ‘CORESET-ID’

| | |
|---|---|
| controlResourceSetId | controlResourceSetId |
| (control resource set Identity) | |
| frequencyDomainResources | BIT STRING (SIZE (45)), |
| (frequency axis resource allocation information) | |
| duration | INTEGER |

```
(1..maxCoReSetDuration),
(time axis resource allocation information)
  cce-REG-MappingType
  CHOICE {
(CCE-to-REG mapping scheme)
    interleaved
  SEQUENCE {
      reg-BundleSize
  ENUMERATED {n2, n3, n6},
      precoderGranularity
  ENUMERATED {sameAsREG-bundle, allContiguousRBs},
      interleaverSize
  ENUMERATED {n2, n3, n6}
(interleaver size)
      shiftIndex
  INTEGER(0..maxNrofPhysicalResourceBlocks−1)
          OPTIONAL
(interleaver shift)
},
```

| | |
|---|---|
| nonInterleaved | NULL |

```
  },
  tci-StatesPDCCH
  SEQUENCE(SIZE(1..maxNrofTCI-StatesPDCCH)) OF TCI-StateId
        OPTIONAL,
(QCL configuration information)
```

| | |
|---|---|
| tci-PresentInDCI | ENUMERATED |

{enabled}
OPTIONAL, -- Need S
}

In Table 8, tci-StatesPDCCH (referred to as a transmission configuration indication (TCI) state) configuration information may include information on one or a plurality of synchronization signal/PBCH block indexes or CSI-RS indexes having the quasi co-located (QCL) relationship with a DMRS transmitted in the corresponding CORESET.

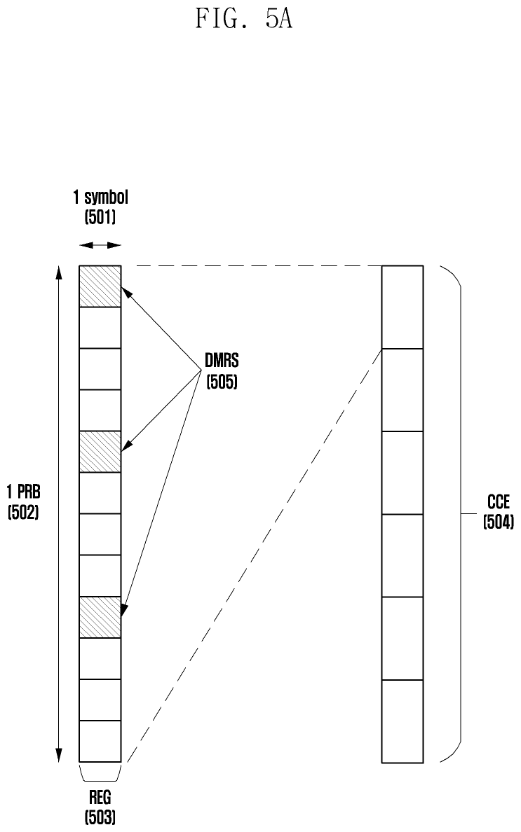

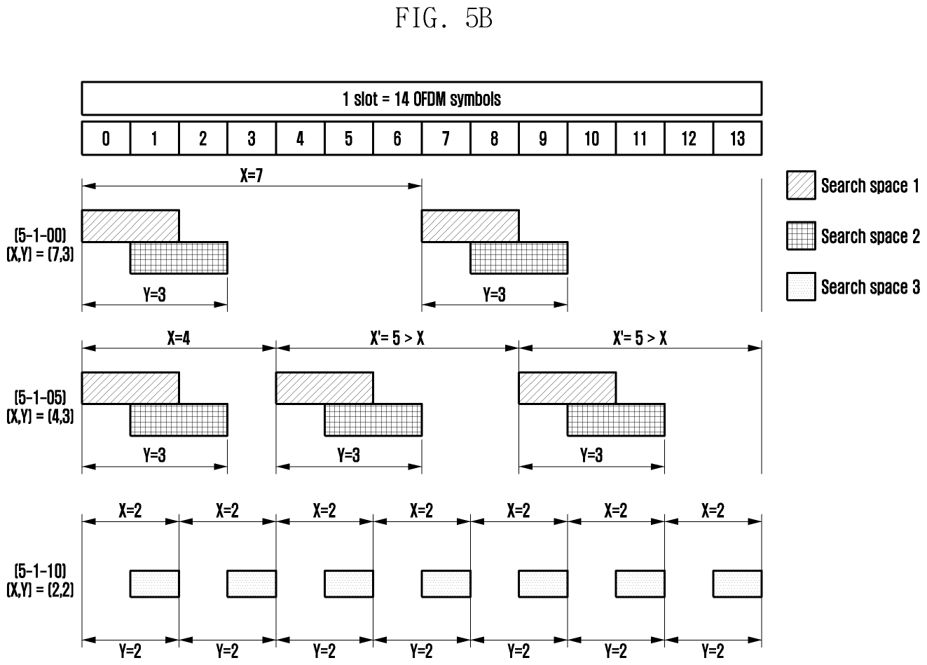

FIG. 5A illustrates an example of a basic unit of time and frequency resources included in a downlink control channel which can be used in a 5G system according to an embodiment of the disclosure.

Referring to FIG. 5A, the basic unit of time and frequency resources included in the control channel may be a resource element group (REG) 503, and the REG 503 may be defined as 1 OFDM symbol 501 in the time axis and 1 PRB 502 in the frequency axis, that is, as 12 subcarriers. The BS may configure a downlink control channel allocation unit by concatenating the REGs 503.

As illustrated in FIG. 5A, when the basic unit for allocation of the downlink control channel in the 5G system is a control channel eminent (CCE) 504, 1 CCE 504 may include a plurality of REGs 503. In a description of the REG 503 illustrated in FIG. 5A by way of example, the REG 503 may include 12 REs and, when 1 CCE 504 includes 5 REGs 503, 1 CCE 504 may include 72 REs. When a downlink CORESET is configured, the corresponding area may include a plurality of CCEs 504, and a specific downlink control channel may be mapped to one or a plurality of CCEs 504 according to an aggregation level (AL) within the CORESET and then transmitted. CCEs 504 within the CORESET may be distinguished by numbers and the numbers of the CCEs 504 may be assigned according to a logical mapping scheme.

The basic unit of the downlink control channel illustrated in FIG. 5A, that is, the REG 503, may include all of the REs to which the DCI is mapped and the areas to which DMRSs 505, which are reference signals for decoding the REs, are mapped. As illustrated in FIG. 5A, 3 DMRSs 505 may be transmitted in 1 REG 503. The number of CCEs required to transmit the PDCCH may be 1, 2, 4, 8, or 16 according to the aggregation level (AL), and the different number of CCEs may be used to implement link adaptation of the downlink control channel. For example, if AL=L, one downlink control channel may be transmitted through L CCEs. The UE should detect a signal in the state in which the UE does not know information on the downlink control channel, and a search space indicating a set of CCEs is defined to perform blind decoding in a wireless communication system (for example, 5G or NR system). The search space is a set of downlink control channel candidates including CCEs for which the UE should attempt decoding at the given aggregation level, and there are several aggregation levels at which one set of CCEs is configured by 1, 2, 4, 8, and 16 CCEs, so that the UE may have a plurality of search spaces. A search space set may be defined as a set of search spaces at all the configured aggregation levels.

The search space may be classified into a common search space and a UE-specific search space. UEs in a predetermined group or all UEs may search for a common search space of the PDCCH in order to receive cell-common control information such as dynamic scheduling for system information or paging messages. For example, PDSCH scheduling allocation information for transmission of an SIB including information on a service provider of a cell may be received by searching for (monitoring) a common search space of the PDCCH. In the case of the common search space, UEs in a predetermined group or all UEs should receive the PDCCH, so that the common-search space may be defined as a set of pre-arranged CCEs. Scheduling allocation information for the UE-specific PDSCH or PUSCH may be received by searching for a UE-specific search space of the PDCCH. The UE-specific search space may be UE-specifically defined as a UE identity and a function of various system parameters.

A parameter for a search space of a PDCCH in a wireless communication system (for example, a 5G or NR system) may be configured in the UE by the BS through higher-layer signaling (for example, SIB, MIB, or RRC signaling). For example, the BS may configure, in the UE, the number of PDCCH candidates at each aggregation level L, a monitoring period of the search space, a monitoring occasion in units of symbols within the slot for the search space, a search space type, that is, a common search space or a UE-specific search space, a combination of a DCI format and an RNTI to be monitored in the corresponding search space, and a control resource set index for monitoring the search space. For example, the following information shown below in Table 9 may be included in the information configured by the BS.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |

(search space identifier)

| | |
|---|---|
| controlResourceSetId | ControlResourceSetId, |

(control resource set identifier)

| | |
|---|---|
| monitoringSlotPeriodicityAndOffset | CHOICE { |

```
    sl1
  NULL,
    sl2
  INTEGER (0..1),
    sl4
  INTEGER (0..3),
    sl5
  INTEGER (0..4),
    sl8
  INTEGER (0..7),
    sl10
  INTEGER (0..9),
    sl16
  INTEGER (0..15),
    sl20
  INTEGER (0..19)
  }
```

OPTIONAL,

duration INTEGER (2..2559)

| | |
|---|---|
| monitoringSymbolsWithinSlot | BIT STRING |

(SIZE (14))
OPTIONAL,
(montioring symbol within slot)

| | |
|---|---|
| nrofCandidates | SEQUENCE { |

```
    aggregationLevel1
  ENUMERATED {n0, n1, n2, n3, n4, n5, n6, n8},
    aggregationLevel2
  ENUMERATED {n0, n1, n2, n3, n4, n5, n6, n8},
    aggregationLevel4
  ENUMERATED {n0, n1, n2, n3, n4, n5, n6, n8},
    aggregationLevel8
  ENUMERATED {n0, n1, n2, n3, n4, n5, n6, n8},
    aggregationLevel16
  ENUMERATED {n0, n1, n2, n3, n4, n5, n6, n8}
  },
```

| | |
|---|---|
| searchSpaceType | CHOICE { |
| (seacrh space type) | |

```
    -- Configures this search space as common search space (CSS) and DCI
formats to monitor.
    common
  SEQUENCE {
(common search space)
}
    ue-Specific
  SEQUENCE {
(UE-specific search space)
      -- Indicates whether the UE monitors in this USS for DCI formats 0-
0 and 1-0 or for formats 0-1 and 1-1.
      formats
  ENUMERATED {formats0-0-And-1-0, formats0-1-And-1-1},
      ...
    }
```

The BS may configure one or a plurality of search space sets in the UE according to configuration information. The BS may configure search space set 1 and search space set 2 in the UE, and the configuration may be performed such that DCI format A scrambled by an X-RNTI (e.g., a first RNTI) in search space set 1 is monitored in the common search space and DCI format B scrambled by a Y-RNTI (e.g., a second RNTI) in search space set 2 is monitored in the UE-specific search space.

According to configuration information, one or a plurality of search space sets may exist in the common search space or the UE-specific search space. For example, search space set #1 and search space set #2 may be configured as common search spaces, and search space set #3 and search space set #4 may be configured as UE-specific search spaces.

In the common search space, the following combinations of DCI formats and RNTIs may be monitored. Of course, the disclosure is not limited to the following examples.
DCI format 0_0/1_0 with CRC scrambled by cell-RNTI (C-RNTI), configured scheduling (CS)-RNTI, semi-persistent (SP)-CSI-RNTI, RA-RNTI, temporary cell (TC)-RNTI, paging (P)-RNTI, and system information (SI)-RNTI;
DCI format 2_0 with CRC scrambled by SFI-RNTI;
DCI format 2_1 with CRC scrambled by interruption (INT)-RNTI;
DCI format 2_2 with CRC scrambled by TPC-PUSCH-RNTI and TPC-PUCCH-RNTI; and
DCI format 2_3 with CRC scrambled by TPC-SRS-RNTI.

In the UE-specific search space, the following combinations of DCI formats and RNTIs may be monitored. Of course, the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The described RNTIs may follow the following definitions and uses.
C-RNTI: used for scheduling UE-specific PDSCH;
TC-RNTI: used for UE-specific PDSCH scheduling;
   CS-RNTI: used for semi-statically configured UE-specific PDSCH scheduling;
RA-RNTI: used for PDSCH scheduling at random access stage;
P-RNTI: used for PDSCH scheduling through which paging is transmitted;
SI-RNTI: used for PDSCH scheduling through which system information is transmitted;
INT-RNTI: used for indicating whether puncturing is performed for PDSCH;
   TPC for PUSCH RNTI (TPC-PUSCH-RNTI): used for indicating PUSCH power control command;
   TPC for PUCCH RNTI (TPC-PUCCH-RNTI): used for indicating PUCCH power control command;
   TPC for SRS RNTI (TPC-SRS-RNTI): used for indicating SRS power control command;

The DCI formats may follow the following definition shown below in Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

A control resource set p and a search space of an aggregation level L in a search space set s may be expressed as shown below in Equation 1.

$$L \cdot \{ ( {Y}_{p , {n}_{s , f}^{μ}} + ⌊ \frac{{m}_{s , {n}_{CI} \cdot {N}_{CCE , p}}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing within control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: index of PDCCH candidates at aggregation level L
i=0, . . . , L−1
Y_{p,n}_{_{s,f}}_{^{μ}}=(Aₚ·Y_{p,n}_{_{s,f}}_{^{μ}}₋₁) mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: terminal identity

For a common search space, a value of Y_{p,n}_{_{s,f}}_{^{μ}} corresponds to 0.

For a UE-specific search space, the value of Y_{p,n}_{_{s,f}}_{^{μ}} may correspond to a value varying depending on the terminal's identity (C-RNTI or ID configured for the terminal by the BS) and the time index.

In a 5G system, a set of search space sets monitored by the UE at every time point may vary as a plurality of search space sets can be configured as different parameters (for example, the parameters in Table 9). When search space set #1 is configured on an X-slot period, search space set #2 is configured on a Y-slot period, and X and Y are different from each other. The UE may monitor all of search space set #1 and search space set #2 in a specific slot and monitor one of search space set #1 and search space set #2 in another specific slot.

PDCCH: Span

The UE may report a UE capability in the case in which a plurality of PDCCH monitoring locations exist within the slot and, at this time, the concept “span” may be used. The span is consecutive symbols in which the UE can monitor a PDCCH within the slot, and each PDCCH monitoring location may be within 1 span. The span may be expressed by (X,Y), in which X refers to the minimum number of symbols which should be spaced apart between first symbols of two consecutive spans and Y refers to the number of consecutive symbols for monitoring a PDCCH within 1 span. At this time, the UE may monitor the PDCCH in a section within Y symbols from the first symbol of the span within the span.

FIG. 5B illustrates a case in which the UE may have a plurality of PDCCH monitoring locations within a slot through a span in a wireless communication system, according to an embodiment of the disclosure.

Referring to FIG. 5B, the span is expressed by (X,Y)=(7,3), (4,3), and (2,2), and the three cases are expressed as 5-1-00, 5-1-05, and 5-1-10 in FIG. 5B. For example, 5-1-00 indicates the case in which the number of spans which can be expressed by (7,3) is 2 is in the slot. An interval between first symbols of the two spans is expressed as X=7, a PDCCH monitoring location may exist within a total of Y=3 symbols from the first symbol of each span, and search spaces 1 and 2 exist within Y=3 symbols. In another example, 5-1-05 indicates the case in which a total number of spans which can be expressed by (4,3) is 3 is in the slot, and an interval between a second span and a third span is X′=5 symbols larger than X=4.

PDCCH: UE Capability Reporting

The slot location of the common search space and the UE-specific search space is indicated by a monitoringSymbolsWithinSlot parameter in Table 11-1, shown below, and the symbol location within the slot is indicated by a bitmap through a monitoringSymbolsWithinSlot parameter in Table 9, shown above. Meanwhile, the symbol location within the slot in which the UE can perform search space monitoring may be reported to the BS through the following UE capability.
UE capability 1 (hereinafter, referred to as “FG 3-1”) will now be described. When the number of monitoring occasions (MOs) (the term “monitoring occasion” and the term “MO” are used interchangeably throughout the disclosure) for type 1 and type 3 search spaces or the UE-specific search space is 1 within the slot, the UE capability is a capability to monitor the corresponding MO if the corresponding MO is within first 3 symbols in the slot. The UE capability is a mandatory capability which all UEs supporting NR should support and whether to support the capability is not explicitly reported to the BS.

TABLE 11-1

| | | | Field name in |
|---|---|---|---|
| Index | Feature group | Components | TS 38.331 [2] |
| 3-1 | Basic DL control | 1) One configured CORESET per BWP per cell in addition to | n/a |
| | channel | CORESET0 | |
| | | CORESET resource allocation of 6RB bit-map and duration of | |
| | | 1-3 OFDM symbols for (FR)1 | |
| | | For type 1 CSS without dedicated RRC configuration and for | |
| | | type 0, 0A, and 2 CSSs, CORESET resource allocation of 6RB | |
| | | bit-map and duration 1-3 OFDM symbols for FR2 | |
| | | For type 1 CSS with dedicated RRC configuration and for type | |
| | | 3 CSS, UE specific SS, CORESET resource allocation of 6RB | |
| | | bit-map and duration 1-2 OFDM symbols for FR2 | |
| | | REG-bundle sizes of 2/3 RBs or 6 RBs | |
| | | Interleaved and non-interleaved CCE-to-REG mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast PDCCH | |
| | | transmission per BWP per cell | |
| | | PDCCH aggregation levels 1, 2, 4, 8, 16 | |
| | | UP to 3 search space sets in a slot for a scheduled SCell per | |
| | | BWP | |
| | | This search space limit is before applying all dropping rules. | |
| | | For type 1 CSS with dedicated RRC configuration, type 3 CSS, | |
| | | and UE-SS, the monitoring occasion is within the first 3 OFDM | |
| | | symbols of a slot | |
| | | For type 1 CSS without dedicated RRC configuration and for | |
| | | type 0, 0A, and 2 CSS, the monitoring occasion can be any | |
| | | OFDM symbol(s) of a slot, with the monitoring occasions for any | |
| | | of Type 1- CSS without dedicated RRC configuration, or Types | |
| | | 0, 0A, or 2 CSS configurations within a single span of three | |
| | | consecutive OFDM symbols within a slot | |
| | | 3) Monitoring DCI formats 0_0, 1_0, 0_1, 1_1 | |
| | | 4) Number of PDCCH blind decodes per slot with a given SCS | |
| | | follows Case 1-1 table | |
| | | 5) Processing one unicast DCI scheduling DL and one unicast | |
| | | DCI scheduling UL per slot per scheduled CC for FDD | |
| | | 6) Processing one unicast DCI scheduling DL and 2 unicast DCI | |
| | | scheduling UL per slot per scheduled CC for TDD | |

UE capability 2 (hereinafter, referred to as “FG 3-2”) will now be described. When the number of MOs for the common search space or the UE-specific search space is one within the slot as shown in Table 11-2 below, the UE capability is a capability to perform monitoring regardless of the start symbol location of the corresponding MO. The UE capability can be optionally supported by the UE, and whether to support the capability is explicitly reported to the BS.

TABLE 11-2

| | | | Field name in |
|---|---|---|---|
| Index | Feature group | Components | TS 38.331 [2] |
| 3-2 | PDCCH monitoring | For a given UE, all search space configurations are within | pdcchMonitoringSingleOccasion |
| | on any span of up to 3 | the same span of 3 consecutive OFDM symbols in the slot. | |
| | consecutive OFDM | | |
| | symbols of a slot | | |

UE capability 3 (hereinafter, referred to as “FG 3-5”, “FG 3-5a”, “FG 3-5b”) will now be described. When the number of MOs for the common search space or the UE-specific search space is plural within the slot, as shown in Table 11-3 below, the UE capability indicates a pattern of MOs which the UE can monitor. The pattern includes an interval X between start symbols of different MOs and a maximum symbol length Y of one MO. A combination of (X,Y) supported by the UE may be one or more of 1(2,2), (4,3), (7,3)1. The UE capability can be optionally supported by the UE, and whether to support the capability and the combination (X,Y) are explicitly reported to the BS.

TABLE 11-3

| | | | Field name in |
|---|---|---|---|
| Index | Feature group | Components | TS 38.331 [2] |
| 3-5 | For type 1 CSS with dedicated | For type 1 CSS with dedicated RRC configuration, type 3 CSS, and UE-SS, | pdcch- |
| | RRC configuration, type 3 CSS, | monitoring occasion can be any OFDM symbol(s) of a slot for Case 2. | MonitoringAnyOccasions |
| | and UE-SS, monitoring occasion | | {3-5. withoutDCI-Gap |
| | can be any OFDM symbol(s) of | | 3-5a. withDCI-Gap} |
| | a slot for Case 2. | | |
| 3-5a | For type 1 CSS with dedicated | For type 1 CSS with dedicated RRC configuration, type 3 CSS and UE-SS, | |
| | RRC configuration, type 3 CSS, | monitoring occasion can be any OFDM symbol(s) of a slot for Case 2, with | |
| | and UE-SS, monitoring occasion | minimum time separation (including the cross-slot boundary case) between | |
| | can be any OFDM symbol(s) of | two DL unicast DCIs, between two UL unicast DCIs, or between a DL and | |
| | a slot for Case 2 with a DCI | a UL unicast DCI in different monitoring occasions where at least one | |
| | gap. | of them is not the monitoring occasions of FG-3-1, for a same UE as: | |
| | | 2 OFDM symbols for 15 kHz; | |
| | | 4 OFDM symbols for 30 kHz; | |
| | | 7 OFDM symbols for 60 kHz with NCP; or | |
| | | 11 OFDM symbols for 120 kHz | |
| | | Up to one unicast DL DCI and up to one unicast UL DCI in a monitoring | |
| | | occasion except for the monitoring occasions of FG 3-1. | |
| | | In addition for TDD, the minimum separation between the first two UL | |
| | | unicast DCIs within the first 3 OFDM symbols of a slot can be zero OFDM | |
| | | symbols. | |
| 3-5b | All PDCCH monitoring occasions | PDCCH monitoring occasions of FG-3-1, plus additional PDCCH monitoring | |
| | can be any OFDM symbol(s) of | occasion(s) can be any OFDM symbol(s) of a slot for Case 2, and for | |
| | a slot for Case 2 with a span | any two PDCCH monitoring occasions belonging to different spans, where | |
| | gap. | at least one of them is not the monitoring occasions of FG-3-1, in same | |
| | | or different search spaces, there is a minimum time separation of X OFDM | |
| | | symbols (including the cross-slot boundary case) between the start of | |
| | | two spans, where each span is of length up to Y consecutive OFDM symbols | |
| | | of a slot. Spans do not overlap. Every span is contained in a single slot. | |
| | | The same span pattern repeats in every slot. The separation between | |
| | | consecutive spans within and across slots may be unequal but the same (X, | |
| | | Y) limit must be satisfied by all spans. Every monitoring occasion is fully | |
| | | contained in one span. In order to determine a suitable span pattern, first | |
| | | a bitmap b(l), 0 <= l <= 13 is generated, where b(l) = 1 if symbol | |
| | | 1 of any slot is part of a monitoring occasion, b(l) = 0 otherwise. | |
| | | The first span in the span pattern begins at the smallest 1 for which b(l) = | |
| | | 1. The next span in the span pattern begins at the smallest 1 not included | |
| | | in the previous span(s) for which b(l) = 1. The span duration is | |
| | | max{maximum value of all CORESET durations, minimum value of Y in the | |
| | | UE reported candidate value} except possibly the last span in a slot | |
| | | which can be of shorter duration. A particular PDCCH monitoring | |
| | | configuration meets the UE capability limitation if the span arrangement | |
| | | satisfies the gap separation for at least one (X, Y) in the UE reported | |
| | | candidate value set in every slot, including cross slot boundary. | |
| | | For the set of monitoring occasions which are within the same span: | |
| | | Processing one unicast DCI scheduling DL and one unicast DCI scheduling | |
| | | UL per scheduled component carrier (CC) across this set of monitoring | |
| | | occasions for FDD. | |
| | | Processing one unicast DCI scheduling DL and two unicast DCI scheduling | |
| | | UL per scheduled CC across this set of monitoring occasions for TDD. | |
| | | Processing two unicast DCI scheduling DL and one unicast DCI scheduling | |
| | | UL per scheduled CC across this set of monitoring occasions for TDD. | |
| | | The number of different start symbol indices of spans for all PDCCH | |
| | | monitoring occasions per slot, including PDCCH monitoring occasions of | |
| | | FG-3-1, is no more than floor(14/X) (X is minimum among values reported | |
| | | by UE). | |
| | | The number of different start symbol indices of PDCCH monitoring occasions | |
| | | per slot including PDCCH monitoring occasions of FG-3-1, is no more than | |
| | | 7. | |
| | | The number of different start symbol indices of PDCCH monitoring occasions | |
| | | per half-slot including PDCCH monitoring occasions of FG-3-1 is no more | |
| | | than 4 in SCell. | |

The UE may report whether to support UE capability 2 and/or UE capability 3 and a relevant parameter to the BS. The BS may allocate time axis resources for the common search space and the UE-specific search space on the basis of the UE capability. In the resource allocation, the BS may not place the MO at the location at which the UE cannot perform monitoring.

PDCCH: BD/CCE Limit

If a plurality of search space sets are configured in the UE, a method of determining a search space set which the UE should monitor may be based on “condition 1” and “condition 2”.

If the UE receives a configuration of a value of monitoringCapabilityConfig-r16 which is higher-layer signaling as r15monitoringcapability, the UE defines the number of PDCCH candidates which can be monitored and a maximum value for the number of CCEs included in entire search spaces (indicating a set of entire CCE sets corresponding to a union area of a plurality of search space sets). When the UE receives a configuration of a value of monitoringCapabilityConfig-r16 as r16monitoringcapability, the UE may define the number of PDCCH candidates which can be monitored and a maximum value for the number of CCEs included in entire search spaces (indicating entire CCE sets corresponding to a union area of a plurality of search space sets) for each span.

Condition 1: Limit on a Maximum Number of PDCCH Candidates

In a cell in which subcarrier spacing is configured as 15·2^{μ} kHz, the maximum number M^{μ} of PDCCH candidates which the UE can monitor according to the configuration value of higher-layer signaling, as described above, follows Table 12-1, shown below, when the maximum number of PDCCH candidates M^{μ} is defined on the basis of a slot or Table 12-2, shown below, when the maximum number M^{μ} of PDCCH candidates is defined on the basis of a span.

TABLE 12-1

| | Maximum number of PDCCH candidates |
|---|---|
| μ | per slot and per serving cell M^{μ} |
| 0 | 44 |
| 1 | 36 |
| 2 | 22 |
| 3 | 20 |

TABLE 12-2

| | Maximum number M^{μ} of monitored | | |
|---|---|---|---|
| | PDCCH candidates per span for | | |
| | combination (X, Y) and per serving cell | | |
| μ | (2, 2) | (4, 3) | (7, 3) |
| 0 | 14 | 28 | 44 |
| 1 | 12 | 24 | 36 |

Condition 2: Limit on a Maximum Number of CCEs

In a cell in which subcarrier spacing is configured as 15·2^{μ} kHz, the maximum number of CCEs included in the entire search spaces (indicating a set of entire CCE sets corresponding to a union area of a plurality of search space sets) according to the configuration value of higher-layer signaling, as described above, follows Table 12-3 when the maximum number C^{μ} of CCEs is defined on the basis of a slot or Table 12-4, shown below, when the maximum number C^{μ} of CCEs is defined on the basis of a span.

TABLE 12-3

| | Maximum number of non-overlapped |
|---|---|
| μ | CCEs per slot and per serving cell (C^{μ}) |
| 0 | 56 |
| 1 | 56 |
| 2 | 48 |
| 3 | 32 |

TABLE 12-4

| | Maximum number C^{μ} of | | |
|---|---|---|---|
| | non-overlapped CCEs per span for | | |
| | combination (X, Y) and per serving cell | | |
| μ | (2, 2) | (4, 3) | (7, 3) |
| 0 | 18 | 36 | 56 |
| 1 | 18 | 36 | 56 |

For convenience of description, a situation satisfying both conditions 1 and 2 at a specific time point is defined as “condition A”. Accordingly, not satisfying condition A may mean that at least one of conditions 1 and 2 is not satisfied.

PDCCH: Overbooking

Condition A may not be satisfied at a specific time point according to a configuration of search space sets by the BS. If condition A is not satisfied at a specific time point, the UE may select and monitor only some of the search space sets configured to satisfy condition A at the corresponding time point, and the BS may transmit the PDCCH through the selected search space sets.

The following method may be applied as a method of selecting some of the configured search space sets.

If condition A for the PDCCH is not satisfied at a specific time point (slot), the UE (or the BS) may select a search space set of which a search space type is configured as a common-search space among search space sets existing at the corresponding time point in preference to a search space set of which a search space type is configured as a UE-specific search space.

If search space sets configured as the common-search space are all selected (that is, if condition A is satisfied even after all search spaces configured as the common-search space are selected), the UE (or BS) may select search space sets configured as the UE-specific search space. At this time, if the number of search space sets of configured as the UE-specific search space is plural, a search space set having a lower search space set index may have a higher priority. UE-specific search space sets may be selected within a range in which condition A is satisfied in consideration of the priority.

DRX

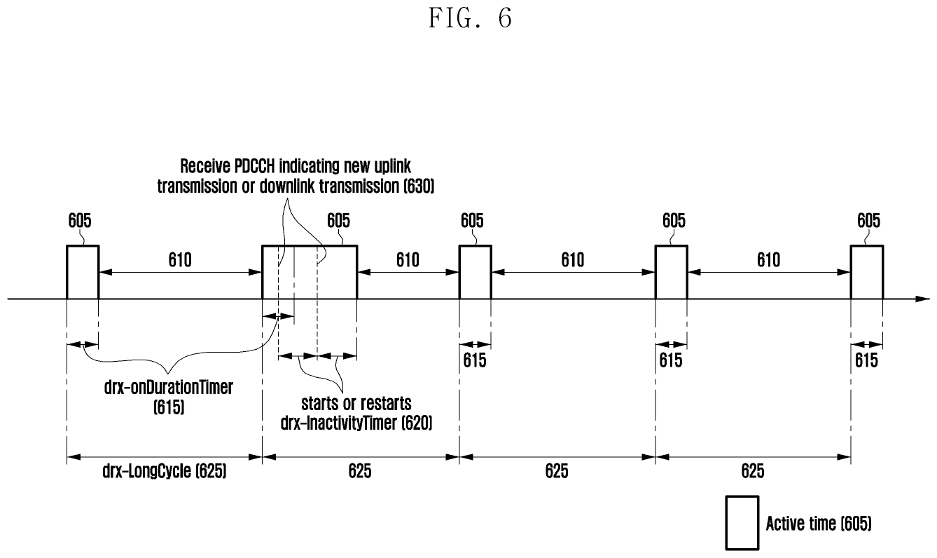

FIG. 6 illustrates an example of a DRX operation in a wireless communication system, according to an embodiment of the disclosure.

DRX is an operation in which the UE using a service discontinuously receives data in an RRC-connected state in which a radio link is established between the BS and the UE. When DRX is applied, the UE may turn on a receiver at a specific time point and monitor a control channel, and when there is no data received for a predetermined period, turn off the receiver to reduce power consumption of the UE. The DRX operation may be controlled by a MAC layer device on the basis of various parameters and a timer.

Referring to FIG. 6, an active time 605 is a time during which the UE wakes up every DRX cycle and monitors a PDCCH. The active time 605 may be defined as follows:
drx-onDurationTimer or drx-InactivityTimer or drx-RetransmissionTimerDL or drx-RetransmissionTimerUL or ra-ContentionResolutionTimer is running;
a Scheduling Request is sent on PUCCH and is pending; or
a PDCCH indicating a new transmission addressed to the C-RNTI of the MAC entity has not been received after successful reception of a random access response for the random access preamble not selected by the MAC entity among the contention-based random access preamble.

drx-onDurationTimer, drx-InactivityTimer, drx-RetransmissionTimerDL, drx-RetransmissionTimerUL, and ra-ContentionResolutionTimer, are timers of which values are configured by the BS, and have functions configured to monitor a PDCCH by the UE in the state in which a predetermined condition is satisfied.

The drx-onDurationTimer 615 is a parameter for configuring a minimum time during which the UE is awake in a DRX cycle. The drx-InactivityTimer 620 is a parameter for configuring a time during which the UE is additionally awake when a PDCCH indicating new uplink transmission or downlink transmission is received as indicated by reference numeral 630. The drx-RetransmissionTimerDL is a parameter for configuring a maximum time during which the UE is awake in order to receive downlink retransmission in a downlink hybrid automatic repeat request (HARQ) procedure. The drx-RetransmissionTimerUL is a parameter for configuring a maximum time during which the UE is awake in order to receive a grant of uplink retransmission in an uplink HARQ procedure. The drx-onDurationTimer, drx-InactivityTimer, drx-RetransmissionTimerDL, and drx-RetransmissionTimerUL may be configured as, for example, a time, the number of subframes, and the number of slots. The ra-ContentionResolutionTimer is a parameter for monitoring a PDCCH in a random access procedure.

An inactive time 610 is a time in which no PDCCH monitoring is performed or a time in which no PDCCH reception is performed during the DRX operation, and the remaining time except for the active time 605 in the entire time in which the DRX operation is performed. When the PDCCH is not monitored during the active time 605, the UE may enter a sleep or inactive state and reduce power consumption.

The DRX cycle refers to a cycle on which the UE wakes up and monitors a PDCCH. That is, the DRX cycle is a time interval or a cycle of a duration from monitoring of the PDCCH to monitoring of the next PDCCH by the UE. The DRX cycle has two types such as a short DRX cycle and a long DRX cycle. The short DRX cycle may be optionally applied.

The long DRX cycle 625 is a longer cycle among the two DRX cycles configured in the UE. The UE starts the drx-onDurationTimer 615 at a time point at which the long DRX cycle 625 passes after a start point (for example, a start symbol) of the drx-onDurationTimer 615 while the long DRX cycle operates. In the operation of the long DRX cycle 625, the UE may start the drx-onDurationTimer 615 in a slot after drx-SlotOffset in a subframe that satisfies Equation 2, below. Here, the drx-SlotOffset is a delay before the drx-onDurationTimer 615 starts. The drx-SlotOffset may be configured as, for example, a time, or the number of slots.

[(SFN×10)+subframe number]modulo(drx-LongCycle)=drx-StartOffset Equation 2

SFN refers to a “single frequency network”. The drx-LongCycleStartOffset and drx-StartOffset may be used to define a subframe for starting the long DRX cycle 625. The drx-LongCycleStartOffset may be configured as, for example, a time, the number of subframes, or the number of slots.

QCL, TCI State

In the wireless communication system, one or more different antenna ports (or one or more channels, signals, and combinations thereof, but commonly referred to as different antenna ports for convenience of description) may be associated by a QCL configuration shown in Table 13, below. The TCI state is to inform of a QCL relation between a PDCCH (or a PDCCH DMRS) and another RS or channel, and a reference antenna port A (e.g., reference RS #A) and another purpose antenna port B (e.g., target RS #B) which are QCLed means that the UE is allowed to apply some or all of large-scale channel parameters estimated in the antenna port A to channel measurement from the antenna port B. The QCL is required to associate different parameters according to conditions, such as time tracking influenced by average delay and delay spread, frequency tracking influenced by Doppler shift and Doppler spread, radio resource management (RRM) influenced by an average gain, and beam management (BM) influenced by a spatial parameter. Accordingly, NR supports four types of QCL relations shown in Table 13, below.

TABLE 13

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

A spatial Rx parameter may refer to some or all of an angle of arrival (AoA), a power angular spectrum (PAS) of AoA, an angle of departure (AoD), a PAS of AoD, a transmission/reception channel correlation, transmission/reception beamforming, and a spatial channel correlation.

The QCL relation can be configured in the UE through RRC parameter TCI-state and QCL-Info as shown in Table 19, below. Referring to Table 14 below, the BS may configure one or more TCI states in the UE and inform the UE of a maximum of two QCL relations (QCL-Type 1 and QCL-Type 2) for an RS referring to an ID of the TCI state, that is, a target RS. At this time, each piece of the QCL information (QCL-Info) included in the TCI state includes a serving cell index and a BWP index of a reference RS indicated by the corresponding QCL information, a type and an ID of the reference RS, and the QCL type as shown in Table 13, above.

TABLE 14

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring
to corresponding TCI state ID)

| | |
|---|---|
| qcl-Type2 | QCL-Info |

```
      OPTIONAL, -- NeedR
  (QCL information of second reference RS of RS (target RS)
referring to corresponding TCI state ID)
  ...
```

| | |
|---|---|
| } | |
| QCL-Info ::= | SEQUENCE { |
| cell | ServCellIndex |
| OPTIONAL, -- NeedR | |

```
  (serving cell index of reference RS indicated by corresponding
  QCL information)
```

| | |
|---|---|
| bwp-Id | BWP-Id |

```
        OPTIONAL, -- Cond CSI-RS-Indicated
  (BWP index of reference RS indicated by corresponding QCL
  information)
```

| | |
|---|---|
| referencesignal | CHOICE { |
| csi-rs | NZP-CSI-RS- |

ResourceId,

| | |
|---|---|
| ssb | SSB- |

```
Index
    (one of CSI-RSI ID or SSB ID indicated by corresponding QCL
information)
  },
```

| | |
|---|---|
| qcl-Type | ENUMERATED |

{typeA, typeB, typeC, typeD},
...
}

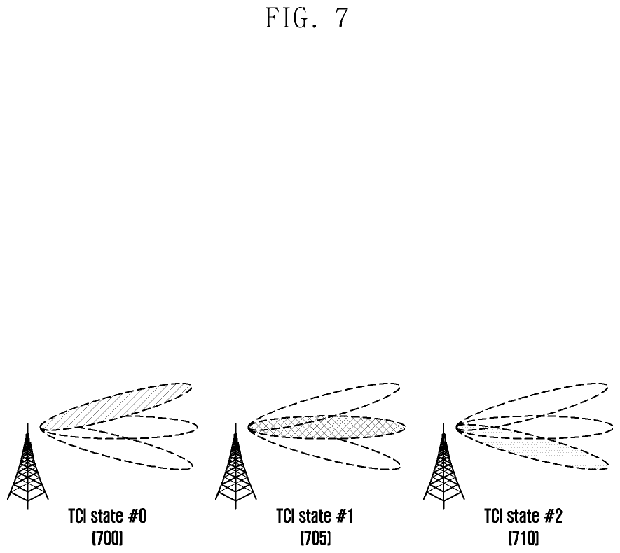

FIG. 7 illustrates an example of BS beam allocation according to a TCI state configuration in a wireless communication system, according to an embodiment of the disclosure.

Referring to FIG. 7, the BS may transmit information on N different beams to the UE through N different TCI states. The N represents the number of beams or the number of TCI states. For example, when N=3 as illustrated in FIG. 7, the BS may notify that a qcl-Type 2 parameter included in three TCI states 700, 705, and 710 is associated with a CSI-RS or SSB corresponding to different beams to be configured as QCL type D and antenna ports referring to the different TCI states 700, 705, and 710 are associated with different spatial Rx parameters, that is, different beams.

Table 15-1 to Table 15-5, below, show valid TCI state configurations according to the target antenna port type.

Table 15-1 shows valid TCI state configurations when the target antenna port is a CSI-RS for tracking (TRS). The TRS is an NZP CSI-RS for which a repetition parameter is not configured and trs-Info is configured as true among CSI-RSs. The third configuration in Table 15-1 may be used for an aperiodic TRS.

TABLE 15-1

| Valid TCI | | | | |
|---|---|---|---|---|
| state | | | | |
| Config- | | | DL RS 2 | qcl-Type 2 |
| uration | DL RS 1 | qcl-Type 1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 15-2 shows valid TCI state configurations when the target antenna port is a CSI-RS for CSI. The CSI-RS for CSI is an NZP CSI-RS for which a parameter (for example, a repetition parameter) indicating repetition is not configured and trs-Info is not configured as true among the CSI-RSs.

TABLE 15-2

| Valid TCI | | | | |
|---|---|---|---|---|
| state | | | | |
| Config- | | | DL RS 2 | qcl-Type 2 |
| uration | DL RS 1 | qcl-Type 1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 15-3 shows valid TCI state configurations when the target antenna port is a CSI-RS for BM (that is, the same meaning as a CSI-RS for L1 RSRP reporting). The CSI-RS for BM is an NZP CSI-RS for which a repetition parameter is configured to have a value of on or off and trs-Info is not configured as true.

TABLE 15-3

| Valid TCI | | | | |
|---|---|---|---|---|
| state | | | | |
| Config- | | | DL RS 2 | qcl-Type 2 |
| uration | DL RS 1 | qcl-Type 1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH block | QCL-TypeD |

Table 15-4 shows valid TCI state configurations when the target antenna port is a PDCCH DMRS.

TABLE 15-4

| Valid TCI | | | | |
|---|---|---|---|---|
| state | | | | |
| Config- | | | DL RS 2 | qcl-Type 2 |
| uration | DL RS 1 | qcl-Type 1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 15-5 shows valid TCI state configurations when the target antenna port is a PDCCH DMRS.

TABLE 15-5

| Valid TCI | | | | |
|---|---|---|---|---|
| state | | | | |
| Config- | | | DL RS 2 | qcl-Type 2 |
| uration | DL RS 1 | qcl-Type 1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

In a representative QCL configuration method by Table 15-1 to Table 15-5, the target antenna port and the reference antenna port for each step are configured and operated as “SSB”->“TRS”->“CSI-RS for CSI, CSI-RS for BM, PDCCH DMRS, or PDSCH DMRS”. In a representative QCL configuration method by Table 20 to Table 24, the target antenna port and the reference antenna port for each step are configured and operated as “SSB”->“TRS”->“CSI-RS for CSI, CSI-RS for BM, PDCCH DMRS, or PDSCH DMRS”.

PDCCH: TCI State

TCI state combinations which can be applied to the PDCCH DMRS antenna port may be as shown in Table 16, below. In Table 16, a fourth row is a combination assumed by the UE before the RRC configuration, and configurations after RRC are impossible.

TABLE 16

| Valid TCI | | | | |
|---|---|---|---|---|
| state | | | | |
| Config- | | | DL RS 2 | qcl-Type2 |
| uration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| | (CSI) | | | |
| 4 | SS/PBCH | QCL-TypeA | SS/PBCH | QCL-TypeD |
| | Block | | Block | |

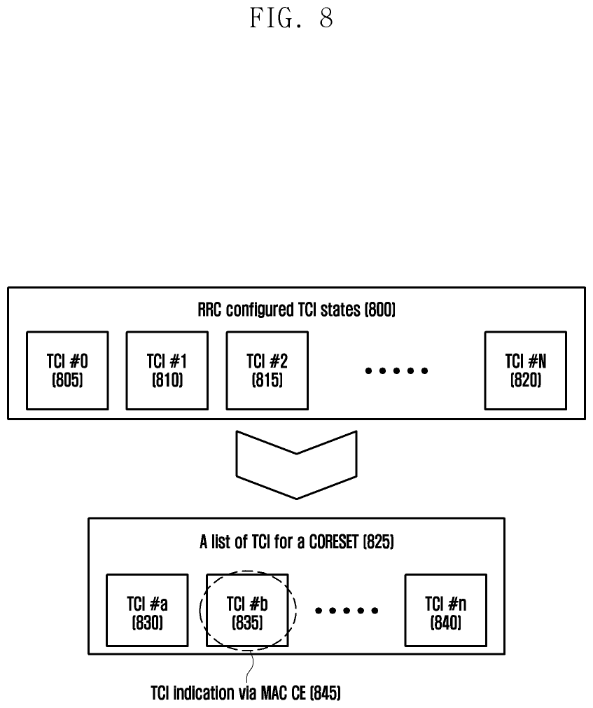

FIG. 8 illustrates an example of a method of allocating TCI states for a PDCCH in a wireless communication system, according to an embodiment of the disclosure.

In NR system, a hierarchical signaling method as illustrated in FIG. 8 is supported for dynamic allocation for a PDCCH beam. Referring to FIG. 8, the BS may configure N TCI states 805, 810, 815 . . . , 820 in the UE through RRC signaling 800 and configure some thereof as TCI states for the CORESET as indicated by reference numeral 825. Thereafter, the BS may indicate one of the TCI states 830, 835, and 840 for the CORESET to the UE through MAC CE signaling as indicated by reference numeral 845. Subsequently, the UE may receive a PDCCH on the basis of beam information included in the TCI states indicated by the MAC CE signaling.

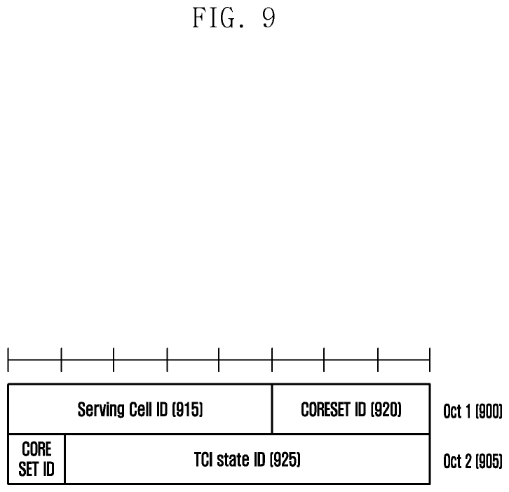

FIG. 9 illustrates a TCI indication MAC CE indication signaling structure for a PDCCH DMRS in a wireless communication system according to an embodiment of the disclosure.

Referring to FIG. 9, TCI indication MAC CE signaling for the PDCCH DMRS may consist of 2 bytes (16 bits, i.e., octet 1, 900 and octet 2, 905), and may include a serving cell ID 915 of 5 bits, a CORESET ID 920 of 4 bits, and a TCI state ID 925 of 7 bits.

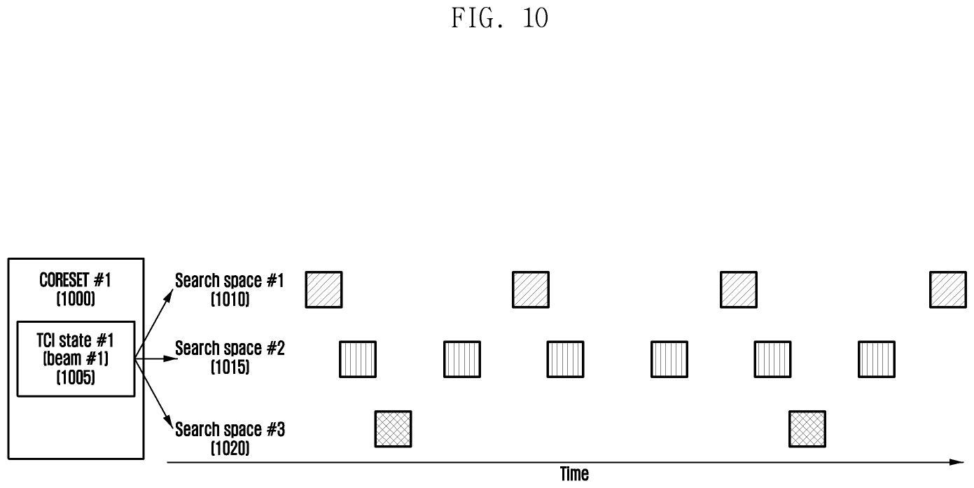

FIG. 10 illustrates an example of a CORESET and search space beam configuration in a wireless communication system, according to an embodiment of the disclosure.

Referring to FIG. 10, the BS may indicate one of the TCI state list included in the configuration of a CORESET 1000 through MAC CE signaling as indicated by reference numeral 1005. Thereafter, before another TCI state is indicated to the corresponding CORESET through different MAC CE signaling, the UE may consider that the same QCL information (beam #1) 1005 is applied to one or more search spaces 1010, 1015, and 1050 associated with the CORESET. The PDCCH beam allocation method has difficulty indicating a beam change earlier than a MAC CE signaling delay and has a disadvantage of applying the same beam to all CORESETs regardless of a search space characteristic, and thus causes flexible PDCCH beam operation to be difficult. Hereinafter, embodiments of the disclosure provide a more flexible PDCCH beam configuration and operation method. In the following embodiments of the disclosure, some distinguished examples are provided for convenience of description, but they are not exclusive and can be applied through a proper combination thereof according to circumstances.

The BS may configure one or a plurality of TCI states for a specific CORESET in the UE and activate one of the configured TCI states through a MAC CE activation command. For example, {TCI state #0, TCI state #1, TCI state #2} are configured in CORESET #1 as the TCI states, and the BS may transmit a command for activating TCI state #0 assumed as the TCI state for CORESET #1 to the UE through the MAC CE. The UE may correctly receive a DMRS of the corresponding CORESET on the basis of QCL information within the activated TCI state by means of the activation command for the TCI state received through the MAC CE.

When the UE does not receive the MAC CE activation command for the TCI state of CORESET #0 for the CORESET having an index of 0, the UE may assume that a DMRS transmitted in CORESET #0 is QCLed with an SS/PBCH block identified in an initial access process or a non-contention-based random access process which is not triggered by a PDCCH command.

When the UE does not receive a configuration of the TCI state for CORESET #X or the UE receives the configuration of one or more TCI states but does not receive a MAC CE activation command for activating one thereof, the UE may assume that a DMRS transmitted in CORESET #X is QCLed with an SS/PBCH block identified in an initial access process.

PDCCH: Related to QCL Prioritization Rule

Hereinafter, an operation for determining a QCL priority for a PDCCH is described in detail.

When the UE operates with carrier aggregation in a single or band and a plurality of control resource sets existing within an activated BWP in a single cell or a plurality of cells overlap in the time while having the same or different QCL-TypeD characteristics in a specific PDCCH monitoring occasion, the UE may select a specific control resource set according to a QCL priority determination operation and monitor control resource sets having the same QCL-TypeD characteristic as the corresponding control resource set. That is, a plurality of control resource sets overlap in the time, only one QCL-TypeD characteristic may be received. At this time, a reference to determining the QCL priority is described below.
Reference 1. a control resource set connected to a common search space having the lowest index within a cell corresponding to the lowest index among cells including the common search space
Reference 2. a control resource set connected to a UE-specific search space having the lowest index in a cell corresponding to the lowest index among cells including the UE-specific search space

As described above, when the corresponding references are not satisfied, the following reference is applied. For example, when control resource sets overlap in the time in a specific PDCCH monitoring section, if all control resource sets are connected to a UE-specific search space without being connected to a common search space, that is, if reference 1 is not satisfied, the UE may omit applying of reference 1 and apply reference 2.

When the control resource set is selected by the references, the UE may additionally consider two matters below for QCL information configured in the control resource set. First, when control resource set 1 has CSI-RS 1 as a reference signal having the relation of QCL-TypeD, a reference signal having the relation of QCL-TypeD with CSI-RS 1 is SSB1, and a reference signal having the relation of QCL-TypeD with control resource set 2 is SSB1, the UE may consider that two control resource sets 1 and 2 have different QCL-TypeD characteristics. Second, when control resource set 1 has CSI-RS 1 configured in cell 1 as a reference signal having the relation of QCL-TypeD, a reference signal having the relation of QCL-TypeD with CSI-RS1 is SSB1, control resource set 2 has CSI-RS 2 configured in cell 2 as a reference signal having the relation of QCL-TypeD, and a reference signal having the relation of QCL-TypeD with CSI-RS 2 is SSB 1, the UE may consider that the two control resource sets have the same QCL-TypeD characteristic.

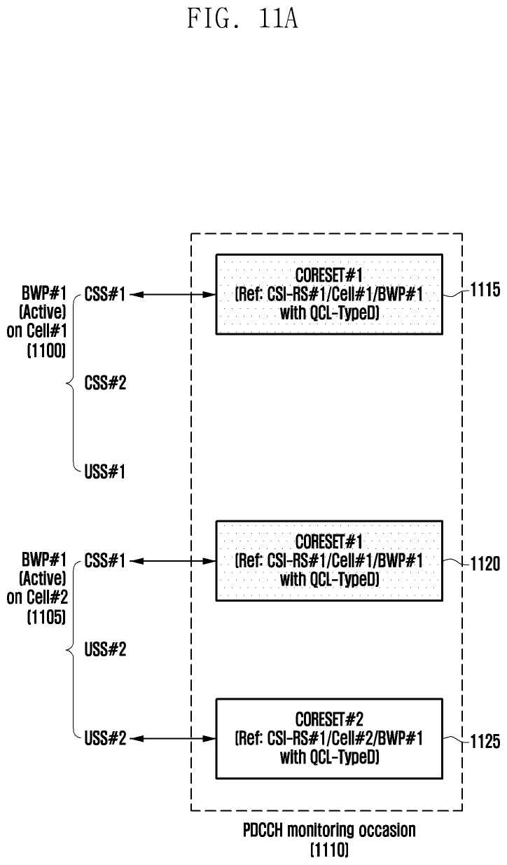

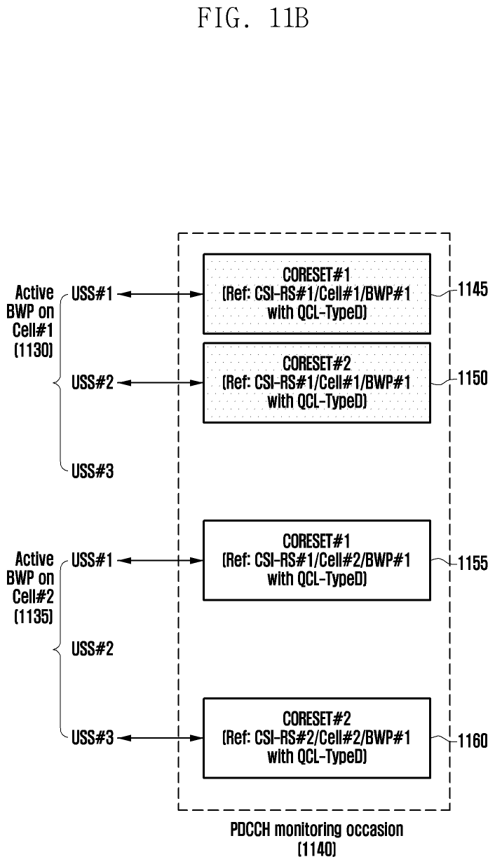

FIGS. 11A and 11B illustrate a method of selecting a control resource set which can be received in consideration of a priority when the UE receives a downlink control channel in a wireless communication system according to an embodiment of the disclosure. For example, the UE may receive a configuration of reception of a plurality of control resource sets overlapping in the time in a specific PDCCH monitoring occasion 1110, and the plurality of control resource sets may be connected to a common search space or a UE-specific search space for a plurality of cells. In the corresponding PDCCH monitoring occasion, a first control resource set 1115 connected to a first common search space may exist within a first BWP 1100 of a first cell and a first control resource set 1120 connected to a first common search space and a second control resource set 1125 connected to a second UE-specific search space may exist within a first BWP 1105 of a second cell. The control resource sets 1115 and 1120 may have the relation of QCL-TypeD with a first CSI-RS resource configured within the first BWP of the first cell, and the control resource set 1125 may have the relation of QCL-TypeD with the first CSI-RS resource configured within the first BWP of the second cell. Accordingly, when reference 1 is applied to the corresponding PDCCH monitoring occasion 1110, all other control resource sets having the reference signal of QCL-TypeD which is the same as the first control resource set 1115 may be received. Accordingly, the UE may receive the control resource sets 1115 and 1120 in the corresponding PDCCH monitoring occasion 1110. In another example, the UE may receive a configuration of reception of a plurality of control resource sets overlapping in the time in a specific PDCCH monitoring occasion 1140, and the plurality of control resource sets may be connected to a common search space or a UE-specific search space for a plurality of cells. In the corresponding PDCCH monitoring occasion, a first control resource set 1145 connected to a first UE-specific search space and a second control resource set 1150 connected to a second UE-specific search space may exist within a first BWP 1130 of a first cell and a first control resource set 1155 connected to a first UE-specific search space and a second control resource set 1160 connected to a third UE-specific search space may exist within a first BWP 1135 of a second cell. The control resource sets 1145 and 1150 may have the relation of QCL-TypeD with a first CSI-RS resource configured within the first BWP of the first cell, the control resource set 1155 may have the relation of QCL-TypeD with the first CSI-RS resource configured within the first BWP of the second cell, and the control resource set 1160 may have the relation with QCL-TypeD with a second CSI-RES resource configured within the first BWP of the second cell. However, when reference 1 is applied to the corresponding PDCCH monitoring occasion 1140, there is no common search space, and thus reference 2 which is the following reference may be applied. When reference 2 is applied to the corresponding PDCCH monitoring occasion 1140, all other control resource sets having the reference signal of QCL-TypeD which is the same as the control resource set 1145 may be received. Accordingly, the UE may receive the control resource sets 1145 and 1150 in the corresponding PDCCH monitoring occasion 1140.

Related to Rate Matching/Puncturing

In the following description, a rate matching operation and a puncturing operation are described in detail.

When a time at which a predetermined symbol sequence A is transmitted and frequency resources A overlap a predetermined time and frequency resources B, a rate matching or puncturing operation may be considered as a transmission/reception operation of a channel A considering of resources C in an area in which the resources A and the resources B overlap each other. A detailed operation may follow the content below.

Rate Matching Operation
The BS may map and transmit the channel A only for the remaining resource areas except for the resources C corresponding to the area in which the entire resources A for transmitting the symbol sequence A to the UE overlap the resources B. For example, when the symbol sequence A includes {symbol #1, symbol #2, symbol #3, symbol #4}, the resources A are {resource #1, resource #2, resource #3, resource #4}, and the resources B are {resource #3, resource #5}, the BS may sequentially map the symbol sequence A to the remaining resources {resource #1, resource #2, resource #4} except for {resource #3} corresponding to the resources C among the resources A and transmit the same. As a result, the BS may map the symbol sequence {symbol #1, symbol #2, symbol #3} to {resource #1, resource #2, resource #4}, respectively, and transmit the same.

The UE may determine the resources A and the resources B on the basis of scheduling information for the symbol sequence A from the BS and determine the resources C in the area in which the resources A and the resources B overlap each other. The UE may receive the symbol sequence A on the basis of the assumption that the symbol sequence A is mapped to and transmitted in the remaining areas except for the resources C among the entire resources A. For example, when the symbol sequence A includes {symbol #1, symbol #2, symbol #3, symbol #4}, the resources A are {resource #1, resource #2, resource #3, resource #4}, and the resources B are {resource #3, resource #5}, the UE may receive the symbol sequence A on the basis of the assumption that the symbol sequence A is sequentially mapped to the remaining resources {resource #1, resource #2, resource #4} except for {resource #3} corresponding to the resources C among the resources A. As a result, the UE may perform a series of reception operation later on the basis of the assumption that the symbol sequence {symbol #1, symbol #2, symbol #3} is mapped to and transmitted in {resource #1, resource #2, resource #4}, respectively.

Puncturing Operation

When there are resources C corresponding to an area in which the entire resources A for transmitting the symbol sequence A to the UE overlap the resources B, the BS may map the symbol sequence A to all the resources A, but may perform transmission only in the remaining resource areas except for the resources C among the resources A without transmission in a resource area corresponding to the resources C. For example, when the symbol sequence A includes {symbol #1, symbol #2, symbol #3, symbol #4}, the resources A are {resource #1, resource #2, resource #3, resource #4}, and the resources B are {resource #3, resource #5}, the BS may map the symbol sequence A includes {symbol #1, symbol #2, symbol #3, symbol #4} to the resources A {resource #1, resource #2, resource #3, resource #4}, respectively, and transmit only the symbol sequence {symbol #1, symbol #2, symbol #4} corresponding to the remaining resources {resource #1, resource #2, resource #4} except for {resource #3} corresponding to the resources C among the resources A without transmission of {symbol #3} mapped to {resource #3} corresponding to the resources C. As a result, the BS may map the symbol sequence {symbol #1, symbol #2, symbol #4} to {resource #1, resource #2, resource #4}, respectively, and transmit the same.

The UE may determine the resources A and the resources B on the basis of scheduling information for the symbol sequence A from the BS and determine the resources C in the area in which the resources A and the resources B overlap each other. The UE may receive the symbol sequence A on the basis of the assumption that the symbol sequence A is mapped to the entire resources A but is transmitted only in the remaining areas except for the resources C among the resources A. For example, when the symbol sequence A includes {symbol #1, symbol #2, symbol #3, symbol #4}, the resources A are {resource #1, resource #2, resource #3, resource #4}, and the resources B are {resource #3, resource #5}, the UE may assume that the symbol sequence A {symbol #1, symbol #2, symbol #3, symbol #4} is mapped to the resources A {resource #1, resource #2, resource #3, resource #4}, respectively, but {symbol #3} mapped to {resource #3} corresponding to the resources C is not transmitted, and may perform reception on the basis the assumption that the symbol sequence {symbol #1, symbol #2, symbol #4} corresponding to the remaining resources {resource #1, resource #2, resource #4} except for {resource #3} corresponding to the resources C among the resources A is mapped and transmitted. As a result, the UE may perform a series of reception operations later on the basis of the assumption that the symbol sequences {symbol #1, symbol #2, symbol #4} are mapped to and transmitted in {resource #1, resource #2, resource #4}, respectively.

In the following description, a method of configuring rate matching resources for the purpose of rate matching in the 5G communication system is described. Rate matching refers to the control of the size of a signal in consideration of the amount of resources available for transmitting the signal. For example, rate matching of a data channel may mean mapping data channels to specific time and frequency resource domains without transmission, so as to control the size of data according thereto.

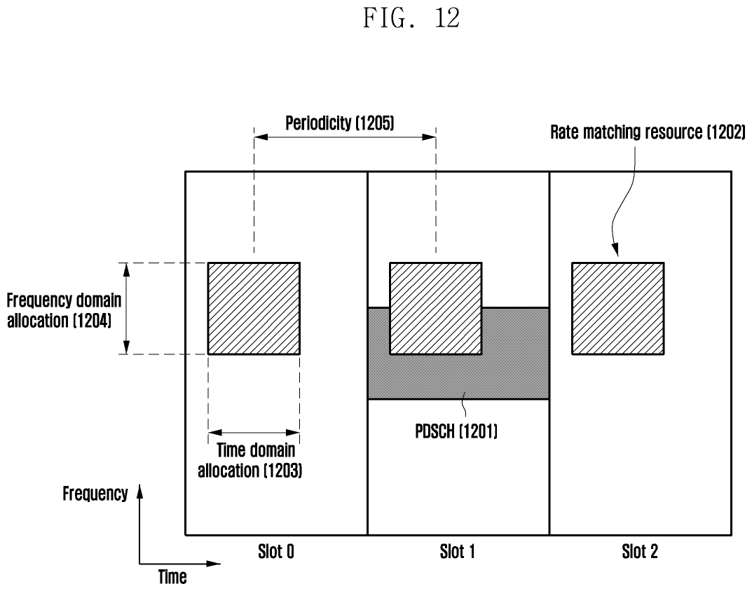

FIG. 12 illustrates a method by which the BS and the UE transmit and receive data in consideration of a downlink data channel and rate matching resources according to an embodiment of the disclosure.

Referring to FIG. 12, a downlink data channel (PDSCH) 1201 and a rate matching resource 1202 are illustrated. The BS may configure one or a plurality of rate matching resources 1202 in the UE through higher-layer signaling (for example, RRC signaling). The rate matching resource 1202 configuration information may include time axis resource allocation information 1203, frequency axis resource allocation information 1204, and period information 1205. In the following description, a bitmap corresponding to the frequency axis resource allocation information 1204 is named a “first bitmap”, a bitmap corresponding to the time axis resource allocation information 1203 is named a “second bitmap”, and a bitmap corresponding to the period information 1205 is named a “third bitmap”. When all or some of the time and frequency resources of the scheduled data channel 1201 overlap the configured rate matching resources 602, the BS may rate-match the data channel 1201 in the part of the rate matching resources 1202 and transmit the data channel, and the UE may perform reception and decoding on the basis of the assumption that the data channel 1201 is rate-matched in the part of the rate matching resources 1202.

The BS may dynamically notify the UE of whether to rate-match the data channel in the configured rate matching resource part through an additional configuration (corresponding to a “rate matching indicator” in the above-described DCI format). Specifically, the BS may select some of the configured rate matching resources, group the selected rate matching resources into a rate matching resource group, and inform the UE of whether to perform rate matching on the data channel for each rate matching resource group through DCI using a bitmap scheme. For example, when 4 rate matching resources, RMR #1, RMR #2, RMR #3, and RMR #4 are configured, the BS may configure rate matching groups RMG #1={RMR #1, RMR #2} and RMG #2={RMR #3, RMR #4}, and inform the UE of whether to perform rate matching in each of RMG #1 and RMG #2 by using 2 bits within a DCI field. For example, “1” may be indicated when rate matching should be performed, and “0” may be indicated when rate matching should not be performed.

In the 5G system, granularity at an “RB symbol level” and an “RE level” is supported as a method of configuring the rate matching resource in the UE. More specifically, the following configuration method may be used.

RB Symbol Level

The UE may receive a configuration of a maximum of 4 RateMatchPatterns through higher-layer signaling, and one RateMatchPattern may include the following content.
As reserved resources within a BWP, resources in which time and frequency resource areas of the corresponding reserved resources are configured by a combination of a bitmap at an RB level and a bitmap at a symbol level in the frequency axis may be included. The reserved resources may span one or two slots. A time domain pattern (periodicityAndPattern) in which the time and frequency domains including a pair of bitmaps at the RB level and the symbol level are repeated may be additionally configured.
Time and frequency domain resource areas configured as CORESETs within the BWP and resource areas corresponding to a time domain pattern configured as a search space configuration in which the corresponding resource areas are repeated may be included.

RE Level

The UE may receive a configuration of the following content through higher-layer signaling.
As configuration information for Res corresponding to a LTE cell-specific reference signal or common reference signal (CRS) pattern, the number of LTE CSR ports (nrofCRS-Ports), values of LTE-CRS-vshift(s) (v-shift), information on a center subcarrier location (carrierFreqDL) of an LTE carrier from a frequency point that is a reference (for example, reference point A), information on a bandwidth size of an LTE carrier (carrierBandwidthDL), subframe configuration information (mbsfn-SubframConfigList) corresponding to a multicast-broadcast single-frequency network (MBSFN), and the like may be included. The UE may determine the location of the CRS within the NR slot corresponding to the LTE subframe on the basis of the above-described information.
Configuration information for a resource set corresponding to one or a plurality of zero power (ZP) CSI-RSs within the BWP may be included.

Related to LTE CRS Rate Match

Subsequently, the rate match process for the LTE CRS is described in detail. For the coexistence of long-term evolution (LTE) and new RAT (NR) (LTE-NR coexistence), NR provides a function of configuring a pattern of cell-specific reference signal (CRS) of LTE to an NR UE. More specifically, the CRS pattern may be provided by RRC signaling including at least one parameter within a ServingCellConfig information element (IE) or a ServingCellConfigCommon IE. The parameters may be, for example, lte-CRS-ToMatchAround, lte-CRS-PatternList1-r16, lte-CRS-PatternList2-r16, crs-RateMatch-PerCORESETPoolIndex-r16, and the like.

In Rel-15 NR, a function of configuring one CRS pattern per serving cell may be provided through the parameter lte-CRS-ToMatchAround. In Rel-16 NR, the function is expanded to configure a plurality of CRS patterns per serving cell. More specifically, one CRS pattern per LTE carrier may be configured in a single-transmission and reception point (TRP) configuration UE, and two CRS patterns per LTE carrier may be configured in a multi-TRP configuration UE. For example, a maximum of three CRS patterns per serving cell may be configured in the single-TRP configuration UE through the parameter lte-CRS-PatternList1-r16. In another example, the CRS may be configured for each TRP in the multi-TRP configuration UE. That is, a CRS pattern for TRP1 may be configured through the parameter lte-CRS-PatternList1-r16, and a CRS pattern for TRP2 may be configured through the parameter lte-CRS-PatternList2-r16. Meanwhile, when the two TRPs are configured, whether to apply all of the CRS patterns of TRP1 and TRP2 to a specific physical downlink shared channel (PDSCH) or only the CRS pattern for one TRP is determined through the parameter crs-RateMatch-PerCORESETPoolIndex-r16, and only the CRS pattern of one TRP is applied when the parameter crs-RateMatch-PerCORESETPoolIndex-r16 is configured to be enabled and, otherwise, all of the CRS patterns of the two TRPs are applied.

Table 17 shows the ServingCellConfig IE including the CRS pattern, and Table 18 shows the RateMatchPatternLTE-CRS IE including at least one parameter for the CRS pattern.

TABLE 17

| | |
|---|---|
| ServingCellConfig ::= | SEQUENCE { |

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- NeedM

| | |
|---|---|
| downlinkBWP-ToReleaseList | SEQUENCE (SIZE (1..maxNrofBWPs)) OF BWP- |

Id OPTIONAL, -- Need N

| | |
|---|---|
| downlinkBWP-ToAddModList | SEQUENCE (SIZE (1..maxNrofBWPs)) OF |

| | |
|---|---|
| BWP-Downlink | OPTIONAL, -- Need N |

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, ms5, ms6, ms8, ms10, |

ms20, ms30,

ms40, ms50, ms60, ms80, ms100, ms200, ms300, ms500,
ms750, ms1280, ms1920, ms2560, spare10, spare9,

spare8,

spare7, spare6, spare5, spare4, spare3, spare2, sparel }

OPTIONAL, --NeedR

| | |
|---|---|
| defaultDownlinkBWP-Id | BWP-Id |

OPTIONAL, -- NeedS

| | |
|---|---|
| uplinkConfig | UplinkConfig |

OPTIONAL, -- NeedM

| | |
|---|---|
| supplementary Uplink | UplinkConfig |

OPTIONAL, -- NeedM

| | |
|---|---|
| pdcch-ServingCellConfig | SetupRelease { PDCCH-ServingCellConfig } |

OPTIONAL, -- NeedM

| | |
|---|---|
| pdsch-ServingCellConfig | SetupRelease { PDSCH-ServingCellConfig } |

OPTIONAL, -- NeedM

| | |
|---|---|
| csi-MeasConfig | SetupRelease { CSI-MeasConfig } |

OPTIONAL, -- NeedM

| | |
|---|---|
| sCellDeactivationTimer | ENUMERATED {ms20, ms40, ms80, ms160, ms200, |

ms240,

ms320, ms400, ms480, ms520, ms640, ms720,
ms840, ms1280, spare2, spare1} OPTIONAL, --

Cond ServingCellWithoutPUCCH

| | |
|---|---|
| crossCarrierScheduling Config | CrossCarrierSchedulingConfig |

OPTIONAL, -- NeedM

| | |
|---|---|
| tag-Id | TAG-Id, |

| | |
|---|---|
| dummy | ENUMERATED {enabled} |

OPTIONAL, -- NeedR

| | |
|---|---|
| pathlossReferenceLinking | ENUMERATED {spCell, sCell} |

OPTIONAL, -- Cond ScellOnly

| | |
|---|---|
| servingCellMO | MeasObjectId |

```
OPTIONAL, -- Cond MeasObject
  ...,
  [[
```

| | |
|---|---|
| Ite-CRS-ToMatchAround | SetupRelease { RateMatchPatternLTE-CRS } |

OPTIONAL, -- NeedM

| | |
|---|---|
| rateMatchPatternToAddModList | SEQUENCE (SIZE |

(1..maxNrofRateMatchPatterns)) OF RateMatchPattern OPTIONAL, -- NeedN

| | |
|---|---|
| rateMatchPatternToReleaseList | SEQUENCE (SIZE |

(1..maxNrofRateMatchPatterns)) OF RateMatchPatternld OPTIONAL, -- NeedN

| | |
|---|---|
| downlinkChannelBW-PerSCS-List | SEQUENCE (SIZE (1..maxSCSs)) OF SCS- |

| | |
|---|---|
| SpecificCarrier | OPTIONAL -- Need S |

```
  ]],
  [[
```

| | |
|---|---|
| supplementaryUplinkRelease | ENUMERATED {true} |

OPTIONAL, -- NeedN
tdd-UL-DL-ConfigurationDedicated-IAB-MT-r16 TDD-UL-DL-ConfigDedicated-

| | |
|---|---|
| IAB-MT-r16 | OPTIONAL, -- Cond TDD_IAB |

| | |
|---|---|
| dormantBWP-Config-r16 | SetupRelease { DormantBWP-Config-r16 } |

OPTIONAL, -- NeedM

| | |
|---|---|
| ca-SlotOffset-r16 | CHOICE { |

| | |
|---|---|
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

| | |
|---|---|
| } | OPTIONAL, -- |

Cond AsyncCA

| | |
|---|---|
| channelAccessConfig-r16 | SetupRelease { ChannelAccessConfig-r16 } |

OPTIONAL, -- NeedM

| | |
|---|---|
| intraCellGuardBandsDL-List-r16 | SEQUENCE (SIZE (1..maxSCSs)) OF |

| | |
|---|---|
| IntraCellGuardBandsPerSCS-r16 | OPTIONAL, -- NeedS |

| | |
|---|---|
| intraCellGuardBandsUL-List-r16 | SEQUENCE (SIZE (1..maxSCSs)) OF |

| | |
|---|---|
| IntraCellGuardBandsPerSCS-r16 | OPTIONAL, -- NeedS |

| | |
|---|---|
| csi-RS-ValidationWith-DCI-r16 | ENUMERATED {enabled} |

OPTIONAL, -- NeedR

| | |
|---|---|
| lte-CRS-PatternListl-r16 | SetupRelease { LTE-CRS-PatternList-r16 } |

OPTIONAL, -- NeedM

| | |
|---|---|
| lte-CRS-PatternList2-r16 | SetupRelease { LTE-CRS-PatternList-r16 } |

OPTIONAL, -- NeedM
crs-RateMatch-PerCORESETPoolIndex-r16 ENUMERATED {enabled}
OPTIONAL, -- NeedR

| | |
|---|---|
| enableTwoDefaultTCI-States-r16 | ENUMERATED {enabled} |

OPTIONAL, -- NeedR
enableDefaultTCI-StatePerCoresetPoolIndex-r16 ENUMERATED {enabled}
OPTIONAL, -- NeedR

| | |
|---|---|
| enableBeamSwitchTiming-r16 | ENUMERATED {true} |

OPTIONAL, -- NeedR

| | |
|---|---|
| cbg-TxDiffTBsProcessingType1-r16 | ENUMERATED {enabled} |

OPTIONAL, -- NeedR

| | |
|---|---|
| cbg-TxDiffTBsProcessingType2-r16 | ENUMERATED {enabled} |

OPTIONAL -- Need R
]]
}

TABLE 18
- RateMatchPatternLTE-CRS
The IE RateMatchPatternLTE-CRS is used to configure a pattern to rate match around LTE
CRS. See TS 38.214 [19], clause 5.1.4.2.

[symbol]

[symbol]

information element

-- ASN1START
-- TAG-RATEMATCHPATTERNLTE-CRS-START

| | |
|---|---|
| RateMatchPattemLTE-CRS ::= | SEQUENCE { |

| | |
|---|---|
| carrierFreqDL | INTEGER (0..16383), |

| | |
|---|---|
| carrierBandwidthDL | ENUMERATED {n6, n15, n25, n50, n75, n100, spare2, |

spare1},

| | |
|---|---|
| mbsfn-SubframeConfigList | EUTRA-MBSFN-SubframeConfigList |

OPTIONAL, -- NeedM

| | |
|---|---|
| nrofCRS-Ports | ENUMERATED {n1, n2, n4}, |

| | |
|---|---|
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) |

OF RateMatchPatternLTE-CRS
-- TAG-RATEMATCHPATTERNLTE-CRS-STOP
-- ASN1STOP

[symbol]

[symbol]

field descriptions

[symbol]

BW of the LTE carrier in number of PRBs (see TS 38.214 [19], clause 5.1.4.2).

[symbol]

Center of the LTE carrier (see TS 38.214 [19], clause 5.1.4.2).

[symbol]

[symbol]

LTE MBSFN subframe configuration (see TS 38.214 [19], clause 5.1.4.2).

[symbol]

Number of LTE CRS antenna port to rate-match around (see TS 38.214 [19], clause
5.1.4.2).

[symbol]

Shifting value v-shift in LTE to rate match around LTE CRS (see TS 38.214 [19], clause
5.1.4.2).

PDSCH: Related to Frequency Resource Allocation

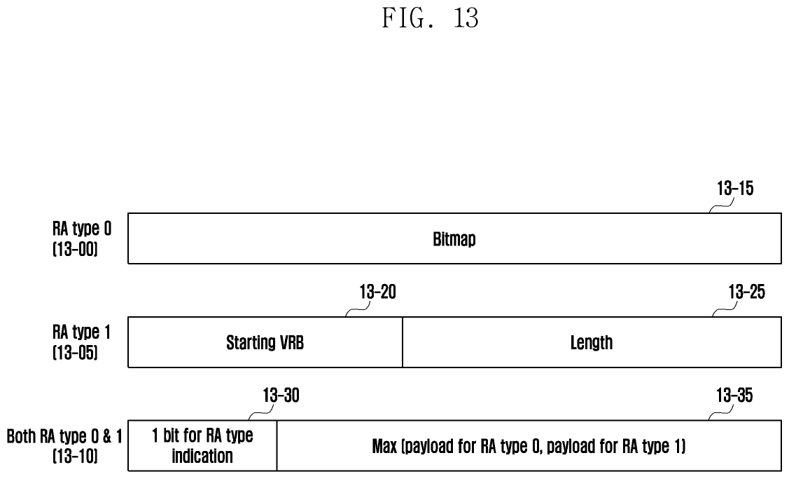

FIG. 13 illustrates an example of frequency axis resource allocation of a PDSCH in a wireless communication system, according to an embodiment of the disclosure.

FIG. 13 illustrates three frequency axis resource allocation methods of type 0 13-00, type 1 13-05, and dynamic switch 13-10 which can be configured through a higher layer in the wireless communication system (for example, a 5G system or NR system).

Referring to FIG. 13, when the UE is configured to use only resource type 0 through higher-layer signaling as indicated by reference numeral 13-00, some pieces of DCI for allocating the PDSCH to the corresponding UE includes a bitmap of N_{RBG} bits. A condition therefor is described later. At this time, N_{RBG} is the number of RBGs, determined as shown in Table 19, below, according to a BWP size allocated by a BWP indicator and a higher-layer parameter rbg-Size, and data is transmitted in an RBG indicated as 1 by the bitmap.

TABLE 19

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

When the UE is configured to use only resource type 1 through higher-layer signaling as indicated by reference numeral 13-05, some pieces of DCI for allocating the PDSCH to the corresponding UE includes frequency axis resource allocation information of ┌log₂(N_{RB}^{DL,BWP}(N_{RB}^{DL,BWP}+1)/2┐ bits. A condition therefor is described later again. The BS may configure a starting virtual RB (VRB) 13-20 and a length 13-25 of frequency axis resources allocated successively therefrom.

When the UE is configured to use both resource type 0 and resource type 1 through higher-layer signaling as indicated by reference numeral 13-10, some pieces of DCI for allocating the PDSCH to the corresponding UE includes frequency axis resource allocation information of bits of a larger value 13-35 among payload 13-15 for configuring resource type 0 and payload 13-20 and 13-25 for configuring resource type 1. A condition therefor is described later again. At this time, one bit 13-30 may be added to the first part (e.g., a most significant bit (MSB)) of the frequency axis resource allocation information within the DCI, and the use of resource type 0 may be indicated when the corresponding bit is “0” and the use of resource type 1 may be indicated when the corresponding bit is “1”.

Related to Allocating Time Domain Resources for PDSCH/PUSCH

Hereinafter, a method of allocating time domain resources for a data channel in a wireless communication system (for example, a 5G or NR system) according to an embodiment of the disclosure is described.

The BS may configure a table for time domain resource allocation information for a downlink data channel (e.g., a PDSCH) and an uplink data channel (e.g., a PUSCH) in the UE through higher-layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. The time domain resource allocation information may include PDCCH-to-PDSCH slot timing (corresponding to a time interval in units of slots between a time point at which a PDCCH is received and a time point at which a PDSCH scheduled by the received PDCCH is transmitted, and indicated by K0) or PDCCH-to-PUSCH slot timing (corresponding to a time interval in units of slots between a time point at which a PDCCH is received and a time point at which a PUSCH scheduled by the received PDCCH is transmitted, and indicated by K2), a location and a length of a start symbol in which a PDSCH or a PUSCH is scheduled within the slot, and a mapping type of a PDSCH or a PUSCH. For example, information shown in Table 20 or Table 21, below, may be transmitted from the BS to the UE.

TABLE 20
PDSCH-TimeDomainResourceAllocationList infomration element

PDSCH-TimeDomainResourceAllocationList ::= SEQUENCE
(SIZE(1.. maxNrofDL-Allocations)) OF PDSCH-
TimeDomainResourceAllocation
PDSCH-TimeDomainResourceAllocation ::= SEQUENCE {
k0 INTEGER (0..32)
OPTIONAL, --Need S
(PDCCH-to-PDSCH timing, slot units)
mapping type ENUMERATED {typeA, typeB},
(PDSCH mapping type)
startSymbolAndLength INTEGER (0..127)
(Start symbol and length of PDSCH)
}

TABLE 21
PUSCH-TimeDomainResourceAllocation information element

```
PUSCH-TimeDomainResourceAllocationList ::= SEQUENCE (SIZE(1..
maxNrofUL-Allocations)) OF PUSCH-TimeDomainResourceAllocation
PUSCH-TimeDomainResourceAllocation ::= SEQUENCE {
  k2 INTEGER(0..32)
  OPTIONAL, --Need S
  (PDCCH-to-PDSCH timing, slot unit)
  mapping type ENUMERATED {typeA, typeB},
  (PUSCH mapping type)
  startSymbolAndLength INTEGER (0..127)
  (Start symbol and length and PUSCH)
}
```

The BS may inform the UE of one of the entries in the table for the time domain resource allocation information through L1 signaling (for example, DCI indicating a time domain resource allocation field). The UE may acquire time domain resource allocation information for a PDSCH or a PUSCH on the basis of the DCI received from the BS.

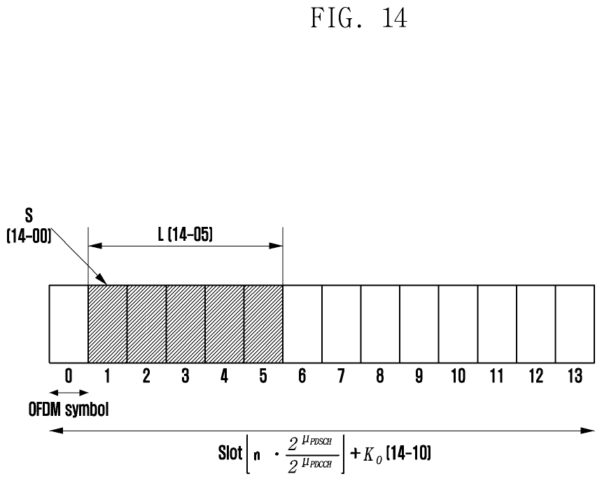

FIG. 14 illustrates an example of allocation of time axis resources of a PDSCH in a wireless communication system, according to an embodiment of the disclosure.

Referring to FIG. 14, the BS may indicate a time axis location of PDSCH resources according to SCS (μ_{PDSCH}, μ_{PDCCH}) of a data channel and a control channel configured using a higher layer, a scheduling offset (K0) value, and an OFDM symbol start location 14-00 and length 14-05 within one slot 14-10 dynamically indicated through DCI.

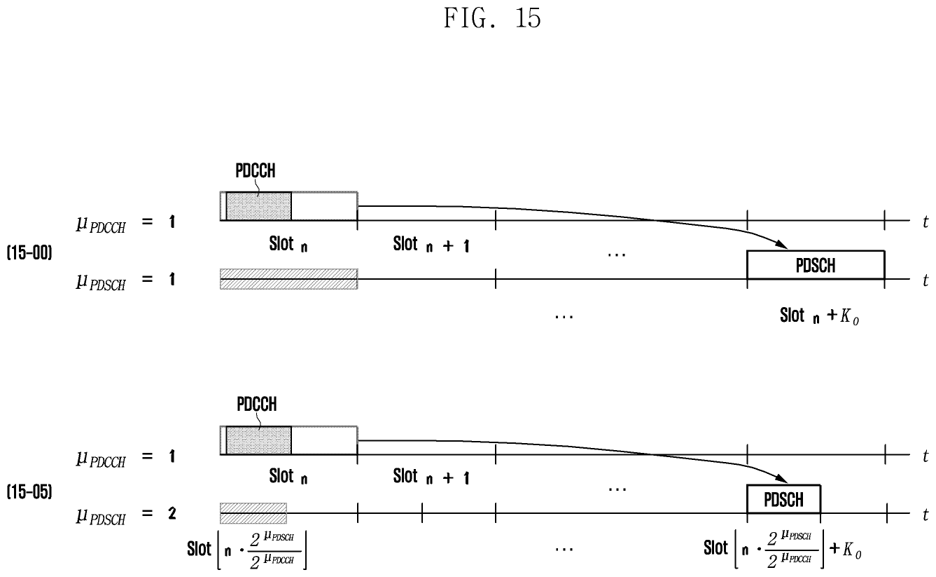

FIG. 15 illustrates an example of allocation of time-axis resources according to subcarrier spacing of a data channel and a control channel in a wireless communication system, according to an embodiment of the disclosure.

Referring to FIG. 15, when subcarrier spacings of a data channel and a control channel are the same as each other (μ_{PDSCH}=μ_{PDCCH}) as indicated by reference numeral 15-00, slot numbers for the data and the control are the same as each other, and thus the BS and the UE may generate a scheduling offset according to a predetermined slot offset K0. On the other hand, when subcarrier spacings of a data channel and a control channel are different from each other (μ_{PDSCH}≠μ_{PDCCH}) as indicated by reference numeral 15-05, slot numbers for the data and the control are different from each other, and thus the BS and the UE may generate a scheduling offset according to a predetermined slot offset K0 on the basis of subcarrier spacing of the PDCCH.

PDSCH: Processing Time

Subsequently, a PDSCH processing time (PDSCH processing procedure time) is described. When the BS schedules to transmit a PDSCH to the UE through DCI format 1_0 1_1, or 1_2, the UE may need a PDSCH processing time for receiving the PDSCH by applying a transmission method indicated through DCI (modulation/demodulation and coding indication index (MCS), demodulation reference signal-related information, and time and frequency resource allocation information). In NR, a PDSCH processing time is defined in consideration thereof. The PDSCH processing time of the UE may follow Equation 3 below.

T_{proc,1}=(N₁+d_{1,1}+d₂)(2048+144)κ2^{-μ}T_{c}+Tₑₓₜ Equation 3

In T_{proc,1} of Equation 3, respective parameters may have meanings described below.
N₁: the number of symbols determined according to UE processing capability 1 or 2 based on a UE capability and numerology μ. N₁ may have a value in Table 22 when UE processing capability 1 is reported according to a UE capability report and may have a value in Table 23 when UE processing capability 2 is reported and information indicating that UE processing capability 2 can be used is configured through higher-layer signaling. The numerology μ may correspond to a minimum value among μ_{PDCCH}, μ_{PDSCH}, and μ_{UL}, to maximize T_{proc,1}, and μ_{PDCCH}, μP_{DSCCH}, and μ_{UL} may be numerology of a PDCCH scheduling a PDSCH, numerology of a scheduled PDSCH, and numerology of an uplink channel to transmit HARQ-ACK, respectively.

TABLE 22
PDSCH processing time in PDSCH processing capability 1

| | PDSCH decoding time N₁ [symbols] | |
|---|---|---|
| | | Case in which AdditionalPosition ≠ pos0 |
| | Case in which dmrs-AdditionalPosition = | within higher-layer signaling DMRS- |
| | pos0 within DMRS-higher-layer | DownlinkConfig or higher-layer parameter |
| | signaling DownlinkConfig in both | is not configured in both PDSCH mapping |
| μ | PDSCH mapping types A and B | types A and B |
| 0 | 8 | N_{1, 0} |
| 1 | 10 | 13 |
| 2 | 17 | 20 |
| 3 | 20 | 24 |

TABLE 23
PDSCH processing time in PDSCH processing capability 2

| | PDSCH decoding time N₁ [symbols] |
|---|---|
| | Case in which dmrs-AdditionalPosition = pos0 within higher-layer signaling DMRS- |
| μ | DownlinkConfig in both PDSCH mapping types A and B |
| 0 | 3 |
| 1 | 4.5 |
| 2 | 9 for frequency range 1 |

κ: 64
Tₑₓₜ: the UE may calculate Tₑₓₜ and apply the same to a PDSCH processing time when the UE uses a shared spectrum channel access scheme. Otherwise, it is assumed that Tₑₓₜ is 0.
When l₁ indicating a location value of a PDSCH DMRS is 12, N1,0 in Table 22 has a value of 14 and, otherwise, has a value of 13.
When the last symbol of the PDSCH is an i^{th} symbol in a slot for transmitting the PDSCH and i<7 for PDSCH mapping type A, d_{1,1} is 7-i and, otherwise, d_{1,1} is 0.
d₂: d₂ of a PUCCH having a high priority index may be configured as a value reported from the UE when the PUCCH having the high priority index and a PUCCH or PUSCH having a low priority index overlap in the time. Otherwise, d₂ is 0.
d_{1,1} may be determined according to the number L of symbols of the scheduled PDSCH and the number d of overlapping symbols between the PDCCH scheduling the PDSCH and the scheduled PDSCH as described below when PDSCH mapping type B is used for UE processing capability 1.
If L≥7, d_{1,1}=0.
If L≥4 and L≤6, d_{1,1}=7−L.
If L=3, d_{1,1}=min (d, 1).
If L=2, d_{1,1}=3+d.
d_{1,1} may be determined according to the number L of symbols of the scheduled PDSCH and the number d of overlapping symbols between the PDCCH scheduling the PDSCH and the scheduled PDSCH as described below when PDSCH mapping type B is used for UE processing capability 2.
d1,1 may be determined according to the number L of symbols of the scheduled PDSCH and the number d of overlapping symbols between the PDCCH scheduling the PDSCH and the scheduled PDSCH as described below when PDSCH mapping type B is used for UE processing capability 2.
If L≥7, d_{1,1}=0.
If L≥4 and L≤6, d_{1,1}=7−L.
In the case of L=2,
if the PDCCH performing scheduling exists within a CORESET including 3 symbols and the corresponding CORESET and the scheduled PDSCH have the same start symbol, d_{1,1}=3.
Otherwise, d_{1,1}=d.
A UE supporting capability 2 within a given serving cell may apply a PDSCH processing time according to UE processing capability 2 when processingType2Enabled that is higher-layer signaling is configured as enable for the corresponding cell.

When a location of a first uplink transmission symbol of a PUCCH including HARQ-ACK information (the corresponding location may consider K₁ defined as a transmission time point of HARQ-ACK, PUCCH resources used for HARQ-ACK transmission, and a timing advance effect) does not start earlier than a first uplink transmission symbol appearing after a time of T_{proc,1} from a last symbol of a PDSCH, the UE should transmit a valid HARQ-ACK message. That is, the UE should transmit the PUCCH including HARQ-ACK only when the PDSCH processing time is sufficient. Otherwise, the UE cannot provide the BS with valid HARQ-ACK information corresponding to the scheduled PDSCH. T_{proc,1} may be used for all of the normal or expanded CP. When the number of PDSCH transmission locations within one slot is 2, d_{1,1} is calculated on the basis of the first PDSCH transmission location within the corresponding slot.

PDSCH: Reception Preparation Time in Cross-Carrier Scheduling

Hereinafter, in the case of cross-carrier scheduling in which numerology μ_{PDCCH} for transmitting the PDCCH performing scheduling and numerology μ_{PDSCH} for transmitting the PDSCH scheduling the corresponding PDCCH are different from each other, a PDSCH reception preparation time N_{pdsch} of the UE defined for a time interval between the PDCCH and the PDSCH is described.

When μ_{PDCCH}<μ_{PDSCH}, the scheduled PDSCH cannot be transmitted earlier than the first symbol of the slot existing after N_{pdsch} symbols from the last symbol of the PDCCH scheduling the corresponding PDSCH. Transmission symbols of the corresponding PDSCH may include a DM-RS.

When μ_{PDCCH}>μ_{PDSCH}, the scheduled PDSCH may be transmitted after N_{pdsch} symbols from the last symbol of the PDCCH scheduling the corresponding PDSCH. Transmission symbols of the corresponding PDSCH may include a DM-RS.

TABLE 24
N_{pdsch} according to scheduled PDCCH

| μ_{PDCCH} | N_{pdsch} [symbols] |
|---|---|
| 0 | 4 |
| 1 | 5 |
| 2 | 10 |
| 3 | 14 |

PDSCH: TCI State Activation MAC-CE

Subsequently, a beam configuration method for a PDSCH is described.

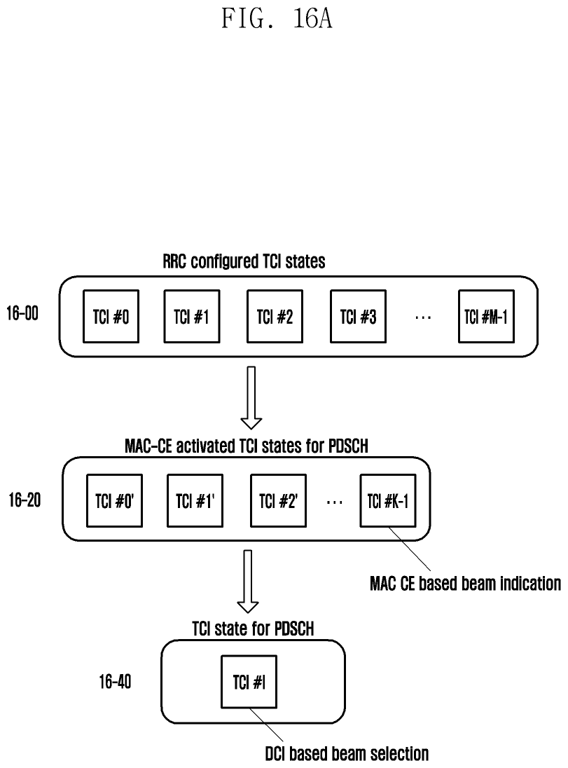

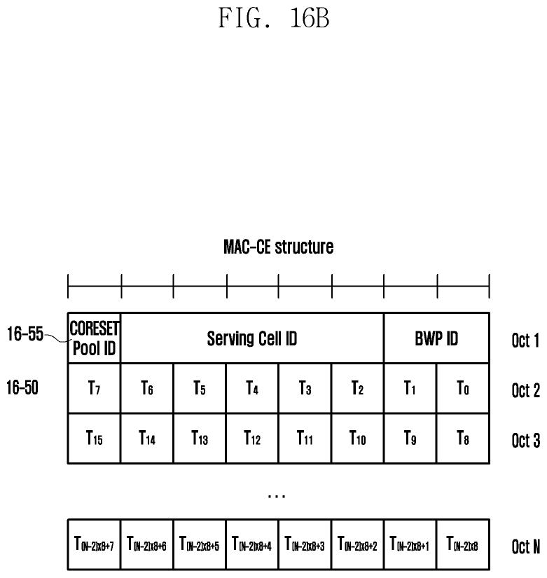

FIG. 16A illustrates a process for beam configuration and activation of the PDSCH according to an embodiment of the disclosure.

Referring to FIG. 16A, a list of TCI states for the PDSCH may be indicated through a higher layer list such as RRC as indicated by reference numeral 16-00. The TCI state list may be indicated, for example, as tci-StatesToAddModList and/or tci-StatesToReleaseList within a PDSCH-Config IE for each BWP. Subsequently, some in the TCI state list may be activated through a MAC-CE as indicated by reference numeral 16-20. The maximum number of activated TCI states may be determined according to a capability reported by the UE. One of the TCI states activated through MAC-CE may be indicated through DCI 16-40.

FIG. 16B illustrates an example of a MAC-CE format for activation/deactivation of a TCI state for PDSCH according to an embodiment of the disclosure.

Referring to FIG. 16B, the MAC-CE format for activation/deactivation of a TCI state for PDSCH includes CORESET pool ID 16-55, serving cell ID, BWP ID and TCI state ID (16-50).

The meaning of each field within the MAC CE and a value which can be configured in each field are described below.

| | |
|---|---|
| - | Serving Cell ID: This field indicates the identity of the Serving Cell for which |
| | the MAC CE applies. The length of the field is 5 bits. If the indicated Serving |
| | Cell is configured as part of a simultaneousTCI-UpdateList1 or simultaneousTCI- |
| | UpdateList2 as specified in TS 38.331 [5], this MAC CE applies to all the Serving |
| | Cells configured in the set simultaneousTCI-UpdateList1 or simultaneousTCI- |
| | UpdateList2, respectively; |
| - | BWP ID: This field indicates a DL BWP for which the MAC CE applies as the |
| | codepoint of the DCI bandwidth part indicator field as specified in TS 38.212 [9]. |
| | The length of the BWP ID field is 2 bits; |
| - | Cᵢ: This field indicates whether the octet containing TCI state ID_{i, 2} is present. If |
| | this field is set to “1”, the octet containing TCI state ID_{i, 2} is present. If this field |
| | is set to “0”, the octet containing TCI state ID_{i, 2} is not present; |
| - | TCI state ID_{i, j}: This field indicates the TCI state identified by TCI-StateId as |
| | specified in TS 38.331 [5], where i is the index of the codepoint of the DCI |
| | Transmission configuration indication field as specified in TS 38.212 [9] and TCI |
| | state ID_{i, j} denotes the j-th TCI state indicated for the i-th codepoint in the DCI |
| | Transmission Configuration Indication field. The TCI codepoint to which the |
| | TCI States are mapped is determined by its ordinal position among all the TCI |
| | codepoints with sets of TCI state ID_{i, j} fields, i.e. the first TCI codepoint with TCI |
| | state ID_{0, 1} and TCI state ID_{0, 2} shall be mapped to the codepoint value 0, the second |
| | TCI codepoint with TCI state ID_{1, 1} and TCI state ID_{1, 2} shall be mapped to the |
| | codepoint value 1 and so on. The TCI state ID_{i, 2} is optional based on the |
| | indication of the Ci field. The maximum number of activated TCI codepoint is 8 |
| | and the maximum number of TCI states mapped to a TCI codepoint is 2. |
| - | R: Reserved bit, set to “0”. |

Related to SRS

Subsequently, a method of estimating an uplink channel using sounding reference signal (SRS) transmission by the UE is described. The BS may configure at least one SRS configuration in every uplink BWP and configure at least one SRS resource set in every SRS configuration in order to transmit configuration information for SRS transmission to the UE. For example, the BS and the UE may exchange higher-layer signaling information below in order to transmit information related to an SRS resource set.
srs-ResourceSetId: SRS indicates a resource set index
srs-ResourceldList: set of SRS resource indexes referred to by SRS resource set
resourceType: indicates a time-axis transmission configuration of SRS resources referred to by an SRS resource set and is configured as one of ‘periodic’, ‘semi-persistent’, and ‘aperiodic’. When ‘periodic’ or ‘semi-persistent’ is configured, associated CSI-RS information may be provided according to a used place of the SRS resource set. When ‘aperiodic’ is configured, an aperiodic SRS resource trigger list and slot offset information may be provided and associated CSI-RS information may be provided according to a used place of the SRS resource set.
usage: indicates a configuration for a used place of SRS resources referred to by the SRS resource set and is configured as one of ‘beamManagement’, ‘codebook’, ‘nonCodebook’, and ‘antennaSwitching’.
alpha, p0, pathlossReferenceRS, srs-PowerControlAdjustmentStates: provides a parameter configuration for controlling transmission power of SRS resources referred to by the SRS resource set.

The UE may understand that SRS resources included in the set of SRS resource indexes referred to by the SRS resource set follow information configured in the SRS resource set.

Further, the BS and the UE may transmit and receive high-layer signaling information in order to transmit individual configuration information for SRS resources. For example, the individual configuration information for SRS resources may include time-frequency axis mapping information within the slot of SRS resources, which may include information on intra-slot or inter-slot frequency hopping of SRS resources. Further, the individual configuration information for SRS resources may include a time-axis transmission configuration of SRS resources and may be configured as one of ‘periodic’, ‘semi-persistent’, and ‘aperiodic’. This may be limited to have the time-axis transmission configuration such as the SRS resources set including SRS resources. When the time-axis transmission configuration of SRS resources is configured as ‘periodic’ or ‘semi-persistent’, an SRS resource transmission period and a slot offset (for example, periodicityAndOffset) may be additionally configured in the time-axis transmission configuration.

The BS may activate, deactivate, or trigger SRS transmission to the UE through higher-layer signaling including RRC signaling or MAC CE signaling or L1 signaling (for example, DCI). For example, the BS may activate or deactivate periodic SRS transmission to the UE through higher-layer signaling. The BS may indicate activation of an SRS resource set having a resourceType configured as periodic through higher-layer signaling, and the UE may transmit SRS resources referred to by the activated SRS resource set. Time-frequency axis resource mapping within the slot of the transmission SRS resources follows resource mapping information configured in the SRS resources, and slot mapping including the transmission period and the slot offset follows a periodicityAndOffset configured in the SRS resources. Further, a spatial domain transmission filter applied to the transmission SRS resources may refer to spatial relation info configured in the SRS resources or refer to associated CSI-RS information configured in the SRS resource set including the SRS resources. The UE may transmit SRS resources within an uplink BWP activated for activated semi-persistent SRS resources through higher-layer signaling.

For example, the BS may activate or deactivate semi-persistent SRS transmission to the UE through high-layer signaling. The BS may indicate activation of the SRS resource set through MAC CE signaling, and the UE may transmit SRS resources referred to by the activated SRS resource set. The SRS resource set activated through MAC CE signaling may be limited to an SRS resource set having the resourceType configured as semi-persistent. Time-frequency axis resource mapping within the slot of the transmission SRS resources follows resource mapping information configured in the SRS resources, and slot mapping including the transmission period and the slot offset follows a periodicityAndOffset configured in the SRS resources. Further, a spatial domain transmission filter applied to the transmission SRS resources may refer to spatial relation info configured in the SRS resources or refer to associated CSI-RS information configured in the SRS resource set including the SRS resources. When spatial relation info is configured in the SRS resources, a spatial domain transmission filter may be determined with reference to configuration information for spatial relation info transmitted through MAC CE signaling activating semi-persistent SRS transmission without following the spatial relation info. The UE may transmit SRS resources within an uplink BWP activated for activated semi-persistent SRS resources through higher-layer signaling.

For example, the BS may trigger aperiodic SRS transmission to the UE through DCI. The BS may indicate one of the aperiodic SRS resource triggers (aperiodicSRS-ResourceTrigger) through an SRS request field of DCI. The UE may understand that an SRS resource set including the aperiodic SRS resource trigger indicated through DCI in an aperiodic SRS resource trigger list among SRS resource set configuration information is triggered. The UE may transmit the SRS resources referred to by the triggered SRS resource set. Time-frequency axis resource mapping within the slot of the transmitted SRS resources follows resource mapping information configured in the SRS resources. Further, slot mapping of the transmitted SRS resources may be determined through a slot offset between a PDCCH including DCI and the SRS resources, which may refer to a value(s) included in a slot offset set configured in the SRS resource set. Specifically, the slot offset between the PDCCH including DCI and the SRS resources may apply a value indicated by a time domain resource assignment field of DCI among an offset value(s) included in the slot offset set configured in the SRS resource set. Further, a spatial domain transmission filter applied to the transmission SRS resources may refer to spatial relation info configured in the SRS resources or refer to associated CSI-RS information configured in the SRS resource set including the SRS resources. The UE may transmit SRS resources within an uplink BWP activated for triggered aperiodic SRS resources through DCI.

When the BS triggers aperiodic SRS transmission to the UE through DCI, the UE may need a minimum time interval between the PDCCH including DCI for triggering aperiodic SRS transmission and the transmitted SRS in order to transmit the SRS through the application of configuration information for SRS resource. The time interval for SRS transmission by the UE may be defined as the number of symbols between the last symbol of the PDCCH including DCI for triggering aperiodic SRS transmission and the first symbol to which the SRS resource that is first transmitted among the transmitted SRS resource(s) is mapped. The minimum time interval may be defined with reference to a PUSCH preparation procedure time required for preparing PUSCH transmission by the UE. Further, the minimum time interval may have different values according to a used place of the SRS resource set including the transmitted SRS resource. For example, the minimum time interval may be defined as N2 symbols defined in consideration of the UE processing capability according to the UE capability with reference to the PUSCH preparation procedure of the UE. Further, the minimum time interval may be determined as N2 symbols when the used place of the SRS resource set is configured as ‘codebook’ or ‘antennaSwitching’ in consideration of the used place of the SRS resource set including the transmitted SRS resource, and may be determined as N2+14 symbols when the used place of the SRS resource set is configured as ‘nonCodebook’ or ‘beamManagement’ The UE may perform aperiodic SRS transmission when the time interval for aperiodic SRS transmission is longer than or equal to the minimum time interval, and may ignore DCI for triggering the aperiodic SRS when the time interval for aperiodic SRS transmission is shorter than the minimum time interval.

TABLE 25

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

OPTIONAL, -- Need R
...
}

In Table 25 above, spatialRelationInfo configuration information is applied to a beam used for corresponding SRS information of beam information of the corresponding reference signal with reference to one reference signal. For example, the configuration of spatialRelationInfo may include information shown in Table 26 below.

TABLE 26

| | |
|---|---|
| SRS-SpatialRelationInfo ::= | SEQUENCE { |
| servingCellId | ServCellIndex OPTIONAL, -- Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, an SS/PBCH block index, a CSI-RS index, or an SRS index may be configured as an index of a reference signal to be referred to for using beam information of a specific reference signal. Higher-layer signaling referenceSignal is configuration information indicating a reference signal of which beam information is referred to for corresponding SRS transmission, ssb-Index is an index of an SS/PBCH block, csi-RS-Index is an index of a CSI-RS, and srs is an index of an SRS. When a value of higher-layer signaling referenceSignal is configured as ‘ssb-Index’, the UE may apply a reception beam used for receiving the SS/PBCH block corresponding to ssb-Index as a transmission beam of the corresponding SRS transmission. When a value of higher-layer signaling referenceSignal is configured as ‘csi-RS-Index’, the UE may apply a reception beam used for receiving the CSI-RS corresponding to csi-RS-Index as a transmission beam of the corresponding SRS transmission. When a value of higher-layer signaling referenceSignal is configured as ‘srs’, the UE may apply a reception beam used for receiving the SRS corresponding to srs as a transmission beam of the corresponding SRS transmission.

PUSCH: Related to Transmission Scheme

Subsequently, a scheduling scheme of PUSCH transmission is described. PUSCH transmission may be dynamically scheduled by a UL grant within DCI or may operate by configured grant Type 1 or Type 2. Dynamic scheduling of PUSCH transmission can be indicated by DCI format 0_0 or 0_1.

Configured grant Type 1 PUSCH transmission may be semi-statically configured through reception of configuredGrantConfig including rrc-ConfiguredUplinkGrant in Table 27 through higher-layer signaling without reception of a UL grant within DCI. Configured grant Type 2 PUSCH transmission may be semi-persistently scheduled by a UL grant within DCI after reception of configuredGrantConfig which does not include rrc-ConfiguredUplinkGrant in Table 27 through higher-layer signaling. When PUSCH transmission operates by a configured grant, parameters applied to PUSCH transmission are applied through configuredGrantConfig which is higher-layer signaling of Table 27 except for dataScramblingIdentityPUSCH, txConfig, codebookSubset, maxRank, and scaling of UCI-OnPUSCH provided as pusch-Config of Table 28 which is higher-layer signaling. When the UE receives transformPrecoder within configuredGrantConfig which is higher-layer signaling of Table 27, the UE applies tp-pi2BPSK within pusch-Config of Table 28 to PUSCH transmission operating by the configured grant.

TABLE 27

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | NUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

| | |
|---|---|
| | sym6, sym1x12, sym2x12, sym4x12, sym5x12, sym8x12, |
| sym10x12, sym16x12, sym20x12, sym32x12, | |
| | sym40x12, sym64x12, sym80x12, sym128x12, |

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |

maxNrofPhysicalResourceBlocks−1)

| | |
|---|---|
| pathlossReferenceIndex | INTEGER (0..maxNrofPUSCH- |

PathlossReferenceRSs−1),
...

| | |
|---|---|
| } | OPTIONAL, -- |

Need R
...
}

Subsequently, a PUSCH transmission method is described. A DMRS antenna port for PUSCH transmission is the same as an antenna port for SRS transmission. PUSCH transmission may follow each of a codebook-based transmission method and a non-codebook-based transmission method according to whether a value of txConfig within pusch-Config of Table 28 which is higher-layer signaling is ‘codebook’ or ‘nonCodebook’.

As described above, PUSCH transmission may be dynamically scheduled through DCI format 0_0 or 0_1 or semi-statically configured by the configured grant. When the UE receives an indication of scheduling of PUSCH transmission through DCI format 0_0, the UE performs a beam configuration for PUSCH transmission by using pucch-spatialRelationInfoID corresponding to a UE-specific PUCCH resource corresponding to a minimum ID within the activated uplink BWP in the serving cell in which case the PUSCH transmission is based on a single antenna port. The UE does not expect scheduling of PUSCH transmission through DCI format 0_0 within a BWP in which the PUCCH resource including pucch-spatialRelationInfo is not configured. When the UE does not receive a configuration of txConfig within pusch-Config of Table 28, the UE does not expect reception of scheduling through DCI format 0_1.

TABLE 28

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)

OPTIONAL, -- Need

M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList | }OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

OPTIONAL, -- Cond

codebookBased

| | | |
|---|---|---|
| maxRank | INTEGER (1..4) | OPTIONAL, -- Cond |

codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Subsequently, codebook-based PUSCH transmission is described. Codebook-based PUSCH transmission may be dynamically scheduled through DCI format 0_0 or 0_1 or semi-statically operate by the configured grant. When codebook-based PUSCH is dynamically scheduled by DCI format 0_1 or is semi-statically configured by the configured grant, the UE determines a precoder for PUS CH transmission on the basis of an SRS resource indicator (SRI), a transmission precoding matrix indicator (TPMI), and a transmission rank (the number of PUSCH transmission layers).

At this time, the SRI may be given through an SRS resource indicator field within DCI or may be configured through srs-ResourceIndicator which is higher-layer signaling. In codebook-based PUSCH transmission, the UE may receive a configuration of at least one SRS resource and a maximum of two SRS resources. When the UE receives the SRI through DCI, the SRS resource indicated by the corresponding SRI is the SRS resource corresponding to the SRI among SRS resources transmitted earlier than the PDCCH including the corresponding SRI. Further, the TPMI and the transmission rank may be given through field information and number of layers within DCI or may be configured through precodingAndNumberOfLayers which is higher-layer signaling. The TPMI is used to indicate a precoder applied to PUSCH transmission. When the UE receives a configuration of one SRS resource, the TPMI is used to indicate a precoder to be applied to the one configured SRS resource. When the UE received a configuration of a plurality of SRS resources, the TPMI is used to indicate a precoder to be applied to SRS resources indicated through the SRI.

The precoder to be used for PUSCH transmission is selected from an uplink codebook having the number of antenna ports which is the same as a value of nrofSRS-Ports within SRS-Config which is higher-layer signaling. In codebook-based PUSCH transmission, the UE determines a codebook subset on the basis of the TPMI and a codebookSubset within pusch-Config which is higher-layer signaling. The codebookSubset within pusch-Config which is higher-layer signaling may be configured as one of ‘fullyAndPartialAndNonCoherent’, ‘partialAndNonCoherent’, or ‘nonCoherent’ on the basis of the UE capability which the UE reports to the BS. When the UE reports ‘partialAndNonCoherent’ as the UE capability, the UE does not expect a configuration of the value of the codebookSubset which is higher-layer signaling as ‘fullyAndPartialAndNonCoherent’. Further, when the UE reports ‘nonCoherent’ as the UE capability, the UE does not expect a configuration of the value of the codebookSubset which is higher-layer signaling as ‘fullyAndPartialAndNonCoherent’ or ‘partialAndNonCoherent’. When nrofSRS-Ports within SRS-ResourceSet which is higher-layer signaling indicate two SRS antenna ports, the UE does not expect a configuration of the value of the codebookSubset which is higher-layer signaling as ‘partialAndNonCoherent’.

The UE may receive a configuration of one SRS resource set having a value of usage within SRS-ResourceSet which is higher-layer signaling configured as ‘codebook’, and one SRS resource may be indicated through the SRI within the corresponding SRS resource set. When several SRS resources are configured within the SRS resource set having the value of usage within SRS-ResourceSet which is higher-layer signaling configured as ‘codebook’, the UE expects a configuration of the same value of nrofSRS-Ports within the SRS-Resource which is higher-layer signaling for all SRS resources.

The UE may transmit one or a plurality of SRS resources included in the SRS resource set having the value of usage configured as ‘codebook’ to the BS according to higher-layer signaling, and the BS may select one of the SRS resources transmitted by the UE and instruct the UE to perform PUSCH transmission by using transmission beam information of the corresponding SRS resource. At this time, in codebook-based PUSCH transmission, the SRI is used as information for selecting an index of one SRS resource and is included in DCI. In addition, the BS may insert information indicating the TPMI and the rank to be used for PUSCH transmission by the UE into DCI. The UE performs PUSCH transmission by applying a precoder indicated by the rank and the TPMI indicated on the basis of the transmission beam of the corresponding SRS resource using the SRS resource indicated by the SRI.

Subsequently, non-codebook-based PUSCH transmission is described. Non-codebook-based PUSCH transmission may be dynamically scheduled through DCI format 0_0 or 0_1 or semi-statically operate by the configured grant. When at least one SRS resource is configured within the SRS resource set having the value of usage configured as ‘nonCodebook’ within SRS-ResourceSet which is higher-layer signaling, the UE may receive scheduling of non-codebook-based PUSCH transmission through DCI format 0_1.

For the SRS resource set having the value of usage configured as ‘nonCodebook’ within SRS-ResourceSet which is higher-layer signaling, the UE may receive a configuration of one connected non-zero power CSI-RS (NZP CSI-RS). The UE may calculate a precoder for SRS transmission through measurement for the NZP CSI-RS resource connected to the SRS resource set. When a difference between the last reception symbol of the aperiodic NZP CSI-RS resource connected to the SRS resource set and the first symbol of aperiodic SRS transmission in the UE is smaller than 42 symbols, the UE does not expect an update of information on the precoder for SRS transmission.

When the value of resource Type within SRS-ResourceSet which is higher-layer signaling is configured as ‘aperiodic’, the connected NZP CSI-RS is indicated by an SRS request which is a field within DCI format 0_1 or 1_1. At this time, when the connected NZP CSI-RS resource is an aperiodic NZP CSI-RS resource, the case in which the value of the SRS request field within DCI format 0_1 or 1_1 is not ‘00’ indicates the existence of the connected NZP CSI-RS. At this time, the corresponding DCI should not indicate cross carrier or cross BWP scheduling. Further, when the value of the SRS request indicates the existence of the NZP CSI-RS, the corresponding NZP CSI-RS is located in a slot in which the PDCCH including the SRS request field is transmitted. At this time, TCI states configured in the scheduled subcarrier are not configured as QCL-TypeD.

When the periodic or semi-persistent SRS resource set is configured, the connected NZP CSI-RS may be indicated through an associatedCSI-RS within SRS-ResourceSet which is higher-layer signaling. For non-codebook-based transmission, the UE does not expect configurations of both spatialRelationInfo which is higher layer signaling for the SRS resource and associatedCSI-RS within SRS-ResourceSet which is higher-layer signaling.

When the UE receives a configuration of a plurality of SRS resources, the UE may determine a precoder and a transmission rank to be applied to PUSCH transmission on the basis of an SRI indicated by the BS. At this time, the SRI may be indicated through an SRS resource indicator field within DCI or may be configured through srs-ResourceIndicator which is higher-layer signaling. Like the codebook-based PUSCH transmission, when the UE receives the SRI through DCI, the SRS resource indicated by the corresponding SRI is the SRS resource corresponding to the SRI among SRS resources transmitted earlier than the PDCCH including the corresponding SRI. The UE may use one or a plurality of SRS resources for SRS transmission, and the maximum number of SRS resources which can be simultaneously transmitted in the same symbol within one SRS resource set and the maximum number of SRS resources are determined by the UE capability which the UE reports to the BS. At this time, SRS resources which the UE simultaneously transmits occupy the same RB. The UE configures one SRS port for each SRS resource. The number of SRS resource sets having the value of usage configured as ‘nonCodebook’ within SRS-ResourceSet which is higher-layer signaling is only one, and the maximum number of SRS resources for non-codebook-based PUSCH transmission can be 4.

The BS transmits one NZP-CSI-RS connected to the SRS resource set, and the UE calculates a precoder to be used for one or a plurality of SRS resource transmissions within the corresponding SRS resource set on the basis of the measurement result when the corresponding NZP-CSI-RS is received. When transmitting one or a plurality of SRS resources within the SRS resource set having usage configured as ‘nonCodebook’ to the BS, the UE applies the calculated precoder and the BS selects one or a plurality of SRS resources from among the one or plurality of received SRS resources. At this time, in non-codebook-based PUSCH transmission, the SRI indicates an index which may express one SRS resource or a combination of a plurality of SRS resources, and the SRI is included in the DCI. The number of SRS resources indicated by the SRI transmitted by the BS may be the number of transmission layers of the PUSCH, and the UE transmits the PUSCH by applying the precoder applied to SRS resources to each layer.

PUSCH: Preparation Process Time

Subsequently, a PUSCH preparation process time (PUSCH preparation procedure time) is described. When the BS schedules to transmit a PUSCH to the UE by using DCI format 0_0, 0_1, or 0_2, the UE may need a PUSCH preparation process time for transmitting a PUSCH by applying a transmission method (a transmission precoding method of SRS resources, the number of transmission layers, and a spatial domain transmission filter) indicated through DCI. In NR, the PUSCH preparation process time considering the same is defined. The PUSCH preparation process time of the UE may follow Equation 4 below.

T_{proc,2}=max((N₂+d_{2,1}+d₂)(2048+144)κ2^{-μ}T_{c}+Tₑₓₜ+T_{switch},d_{2,2}) Equation 4

In T_{proc,2} described in Equation 4, each parameter may have the following meaning.
N₂: the number of symbols determined according to UE processing capability 1 or 2 based on a UE capability and numerology μ. N₁ may have a value in Table 29 when UE processing capability 1 is reported according to a UE capability report and may have a value in Table 30 when UE processing capability 2 is reported and information indicating that UE processing capability 2 can be used is configured through higher-layer signaling.

TABLE 29

| | PUSCH preparation time N₂ |
|---|---|
| μ | [symbols] |
| 0 | 10 |
| 1 | 12 |
| 2 | 23 |
| 3 | 36 |

TABLE 30

| | PUSCH preparation time N₂ |
|---|---|
| μ | [symbols] |
| 0 | 5 |
| 1 | 5.5 |
| 2 | 11 for frequency range 1 |

d_{2,1}: the number of symbols determined as 0 when all resource elements of a first OFDM symbol in PUSCH transmission include only DM-RSs and, otherwise, determined as 1.
κ:64
μ: follows a value among μ_{DL} or μ_{UL} making T_{proc,2} larger. μ_{DL} is downlink numerology for transmitting a PDCCH including DCI scheduling a PUSCH and μ_{UL} is uplink numerology for transmitting a PUSCH.
T_{c}: has: 1/(Δfₘₐₓ·N_{f}), Δfₘₐₓ=480·10³ Hz, and N_{f}=4096.
d_{2,2}: follows a BWP switching time when DCI scheduling a PUSCH indicates BWP switching and, otherwise, has 0.
d₂: a value of d₂ of a PUSCH having a high priority index is used when OFDM symbols of the PUCCH, the PUSCH having the high priority index, and a PUCCH having a low priority index overlap in the time. Otherwise, d₂ is 0.
Tₑₓₜ: the UE may calculate Tₑₓₜ and apply the same to a PUSCH processing time when the UE uses a shared spectrum channel access scheme. Otherwise, it is assumed that Tₑₓₜ is 0.
T_{switch}: it is assumed that T_{switch} is a switching interval time when an uplink switching interval is triggered. Otherwise, it is assumed that T_{switch} is 0.

In consideration of time axis resource mapping information of the PUSCH scheduled through DCI and an effect of uplink-downlink timing advance, the BS and the UE may determine that the PUSCH preparation process time is not sufficient when a first symbol of the PUSCH starts earlier than a first uplink symbol at which the CP starts after T_{proc,2} from a last symbol of the PDCCH including the DCI scheduling the PUSCH. Otherwise, the BS and the UE determine that the PUSCH preparation process time is sufficient. The UE may transmit the PUSCH only when the PUSCH preparation process time is sufficient, and may ignore DCI scheduling the PUSCH when the PUSCH preparation process time is not sufficient.

PUSCH: Related to Repetitive Transmission

Hereinafter, repetitive transmission of an uplink data channel in a 5G system is described in detail. In the 5G system, two types such as a PUSCH repetitive transmission type A and a PUSCH repetitive transmission type B are supported as the repetitive transmission method of the uplink data channel. The UE may receive a configuration of one of PUSCH repetitive transmission type A or B through higher-layer signaling.

PUSCH Repetitive Transmission Type A
As described above, the symbol length of the uplink data channel and the location of a start symbol may be determined through the time domain resource allocation method within one slot, and the BS may notify the UE of the number of repetitive transmissions through higher-layer signaling (for example, RRC signaling) or L1 signaling (for example, DCI).
The UE may repeatedly transmit uplink data channels having the configured same uplink data channel length and start symbol in successive slots on the basis of the number of repetitive transmissions received from the BS. At this time, when slots which the BS configures in the UE in the downlink or one or more symbols among the symbols of uplink data channels configured in the UE are configured as the downlink, the UE omits uplink data channel transmission but counts the number of repetitive transmissions of the uplink data channel.

PUSCH Repetitive Transmission Type B
As described above, the symbol length of the uplink data channel and the location of a start symbol may be determined through the time domain resource allocation method within one slot, and the BS may notify the UE of the number numberofrepetitions of repetitive transmissions through higher-layer signaling (for example, RRC signaling) or L1 signaling (for example, DCI).
First, nominal repetition of the uplink data channel is determined on the basis of the start symbol and the length of the configured uplink data channel. A slot in which n^{th} nominal repetition starts is given by

$${K}_{s} + ⌊ \frac{S + n \cdot L}{{N}_{symb}^{slot}} ⌋ ,$$

and a symbol starting in the slot is given by mod(S+n·L,N_{symb}^{slot}). A slot in which n^{th} nominal repetition ends is given by

$${K}_{s} + ⌊ \frac{S + ( n + 1 ) \cdot L - 1}{{N}_{symb}^{slot}} ⌋$$

and a symbol ending in the slot is given by mod(S+(n+1)·L−1,N_{symb}^{slot}). Here, n=0, . . . , numberofrepetitions-1, S is a start symbol of a configured uplink data channel, and L is the symbol length of the configured uplink data channel. Kₛ indicates a slot in which PUSCH transmission starts, and N_{symb}^{slot} indicates the number of symbols per slot.
The UE determines an invalid symbols for the PUSCH repetitive transmission type B. A symbol configured as the downlink by tdd-UL-DL-ConfigurationCommon or tdd-UL-DL-ConfigurationDedicated is determined as an invalid symbol for the PUSCH repetitive transmission type B. In addition, the invalid symbol may be configured in a higher-layer parameter (for example, InvalidSymbolPattern). The higher-layer parameter (for example, InvalidSymbolPattern) provides a symbol level bit map over one or two slots to configure the invalid symbol. In the bitmap, 1 indicates an invalid symbol. In addition, a period and a pattern of the bitmap may be configured through a higher-layer parameter (for example, periodicityAndPattern). When the higher-layer parameter (for example, InvalidSymbolPattern) is configured, the UE applies an invalid symbol pattern if an InvalidSymbolPatternIndicator-ForDCIFormat0_1 or InvalidSymbolPatternIndicator-ForDCIFormat0_2 parameter indicates 1, or the UE may not apply the invalid symbol pattern if the parameter indicates 0. When the higher-layer parameters (for example, InvalidSymbolPattern) is configured and the InvalidSymbolPatternIndicator-ForDCIFormat0_1 or InvalidSymbolPatternIndicator-ForDCIFormat0_2 is not configured, the UE applies the invalid symbol pattern.

After the invalid symbol is determined, for each nominal repetition, the UE may consider symbols except for the invalid symbol as valid symbols. When one or more valid symbols are included in each nominal repetition, the nominal repetition may include one or more actual repetitions. Each actual repetition includes successive sets of valid symbols which can be used for the PUSCH repetitive transmissions type B in one slot.

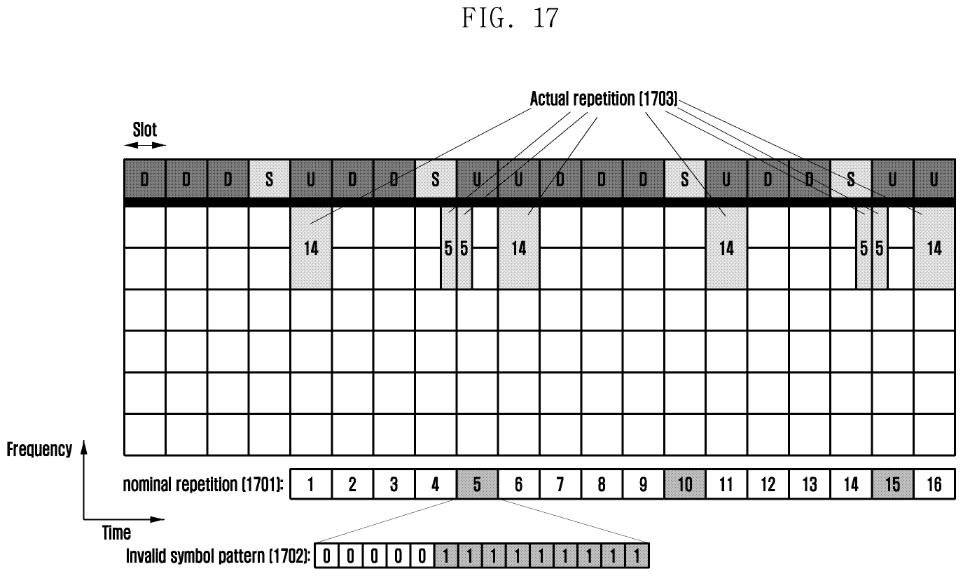

FIG. 17 illustrates an example of the PUSCH repetitive transmission type B in a wireless communication system according to an embodiment of the disclosure. The UE may receive a configuration of the start symbol S of the uplink data channel as 0, the length L of the uplink data channel as 14, and the number of repetitive transmissions as 16. In this case, nominal repetition appears in 16 successive slots as indicated by reference numeral 1701. Thereafter, the UE may determine a symbol configured as a downlink system in each nominal repetition 1701 as an invalid symbol. Further, the UE determines symbols configured as 1 in an invalid symbol pattern 1702 as invalid symbols. When valid symbols other than the invalid symbol in each nominal repetition includes one or more successive symbols in one slot, the valid symbols are configured as actual repetition and transmitted as indicated by reference number 1703.

Further, for PUSCH repetitive transmission, the following additional methods may be defined for UL grant-based PUSCH transmission and configured grant-based PUSCH transmission beyond the slot boundary in NR Release 16.
Method 1 (mini-slot level repetition): two or more PUSCH repetitive transmissions are scheduled within one slot or beyond the boundary of successive slots through one UL grant. In method 1, time domain resource allocation information within DCI indicates resources of first repetitive transmission. Time domain resource information of the remaining repetitive transmissions may be determined according to the domain resource information of first repetitive transmission and an uplink or downlink direction determined for each symbol. Each repetitive transmission occupies successive symbols.
Method 2 (multi-segment transmission): two or more PUSCH repetitive transmissions are scheduled in successive slots through one UL grant. At this time, one transmission is designated for each slot, and start points or repetition lengths may vary depending on each transmission. In method 2, the time domain resource allocation information within DCI indicates start points and repetition lengths of all repetitive transmissions. When repetitive transmission is performed within a single slot through method 2 and there are sets of successive uplink symbols within the corresponding slot, each repetitive transmission is performed for each uplink symbol set. When there is only one set of successive uplink symbols within the corresponding slot, one PUSCH repetitive transmission is performed according to the method of NR Release 15.
Method 3: two or more PUSCH repetitive transmissions are scheduled in successive slots through two or more UL grants. At this time, one transmission is designated for each slot, and an n^{th} UL grant may be received before PUSCH transmission scheduled by an (n−1)^{th} UL grant ends.
Method 4: one or a plurality of PUSCH repetitive transmissions may be supported within a signal slot or two or more PUSCH repetitive transmissions may be supported over boundaries of successive slots through one UL grant or one configured grant. The number of repetitions which the BS indicates to the UE is only a nominal value, and the number of PUSCH repetitive transmissions which the UE actually performs may be larger than the nominal number of repetitions. Time domain resource allocation information within the DCI or the configured grant is resources of the first repetitive transmission indicated by the BS. Time domain resource information of the remaining repetitive transmissions may be determined with reference to resource information of the first repetitive transmission and uplink or downlink directions of symbols. When the time domain resource information of repetitive transmission indicated by the BS is over the slot boundary or includes an uplink/downlink switching point, the corresponding repetitive transmission may be divided into a plurality of repetitive transmissions. At this time, one repetitive transmission may be included for each uplink period in one slot.

PUSCH: Frequency Hopping Process

Hereinafter, frequency hopping of an uplink data channel (physical uplink shared channel (PUSCH)) in a 5G system is described in detail.

In 5G, two methods are supported for each PUSCH repetitive transmission type as the frequency hopping method of the uplink data channel. First, intra-slot frequency hopping and inter-slot frequency hopping are supported in a PUSCH repetitive transmission type A, and inter-repetition frequency hopping and inter-slot frequency hopping are supported in a PUSCH repetitive transmission type B.

The intra-slot frequency hopping method supported in the PUSCH repetitive transmission type A is a method of changing allocated resources in the frequency domain by a frequency offset in two hops within one slot to perform transmission. In intra-slot frequency hopping, a start RB of each hop may be indicated through Equation 5.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad Equation 5$$

In Equation 5, i=0 and i=1 denote a first hop and a second hop, and denotes a start RB in an UL BWP and is calculated by a frequency resource allocation method. RB_{offset} denotes a frequency offset between two hops through a higher-layer parameter. The number of symbols of the first hop may be indicated as └N_{symb}^{PUSCH,s}/2┘, and the number of symbols of the second hop may be indicated as N_{symb}^{PUSCH,s}−└N_{symb}^{PUSCH,s}/2┘. N_{symb}^{PUSCH,s} denotes the length of PUSCH transmission within one slot and indicated by the number of OFDM symbols.

Subsequently, the inter-slot frequency hopping method supported in the PUSCH repetitive transmission types A and B is a method by which the UE changes allocated resources in the frequency domain by a frequency offset in every slot to perform transmission. In inter-slot frequency hopping, a start RB during nₛ^{μ} slots may be indicated through Equation 6.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad Equation 6$$

In Equation 6, nₛ^{μ} denotes a current slot number in multi-slot PUSCH transmission, and RBₛₜₐᵣₜ denotes a start RB in an UP BWP and is calculated by a frequency resource allocation method. RB_{offset} denotes a frequency offset between two hops through a higher-layer parameter.

Subsequently, the inter-repetition frequency hopping method supported in the PUSCH repetitive transmission type B is a method of moving allocated resources in the frequency domain by a configured frequency offset to perform transmission for one or a plurality of repetitions within each nominal repetition. For one or a plurality of actual repetitions within an n^{th} nominal repetition, RBₛₜₐᵣₜ(n) which is an index of the start RB in the frequency domain may follow Equation 7 below.

$$\text{?} ( n ) = \{ \begin{matrix}\text{?} & \text{?} \\ \text{?} & \text{?}\end{matrix} \qquad Equation 7$$

$$\text{?} \text{indicates text missing or illegible when filed}$$

In Equation 7, n denotes an index of nominal repetition, and RB_{offset} denotes an RB offset between two hops through a higher-layer parameter.

Related to UE Capability Report

In LTE system and NR system, the UE may perform a procedure for reporting a capability supported by the UE to the corresponding BS in the state in which the UE is connected to a serving BS. In the following description, this is referred to as a UE capability report.

The BS may transmit a UE capability enquiry message that makes a request for a capability report to the UE in the connected state. The message may include a UE capability request for each radio access technology (RAT) type of the BS. The request for each RAT type may include supported frequency band combination information. In the case of the UE capability enquiry message, a plurality of UE capabilities for respective RAT types may be requested through one RRC message container transmitted by the BS or the BS may insert the UE capability enquiry message including the UE capability request for each RAT type multiple times and transmit the same to the UE. That is, the UE capability enquiry is repeated multiple times within one message and the UE may configure a UE capability information message corresponding thereto and report the same multiple times. In the next-generation mobile communication system, a UE capability request for NR, LTE, E-UTRA-NR dual connectivity (EN-DC), and multi-RAT dual connectivity (MR-DC) may be made. The UE capability enquiry message is generally transmitted initially after the UE is connected to the BS, but may be requested at any time when the BS needs the same.

The UE receiving the request for the UE capability report from the BS in the above step may configure a UE capability according to RAT type and band information requested by the BS. A method by which the UE configures the UE capability in a wireless communication system (for example, a 5G or NR system) is described below

1. When the UE receives a list of LTE and/or NR bands from the BS through a UE capability request, the UE configures a band combination (BC) for EN-DC and NR stand alone (SA). That is, the UE configures a candidate list of BCs for EN-DC and NR SA on the basis of requested bands in FreqBandList. The bands sequentially have priorities as stated in FreqBandList.

2. When the BS sets a “eutra-nr-only” flag or an “eutra” flag and makes a request for the UE capability report, the UE completely removes NR SA BCs from the configured candidate list of BCs. Such an operation may occur only when the LTE BS (eNB) makes a request for an “eutra” capability.

3. Thereafter, the UE removes fallback BCs from the candidate list of BCs configured in the above stage. The fallback BC is a BC which can be obtained by removing a band corresponding to at least one SCell from a predetermined BC, and a BC before the removal of the band corresponding at least one SCell can cover the fallback BC and thus the fallback BC can be omitted. This stage is applied to MR-DC, that is, LTE bands. BCs left after the stage are a final “candidate BC list”.

4. The UE selects BCs suitable for a requested RAT type in the final “candidate BC list” and selects BCs to be reported. In this stage, the UE configures supportedBandCombinationList according to a determined order. That is, the UE configures BCs and UE capability to be reported according to an order of a preset rat-Type (nr->eutra-nr->eutra). Further, the UE configures featureSetCombination for the configured supportedBandCombinationList and configures a list of “candidate feature set combination” in a candidate BC list from which a list for fallback BCs (including capability at the same or lower stage) is received. The “candidate feature set combination” may include all feature set combinations for NR and EUTRA-NR BCs, and may be acquired from a feature set combination of UE-NR-Capabilities and UE-MRDC-Capabilities containers.

5. When the requested rat Type is eutra-nr and influences, featureSetCombinations are included in all of the two containers of UE-MRDC-Capabilities and UE-NR-Capabilities. However, the NR feature set includes only UE-NR-Capabilities.

After configuring the UE capability, the UE may transfer a UE capability information message including the UE capability to the BS. The BS may perform scheduling for the corresponding UE and transmission/reception management on the basis of the UE capability received from the UE.

Related to CA/DC

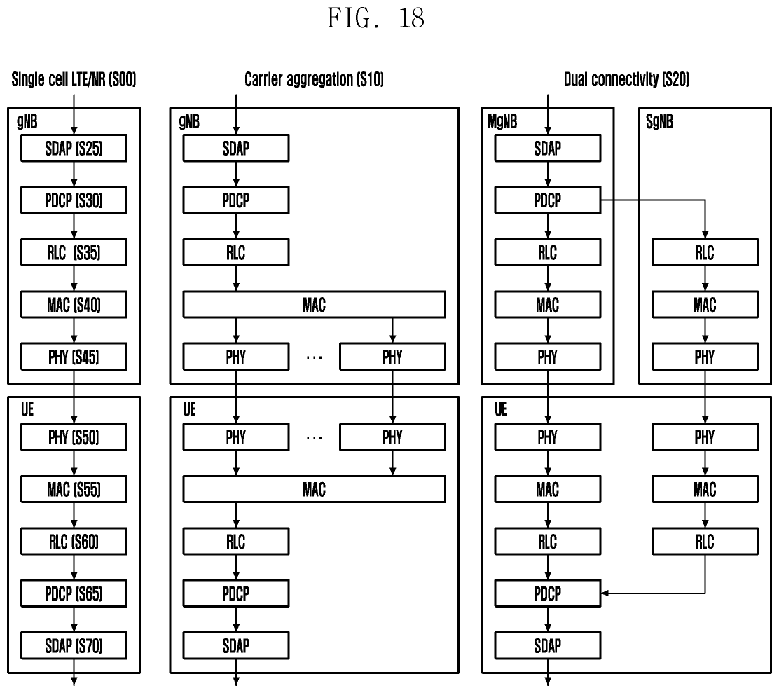

FIG. 18 illustrates a wireless protocol structure of the BS and the UE in single cell, CA, and DC, according to an embodiment of the disclosure.

Referring to FIG. 18, a wireless protocol of a wireless communication system (for example, a 5G or NR system) includes an NR service data adaptation protocol (SDAP) S25 or S70, an NR packet data convergence protocol (PDCP) S30 or S65, an NR radio link control (RLC) S35 or S60, and an NR medium access control (MAC) S40 or S55 in each of the UE and the NR gNB.

Main functions of the NR SDAP S25 or S70 may include some of the following functions:
a user data transmission function (transfer of user-plane data);
a function of mapping QoS flow and a data bearer for uplink and downlink (mapping between a QoS flow and a DRB for both DL and UL);
a function of marking a QoS flow ID for uplink and downlink (marking QoS flow ID in both DL and UL packets); and
a function of mapping reflective QoS flow to a data bearer for uplink SDAP PDUs (reflective QoS flow to DRB mapping for the UL SDAP PDUs).

With respect to the SDAP layer device, the UE may receive a configuration as to whether to use a header of the SDAP layer device or a function of the SDAP layer device for each PDCP layer device, each bearer, or each logical channel through an RRC message. If the SDAP header is configured, a 1-bit indicator of non-access stratum (NAS) reflective QoS of the SDAP header and a 1 bit-indicator of AS reflective QoS may indicate that the UE updates or reconfigures information on mapping of QoS flow and a data bearer in uplink and downlink. The SDAP header may include QoS flow ID information indicating the QoS. The QoS information may be used as data-processing-priority or scheduling information to support a seamless service.

Main functions of the NR PDCP S30 or S65 may include some of the following functions:
a header compression and decompression function (header compression and decompression: robust header compression (ROHC) only);
a user data transmission function (transfer of user data);
a sequential delivery function (in-sequence delivery of upper-layer PDUs);
a non-sequential delivery function (out-of-sequence delivery of upper-layer PDUs);
a reordering function (PDCP PDU reordering for reception);
a duplicate detection function (duplicate detection of lower-layer SDUs);
a retransmission function (retransmission of PDCP SDUs);
a ciphering and deciphering function (ciphering and deciphering); and
a timer-based SDU removal function (timer-based SDU discard in uplink).

The reordering function of the NR PDCP layer device is a function of sequentially reordering PDCP PDUs received from a lower layer on the basis of a PDCP sequence number (SN), and may include a function of sequentially transferring the reordered data to a higher layer The reordering function of the NR PDCP layer device may include a function of directly transmitting data regardless of the sequence, a function of recording PDCP PDUs lost due to the reordering, a function of reporting statuses of the lost PDCP PDUs to a transmitting side, and a function of making a request for retransmitting the lost PDCP PDUs.

Main functions of the NR RLC S35 or S60 may include some of the following functions:
a data transmission function (transfer of upper-layer PDUs);
a sequential delivery function (in-sequence delivery of upper-layer PDUs);
a non-sequential delivery function (out-of-sequence delivery of upper-layer PDUs);
an automatic repeat request (ARQ) function (error correction through ARQ);
a concatenation, segmentation, and reassembly function (concatenation, segmentation and reassembly of RLC SDUs);
a re-segmentation function (re-segmentation of RLC data PDUs);
a reordering function (reordering of RLC data PDUs);
a duplicate detection function (duplicate detection);
an error detection function (protocol error detection);
an RLC SDU deletion function (RLC SDU discard); and
an RLC reestablishment function (RLC reestablishment).

The sequential delivery function (in-sequence delivery) of the NR RLC layer device is a function of sequentially transmitting RLC SDUs received from a lower layer to the higher layer. When one original RLC SDU is divided into a plurality of RLC SDUs and then received, the sequential delivery function (in-sequence delivery) of the NR RLC layer device may include a function of reassembling and transmitting the RLC SDUs, a function of reordering the received RLC PDUs on the basis of an RLC SN or a PDCP SN, a function of recording RLC PDUs lost due to the reordering, a function of reporting statuses of the lost RLC PDUs to a transmitting side, and a function of making a request for retransmitting the lost RLC PDUs. When there are lost RLC SDUs, the sequential delivery function (in-sequence delivery) of the NR RLC layer device may include a function of sequentially transferring only RLC SDUs preceding the lost RLC SDUs to the higher layer or a function of, if a predetermined timer expires even though there are lost RLC SDUs, sequentially transferring all RLC SDUs received before the timer starts to the higher layer. Alternatively, the sequential delivery function (in-sequence delivery) of the NR RLC layer device may include a function of, if a predetermined timer expires even though there are lost RLC SDUs, sequentially transferring all RLC SDUs received up to now to the higher layer. Further, the NR RLC device may process the RLC PDUs sequentially in the order of reception thereof (according to an arrival order regardless of a serial number or a sequence number) and may transfer the RLC PDUs to the PDCP device regardless of the sequence thereof (out-of-sequence delivery). In the case of segments, the NR RLC device may receive segments that are stored in the buffer or are to be received in the future, reconfigure the segments to be one RLC PDU, process the RLC PDU, and then transmit the same to the PDCP device. The NR RLC layer device may not include a concatenation function, and the function may be performed by the NR MAC layer, or may be replaced with a multiplexing function of the NR MAC layer.

The non-sequential function (out-of-sequence delivery) of the NR RLC layer device is a function of transferring RLC SDUs received from a lower layer directly to a higher layer regardless of the sequence of the RLC SDUs, and may include, when one original RLC SDU is divided into a plurality of RLC SDUs and then received, a function of reassembling and transmitting the RLC PDUs and a function of storing RLC SNs or PDCP SNs of the received RLC PDUs, reordering the RLC PDUs, and recording lost RLC PDUs.

The NR MAC S40 or S55 may be connected to a plurality of NR RLC layer devices configured in one UE and main functions of the NR MAC may include some of the following functions:
a mapping function (mapping between logical channels and transport channels);
a multiplexing and demultiplexing function (multiplexing/demultiplexing of MAC SDUs);
a scheduling information report function (scheduling information reporting);
a HARQ function (error correction through HARQ);
a logical channel priority control function (priority handling between logical channels of one UE);
a UE priority control function (priority handling between UEs by means of dynamic scheduling);
an MBMS service identification function (MBMS service identification);
a transport format selection function (transport format selection); and
a padding function (padding).

The NR PHY layer S45 or S50 perform an operation for channel-coding and modulating higher-layer data to generate an OFDM symbol and transmitting the OFDM symbol through a radio channel or demodulating and channel-decoding the OFDM symbol received through the radio channel and transmitting the demodulated and channel-decoded OFDM symbol to the higher layer.

A detailed structure of the wireless protocol may be variously changed according to a carrier (or cell) operation scheme. For example, when the BS transmits data to the UE on the basis of a single carrier (or cell), the BS and the UE use a protocol structure having a single structure for each layer as indicated by reference numeral S00. On the other hand, when the BS transmits data to the UE on the basis of CA using multiple carriers in a single TRP, the BS and the UE use a protocol structure in which layers up to RLC have a single structure but the PHY layer is multiplexed through the MAC layer as indicated by reference numeral S10. In another example, when the BS transmits data to the UE on the basis of DC using multiple carriers in multiple TRPs, the BS and the UE use a protocol structure in which layers up to RLC have a single structure but the PHY layer is multiplexed through the MAC layer as indicated by reference numeral S20.

Referring to the PDCCH and beam configuration-related descriptions described above, it is difficult to achieve the required reliability in a scenario requiring high reliability, such as URLLC, since PDCCH repetition transmission is not currently supported in Rel-15 and Rel-16 NRs. The disclosure improves PDCCH reception reliability of a terminal by providing a PDCCH repetition transmission method via multiple transmission points (TRPs).

Hereinafter, an embodiment of the disclosure is applicable in FDD and TDD systems. Higher signaling (or higher layer signaling) may be a signal transmission method of transmitting a signal from a BS to a terminal by using a downlink data channel of a physical layer or from the terminal to the BS by using an uplink data channel of the physical layer, and may be referred to as RRC signaling, PDCP signaling, or an MAC control element (CE).

When determining whether to apply cooperative communication, the UE can use various methods by which PDCCH(s) allocating PDSCHs to which cooperative communication is applied have specific formats, PDCCH(s) allocating PDSCHs to which cooperative communication is applied include a specific indicator informing of whether cooperative communication is applied, PDCCH(s) allocating PDSCHs to which cooperative communication is applied are scrambled by a specific RNTI, or the application of cooperative communication to a specific section indicated by a higher layer is assumed. Thereafter, for convenience of description, reception of, by the UE, a PDSCH to which cooperative communication is applied on the basis of conditions similar to the above conditions is referred to as an “NC-JT” case (a non-coherent joint transmission (NC-JT) case).

Determining the priority between A and B may be mentioned in various ways, such as selecting one having a higher priority according to a predetermined priority rule to perform an operation corresponding thereto, or omitting or dropping an operation of one having a lower priority.

Hereinafter, in the disclosure, the above examples are described through a plurality of embodiments, but these are not independent and one or more embodiments may be applied simultaneously or in combination.

Related to NC-JT

According to an embodiment of the disclosure, in order to receive a PDSCH from a plurality of TRPs, the UE may use NC-JT.

A wireless communication system (for example, a 5G or NR system) may support all of the service having very short transmission latency and the service requiring a high connectivity density as well as the service requiring a high transmission rate unlike the conventional system. In a wireless communication network including a plurality of cells, TRPs, or beams, cooperative communication (coordinated transmission) between respective cells, TRPs, and/or beams may satisfy various service requirements by increasing the strength of a signal received by the UE or efficiently controlling interference between the cells, TRPs, and/or beams.

Joint transmission (JT) is a representative transmission technology for the cooperative communication and may increase the strength of a signal received by the UE or throughput by transmitting signals to one UE through different cells, TRPs, and/or beams. At this time, a channel between each cell, TRP, and/or beam and the UE may have different characteristics, and particularly, NC-JT supporting non-coherent precoding between respective cells, TRPs, and/or beams may need individual precoding, MCS, resource allocation, and TCI indication according to the channel characteristics for each link between each cell, TRP, and/or beam and the UE.

The NC-JT may be applied to at least one of a downlink data channel (e.g., a PDSCH), a downlink control channel (e.g., a PDCCH), an uplink data channel (e.g., a PUSCH), and an uplink control channel (e.g., a PUCCH)). In PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which may have a bad influence on reception performance of a PDCCH for transmitting the DCI. Accordingly, in order to support JT of the PDSCH, carefully designing a tradeoff between an amount of DCI information and reception performance of control information is required.

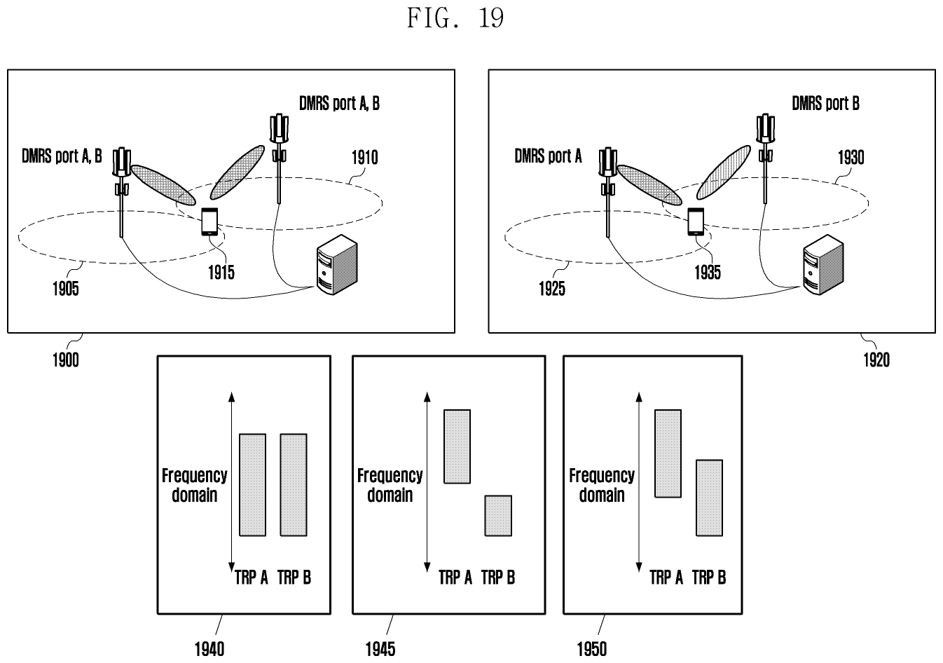

FIG. 19 illustrates a configuration of antenna ports and an example of resource allocation for transmitting a PDSCH using cooperative communication in a wireless communication system, according to an embodiment of the disclosure.

Referring to FIG. 19, the example for PDSCH transmission is described for each scheme of JT, and examples for allocating radio resources for each TRP are described.

Referring to FIG. 19, an example 1900 of coherent JT (C-JT) supporting coherent precoding between respective cells, TRPs, and/or beams is illustrated.

In the case of C-JT, a TRP A 1905 and a TRP B 1910 transmit single data (e.g., a PDSCH) to a UE 1919, and the plurality of TRPs may perform joint precoding. This may mean that the TRP A 1905 and the TPR B 1910 transmit DMRSs through the same DMRS ports in order to transmit the same PDSCH. For example, the TRP A 1905 and the TPR B 1910 may transmit DMRSs to the UE 1915 through a DMRS port A and a DMRS port B, respectively. In this case, the UE may receive one piece of DCI information for receiving one PDSCH demodulated on the basis of the DMRSs transmitted through the DMRS port A and the DMRS port B.

FIG. 19 illustrates an example 1920 of NC-JT supporting non-coherent precoding between respective cells, TRPs 1925 and 1930, and/or beams for PDSCH transmission.

In the case of NC-JT, the PDSCH is transmitted to a UE 1935 for each cell, TPR, and/or beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Further, respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

At this time, various wireless resource allocations such as the case 1940 in which frequency and time resources used by a plurality of TRPs for PDSCH transmission are all the same, the case 1945 in which frequency and time resources used by a plurality of TRPs do not overlap at all, and the case 1950 in which some of the frequency and time resources used by a plurality of TRPs overlap each other may be considered.

In order to support NC-JT, DCIs in various forms, structures, and relations may be considered to simultaneously allocate a plurality of PDSCHs to one UE.

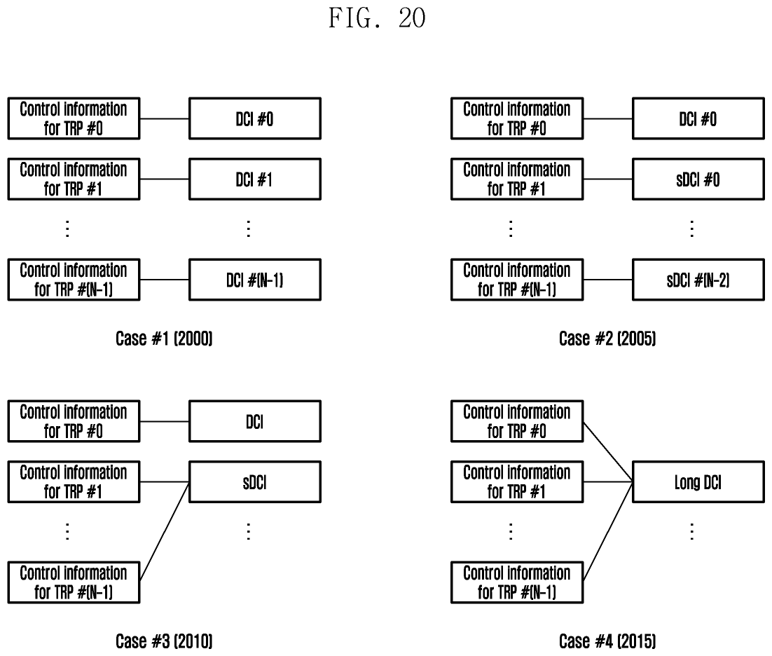

FIG. 20 illustrates an example for a configuration of DCI for NC-JT in which respective TRPs transmit different PDSCHs or different PDSCH layers to the UE in a wireless communication system, according to an embodiment of the disclosure.

Referring to FIG. 20, case #1 2000 is an example in which control information for PDSCHs transmitted from (N−1) additional TRPs is transmitted independently from control information for a PDSCH transmitted by a serving TRP in a situation in which (N−1) different PDSCHs are transmitted from the (N−1) additional TRPs (TRP #1 to TRP # (N−1)) other than the serving TRP (TRP #0) used for single PDSCH transmission. That is, the UE may acquire control information for PDSCHs transmitted from different TRPs (TRP #0 to TRP #(N−1)) through independent DCIs (DCI #0 to DCI #(N−1)). Formats between the independent DCIs may be the same as or different from each other, and payload between the DCIs may also be the same as or different from each other. In case #1, a degree of freedom of PDSCH control or allocation can be completely guaranteed, but when respective pieces of DCI are transmitted by different TRPs, a difference between DCI coverages may be generated and reception performance may deteriorate.

Case #2 2005 is an example in which pieces of control information for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP # (N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCIs (hereinafter, referred to as sDCIs) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2 2005, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 2010 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP # (N−1)) other than the serving TRP (TRP #0) used for a single PDSCH transmission.

In the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. The sDCI may include at least one piece of HARQ-related information such as frequency domain resource assignment and time domain resource assignment of the cooperative TRPs and the MCS. In addition, information that is not included in the sDCI such as a BWP indicator and a carrier indicator may follow DCI (DCI #0, normal DCI, or nDCI) of the serving TRP.

In case #3 2010, a degree of freedom of PDSCH control or allocation may be limited according to content of the information elements included in the sDCI but reception performance of the sDCI can be controlled, and case #3 2010 may have smaller complexity of DCI blind decoding of the UE compared to case #1 2000 or case #2 2005.

Case #4 2015 is an example in which control information for PDSCHs transmitted from (N−1) additional TRPs is transmitted in DCI (long DCI) that is the same as that of control information for the PDSCH transmitted from the serving TRP in a situation in which different (N−1) PDSCHs are transmitted from the (N−1) additional TRPs (TRP #1 to TRP # (N−1)) other than the serving TRP (TRP #0) used for single PDSCH transmission. That is, the UE may acquire control information for PDSCHs transmitted from different TRPs (TRP #0 to TRP # (N−1)) through single DCI. In case #4 2015, complexity of DCI blind decoding of the UE may not be increased, but a degree of freedom of PDSCH control or allocation may be low since the number of cooperative TRPs is limited according to long DCI payload restriction.

The sDCI may refer to various pieces of supplementary DCI such as shortened DCI, secondary DCI, or normal DCI (DCI formats 1_0 and 1_1) including PDSCH control information transmitted in the cooperative TRP, and unless specific restriction is mentioned, the corresponding description may be similarly applied to the various pieces of supplementary DCI.

Case #1 2000, case #2 2005, and case #3 2010 in which one or more pieces of DCI (or PDCCHs) are used to support NC-JT may be classified as multiple PDCCH-based NC-JT, and case #4 2015 in which single DCI (or PDCCH) is used to support NC-JT may be classified as single PDCCH-based NC-JT. In multiple PDCCH-based PDSCH transmission, a CORESET for scheduling DCI of the serving TRP (TRP #0) is separated from CORESETs for scheduling DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Further, in single PDCCH-based NC-JT, single DCI schedules a single PDSCH having a plurality of layers instead of scheduling a plurality of PDSCHs, and the plurality of layers may be transmitted from a plurality of TRPs. At this time, association between a layer and a TRP transmitting the corresponding layer may be indicated through a TCI indication for the layer.

The “cooperative TRP” may be replaced with various terms such as a “cooperative panel” or a “cooperative beam” when actually applied.

“The case in which NC-JT is applied” may be variously interpreted as “the case in which the UE simultaneously receives one or more PDSCHs in one BWP”, “the case in which the UE simultaneously receives PDSCHs on the basis of two or more TCI indications in one BWP”, and “the case in which the PDSCHs received by the UE are associated with one or more DMRS port groups” according to circumstances, but is used by one expression for convenience of description.

In the disclosure, a wireless protocol structure for NC-JT may be variously used according to a TRP development scenario. For example, when there is no backhaul delay between cooperative TRPs or there is a small backhaul delay, a method (a CA-like method) using a structure based on MAC layer multiplexing can be used similarly to reference numeral S10 of FIG. 18. On the other hand, when the backhaul delay between cooperative TRPs is too large to be ignored (for example, when a time of 2 ms or longer is needed to exchange information such as CSI, scheduling, and HARQ-ACK between cooperative TRPs), a method (a DC-like method) of securing a characteristic robust to a delay can be used through an independent structure for each TRP from an RLC layer similarly to reference numeral S20 of FIG. 18.

The UE supporting C-JT/NC-JT may receive a C-JT/NC-JT-related parameter or a setting value from a higher-layer configuration and set an RRC parameter of the UE on the basis thereof. For the higher-layer configuration, the UE may use a UE capability parameter, for example, tci-StatePDSCH. The UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 means a value indicated by maxNumberConfiguredTCIstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

Multi-DCI Based Multi-TRP

As an embodiment of the disclosure, a multi-DCI-based multi-TRP transmission method will be described. According to multi-DCI based multi-TRP transmission method, a downlink control channel for NC-JT may be configured based on multi-PDCCHs.

In NC-JT based on multiple PDCCHs, there may be a CORESET or a search space separated for each TRP when DCI for scheduling the PDSCH of each TRP is transmitted. The CORESET or the search space for each TRP can be configured according to at least one of the following configuration cases.
A configuration of a higher-layer index for each CORESET: CORESET configuration information configured by a higher layer may include an index value, and a TRP for transmitting a PDCCH in the corresponding CORESET may be identified by the configured index value for each CORESET. That is, in a set of CORESETs having the same higher-layer index value, the same TRP may transmit the PDCCH or the PDCCH for scheduling the PDSCH of the same TRP may be transmitted. The index for each CORESET may be named CORESETPoolIndex, and it may be considered that the PDCCH is transmitted from the same TRP in CORESETs in which the same CORESETPoolIndex value is configured. In the CORESET in which the same CORESETPoolIndex value is not configured, a default value of CORESETPoolIndex may be configured, and the default value may be 0.
In the disclosure, when the number of types of CORESETPoolIndex of each of a plurality of CORESETs included in higher-layer signaling PDCCH-Config is larger than 1, that is, when respective CORESETs have different CORESETPoolIndex, the UE may consider that the BS can use a multi-DCI-based multi-TRP transmission method.
Unlike this, in the disclosure, when the number of types of CORESETPoolIndex of each of a plurality of CORESETs included in higher-layer signaling PDCCH-Config is 1, that is, when all CORESETs have the same CORESETPoolIndex of 0 or 1, the UE may consider that the BS performs transmission using a single-TRP without using the multi-DCI-based multi-TRP transmission method.
A configuration of multiple PDCCH-Config: a plurality of PDCCH-Config are configured in one BWP, and each PDCCH-Config may include a PDCCH configuration for each TRP. That is, a list of CORESETs for each TRP and/or a list of search spaces for each TRP may be included in one PDCCH-Config, and one or more CORESETs and one or more search spaces included in one PDCCH-Config may correspond to a specific TRP.
A configuration of a CORESET beam/beam group: a TRP that corresponds to the corresponding CORESET may be identified through a beam or a beam group configured for each CORESET. For example, when the same TCI state is configured in a plurality of CORESETs, the corresponding CORESETs may be transmitted through the same TRP or a PDCCH for scheduling a PDSCH of the same TRP may be transmitted in the corresponding CORESET.
A configuration of a search space beam/beam group: a beam or a beam group is configured for each search space, and a TRP for each search space may be identified therethrough. For example, when the same beam/beam group or TCI state is configured in a plurality of search spaces, the same TRP may transmit the PDCCH in the corresponding search space or a PDCCH for scheduling a PDSCH of the same TRP may be transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The configuration may be independent for each cell or BWP. For example, while two different CORESETPoolIndex values may be configured in the primary cell (PCell), no CORESETPoolIndex value may be configured in a specific SCell. In this case, NC-JT may be configured in the PCell, but NC-JT may not be configured in the SCell in which no CORESETPoolIndex value is configured.

A PDSCH TCI state activation/deactivation MAC-CE which can be applied to the multi-DCI-based multi-TRP transmission method may follow FIG. 16B above. When the UE does not receive a configuration of CORESETPoolIndex for each of all CORESETs within higher-layer signaling PDCCH-Config, the UE may ignore a CORESET Poll ID field 16-55 within the corresponding MAC-CE 16-50. When the UE can support the multi-DCI-based multi-TRP transmission method, that is, when respective CORESETs within higher-layer signaling PDCCH-Config have different CORESETPoolIndex, the UE may activate a TCI state within DCI included in PDCCHs transmitted in CORESETs having CORESETPoolIndex which is the same as a value of the CORESET Poll ID field 16-55 within the corresponding MAC-CE 16-50. For example, when the value of the CORESET Poll ID field 16-55 within the corresponding MAC-CE 16-50 is 0, a TCI state within DCI included in PDCCHs transmitted by the CORESETs having CORESETPoolIndex of 0 may follow activation information of the corresponding MAC-CE.

When the UE receives a configuration indicating that the multi-DCI-based multi-TRP transmission method can be used from the BS, that is, the number of types of CORESETPoolIndex of a plurality of CORESETs included in higher-layer signaling PDCCH-Config is larger than 1 or respective CORESETs have different CORESETPoolIndex, the UE may know that there are the following restrictions on PDSCHs scheduled by PDCCHs within respective CORESETs having different two CORESETPollIndex.

1) When PDSCH indicated by PDCCHs within respective CORESETs having different two CORESETPollIndex completely or partially overlap, the UE may apply TCI states indicated by the respective PDCCHs to different CDM groups. That is, two or more TCI states may not be applied to one CDM group.

2) When PDSCH indicated by PDCCHs within respective CORESETs having different two CORESETPollIndex completely or partially overlap, the UE may expect that the numbers of actual front loaded DMRS symbols of respective PDSCHs, the numbers of actual additional DMRS symbols, locations of actual DMRS symbols, and DMRS types are not different.

3) The UE may expect that bandwidth parts indicated by PDCCHs within respective CORESETs having different two CORESETPoolIndex are the same and subcarrier spacings are also the same.

4) The UE may expect that information on PDSCH scheduled by PDCCHs within respective CORESETs having different two CORESETPoolIndex are completely included in respective PDCCHs.

Single-DCI-Based Multi-TRP

As an embodiment of the disclosure, a single-DCI-based multi-TRP transmission method is described. The single-DCI-based multi-TRP transmission method may configure a downlink control channel for NC-JT on the basis of a single PDCCH.

In single DCI based multi-TRP transmission method, PDSCH transmitted by a plurality of TRPs may be scheduled by one piece of DCI. At this time, as a method of indicating the number of TRPs transmitting the corresponding PDSCHs and the number of TCI states may be used. That is, single PDCCH-based NC-JT may be considered when the number of TCI states indicated by DCI for scheduling the PDSCHs is 2, and single-TRP transmission may be considered when the number of TCI states is 1. The TCI states indicated by the DCI may correspond to one or two TCI states among TCI states activated by the MAC CE. When the TCI states of DCI correspond to two TCI states activated by the MAC CE, a TCI codepoint indicated by the DCI is associated with the TCI states activated by the MAC CE, in which case the number of TCI states activated by the MAC CE, corresponding to the TCI codepoint, may be 2.

In another example, when at least one of all codepoints of the TCI state field within DCI indicate two TCI states, the UE may consider that the BS can perform transmission on the basis of the single-DCI-based multi-TRP method. At this time, at least one codepoint indicating two TCI states within the TCI state field may be activated through an enhanced PDSCH TCI state activation/deactivation MAC-CE.

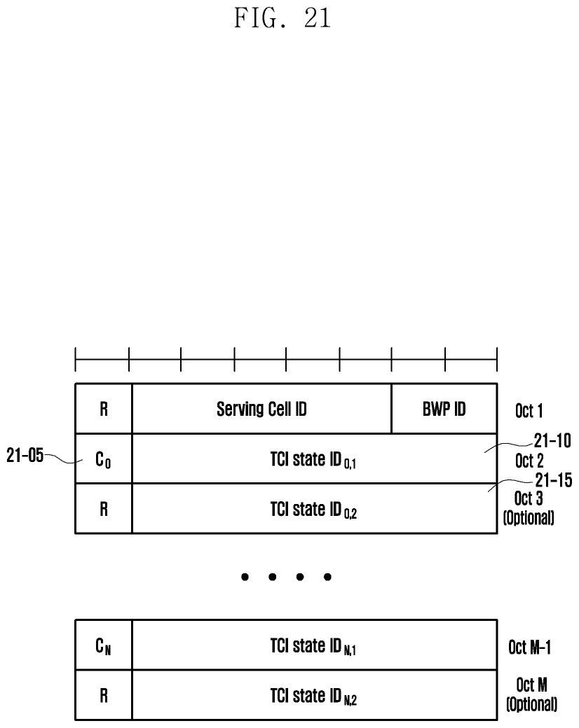

FIG. 21 illustrates an enhanced PDSCH TCI state activation/deactivation MAC-CE format according to an embodiment of the disclosure. The meaning of each field within the MAC CE and a value configurable in each field are as described below.

Serving Cell ID: This field indicates the identity of the Serving Cell for which
the MAC CE applies. The length of the field is 5 bits. If the indicated Serving
Cell is configured as part of a simultaneousTCI-UpdateList1 or simultaneousTCI-
UpdateList2 as specified in TS 38.331 [5], this MAC CE applies to all the Serving
Cells configured in the set simultaneousTCI-UpdateList1 or simultaneousTCI-
UpdateList2, respectively;
BWP ID: This field indicates a DL BWP for which the MAC CE applies as the
codepoint of the DCI bandwidth part indicator field as specified in TS 38.212 [9].
The length of the BWP ID field is 2 bits;
Cᵢ: This field indicates whether the octet containing TCI state ID_{i, 2} is present. If
this field is set to “1”, the octet containing TCI state ID_{i, 2} is present. If this field
is set to “0”, the octet containing TCI state ID_{i, 2} is not present;
TCI state ID_{i, j}: This field indicates the TCI state identified by TCI-StateId as
specified in TS 38.331 [5], where i is the index of the codepoint of the DCI
Transmission configuration indication field as specified in TS 38.212 [9] and TCI
state ID_{i, j} denotes the j-th TCI state indicated for the i-th codepoint in the DCI
Transmission Configuration Indication field. The TCI codepoint to which the
TCI States are mapped is determined by its ordinal position among all the TCI
codepoints with sets of TCI state ID_{i, j} fields, i.e. the first TCI codepoint with TCI
state ID_{0, 1} and TCI state ID_{0, 2} shall be mapped to the codepoint value 0, the second
TCI codepoint with TCI state ID_{1, 1} and TCI state ID_{1, 2} shall be mapped to the
codepoint value 1 and so on. The TCI state ID_{i, 2} is optional based on the
indication of the Ci field. The maximum number of activated TCI codepoint is 8
and the maximum number of TCI states mapped to a TCI codepoint is 2.
R: Reserved bit, set to “0”.

Referring to FIG. 21, when a value of a C₀ field 21-05 is 1, the corresponding MAC-CE may include a TCI state ID_{0,2} field 21-15 in addition to a TCI state ID_{0,1} field 21-10. This means that a TCI state ID_{0,1} and a TCI state ID_{0,2} are activated for a zeroth codepoint of the TCI state field included within the DCI, and when the BS indicates the corresponding codepoint to the UE, the UE may receive an indication of two TCI states. When a value of the C₀ field 21-05 is 0, the corresponding MAC-CE cannot include the TCI state ID_{0,2} field 21-15, which means that one TCI state corresponding to the TCI state ID_{0,1} is activated for the zeroth codepoint of the TCI state field included in the DCI.

The configuration may be independent for each cell or BWP. For example, while a maximum number of activated TCI states corresponding to one TCI codepoint is 2 in the primary cell (PCell), a maximum number of activated TCI states corresponding to one TCI codepoint may be 1 in a specific SCell. In this case, NC-JT may be configured in the PCell but NC-JT may not be configured in the SCell.

Method of Distinguishing Single-DCI-Based Multi-TRP PDSCH Repetitive Transmission Schemes (TDM/FDM/SDM)

Subsequently, a method of distinguishing single-DCI-based multi-TRP PDSCH repetitive transmission schemes is described. The UE may receive an indication of different single-DCI-based multi-TRP PDSCH repetitive transmission schemes (for example, TDM, FDM, and SDM) from the BS according to a value indicated by a DCI field and a higher-layer signaling configuration. Table 31 below shows a method of distinguishing single or multi-TRP-based schemes according to a specific DCI field value and a higher-layer signaling configuration.

TABLE 31

| | | | repetitionNumber | | |
|---|---|---|---|---|---|
| | | | configuration | Related to | Transmission |
| | Number of | Number of | and indication | repetitionScheme | scheme indicated |
| Combination | TCI state | CDM groups | condition | configuration | to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP TDM |
| | | | | not configured | scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 2 | Condition 3 | Configured | Multi-TRP FDM |
| | | | | | scheme A/FDM |
| | | | | | scheme B/TDM |
| | | | | | scheme A |
| 9 | 2 | 2 | Condition 1 | Not configured | Multi-TRP SDM |
| | | | | | scheme B |

Each column in Table 31 above is described below.
Number of TCI states (second column): means the number of TCI states indicated by a TCI state field within DCI and may be 1 or 2.
Number of CDM groups (third column): means the number of different CDM groups of DRMS ports indicated by an antenna port field within DCI. The number of CDM groups may be 1, 2, or 3.
RepetitionNumber configuration and indication condition (fourth column): has three conditions according to whether repetitionNumber for all TDRA entries which can be indicated by a time domain resource allocation field within DCI is configured and whether an actually indicated TDRA entry has a repetitionNumber configuration.

Condition 1: case in which at least one of all TDRA entries which can be indicated by the time domain resource allocation field includes the configuration for repetitionNumber and the TDRA entry indicated by the time domain resource allocation field within DCI includes the configuration of repetitionNumber larger than 1.

Condition 2: case in which at least one of all TDRA entries which can be indicated by the time domain resource allocation field includes the configuration for repetitionNumber and the TDRA entry indicated by the time domain resource allocation field within DCI does not include the configuration for repetitionNumber.

Condition 3: case in which all TDRA entries which can be indicated by the time domain resource allocation field do not include the configuration for repetitionNumber.
Related to a repetitionScheme configuration (fifth column): means whether repetitionScheme which is higher-layer signaling is configured. RepetitionScheme which is higher-layer signaling may receive a configuration of one of ‘tdmSchemeA’, and ‘fdmSchemeA’, ‘fdmSchemeB’.
Transmission scheme indicated to UE (sixth column): means single or multiple-TRP schemes indicated according to each combination (first column) expressed by Table 31 above.

Single-TRP: means single-TRP-based PDSCH transmission. When the UE receives a configuration of pdsch-AggegationFactor within higher-layer signaling PDSCH-config, the UE may receive scheduling of single TRP-based PDSCH repetitive transmission a number of times received through the configuration. Otherwise, the UE may receive scheduling of single TRP-based PDSCH single transmission.

Single-TRP TDM scheme B: means time resource division-based PDSCH repetitive transmission between single TRP-based slots. The UE repeatedly transmits a PDSCH on a time dimension a number of times corresponding to the number of slots of repetitionNumber larger than 1 configured in the TDRA entry indicated by the time domain resource allocation field according to condition 1 related to repetitionNumber. At this time, a start symbol and a symbol length of the PDSCH indicated by the TDRA entry is equally applied to every slot corresponding to repetitionNumber and the same TCI state is applied to each PDSCH repetitive transmission. The corresponding scheme is similar to a slot aggregation scheme in that the PDSCH repetitive transmission between slots is performed in time resources but is different therefrom in that a repetitive transmission indication is dynamically determined on the basis of the time domain resource allocation field within DCI.

Multi-TRP SDM: means a multi-TRP-based space resource division PDSCH transmission scheme. This is a method of dividing a layer and performing reception from each TRP and may increase reliability of PDSCH transmission in that transmission can be performed at a lowered coding rate through an increase in the number of layers even though it is not the repetitive transmission scheme. The UE may receive a PDSCH by applying each of two TCI states indicated through the TCI state field within DCI to two CDM groups indicated by the BS.

Multi-TRP FDM scheme A: means a multi-TRP-based frequency resource division PDSCH transmission scheme and is a scheme having one PDSCH transmission occasion and capable of performing transmission with higher reliability by increasing frequency resources and lowering a coding rate even though is not the repetitive transmission such as multi-TRP SDM. Multi-TRP FDM scheme A may apply two TCI states indicated through the TCI state field within DCI to frequency resources which do not overlap each other. When the PRB bundling size is determined as a wideband and the number of RBs indicated by the frequency domain resource allocation field is N, the UE may receive first ceil (N/2) RBs by applying a first TC state and receive the remaining floor(N/2) RBs by applying a second TCI state. Here, ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.

Multi-TRP FDM scheme B: means a multi-TRP-based frequency resource division PDSCH repetitive transmission scheme and has two PDSCH transmission occasions to repeatedly transmit a PDSCH at each occasion. Like A, multi-TRP FDM scheme B may also apply two TCI states indicated through the TCI state field within DCI to frequency resources which do not overlap each other. When the PRB bundling size is determined as a wideband and the number of RBs indicated by the frequency domain resource allocation field is N, the UE may receive first ceil (N/2) RBs by applying a first TC state and receive the remaining floor(N/2) RBs by applying a second TCI state. Here, ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.

Multi-TRP TDM scheme A: means a PDSCH repetitive transmission scheme within a multi-TRP-based time resource division slot. The UE has two PDSCH transmission occasion within one slot, and a first reception occasion may be determined on the basis of a start symbol and a symbol length of the PDSCH indicated through the time domain resource allocation field within DCI. A start symbol of a second reception occasion of the PDSCH may be an occasion to which a symbol offset by higher-layer signaling StartingSymbolOffsetK from the last symbol of the first transmission occasion, and the transmission occasion corresponding to the symbol length indicated therefrom may be determined. When higher-layer signaling StartingSymbolOffsetK is not configured, the symbol offset may be considered as 0.

Multi-TRP TDM scheme B: means a PDSCH repetitive transmission scheme between multi-TRP-based time resource division slots. The UE has one PDSCH transmission occasion within one slot and may receive repetitive transmission on the basis of a start symbol and a symbol length of the same PDSCH during slots corresponding to repetitionNumber indicated by the time domain resource allocation field within DCI. When repetitionNumber is 2, the UE may receive PDSCH repetitive transmission of first and second slots by applying first and second TCI states, respectively. When repetitionNumber is larger than 2, the UE may use different TCI state schemes according to configured higher-layer signaling tciMapping. When tciMapping is configured as cyclicMapping, first and second TCI states may be applied to first and second PDSCH transmission occasions, respectively, and the same TCI state application method is equally applied to the remaining PDSCH transmission occasions. When tciMapping is configured as sequenticalMapping, a first TCI state may be applied to first and second PDSCH transmission occasions, a second TCI state may be applied to third and fourth PDSCH transmission occasions, and the same TCI state application method may be equally applied to the remaining PDSCH transmission occasions.

Related to RLM RS

Subsequently, a method of selecting or determining an RLM RS when radio link monitoring reference signal (RLM RS) is configured or not configured. The UE may receive a configuration of a set of RLM RSs through RadioLinkMonitoringRS within higher-layer signaling RadioLinkMonitoringConfig for each downlink bandwidth part of the SpCell from the BS. A detailed higher-layer signaling structure of RadioLinkMonitoringConfig may follow Table 32 below.

```
TABLE 32
RadioLinkMonitoringConfig ::= SEQUENCE {
  failureDetectionResourcesToAddModList SEQUENCE
(SIZE(1..maxNrofFailureDetectionResources)) OF RadioLinkMonitoringRS
OPTIONAL, -- Need N
  failureDetectionResourcesToReleaseList SEQUENCE
(SIZE(1..maxNrofFailureDetectionResources)) OF RadioLinkMonitoringRS-Id
OPTIONAL, -- Need N
  beamFailureInstanceMaxCount ENUMERATED {n1, n2, n3, n4, n5, n6, n8, n10}
      OPTIONAL, -- Need R
  beamFailureDetectionTimer ENUMERATED {pbfd1, pbfd2, pbfd3, pbfd4, pbfd5,
pbfd6, pbfd8, pbfd10} OPTIONAL, -- Need R
...
}
RadioLinkMonitoringRS ::= SEQUENCE {
  radioLinkMonitoringRS-Id RadioLinkMonitoringRS-Id,
  purpose ENUMERATED {beamFailure, rlf, both},
  detectionResource CHOICE {
    ssb-Index SSB-Index,
    csi-RS-Index NZP-CSI-RS-ResourceId
  },
...
}
```

Table 33 may show the number of RLM RSs which can be configured or selected for specific purpose according to a maximum number of SSBs (Lₘₐₓ) per half frame. As shown in Table 33, N_{LR-RLM} RSs may be used for link recovery or radio link monitoring according to a value of Lₘₐₓ, and N_{RLM} RSs among the N_{LR-RLM} RSs may be used for radio link monitoring.

TABLE 33
N_{LR-RLM} and N_{RLM} as a function of maximum number
Lₘₐₓ of SS/PBCH blocks per half frame

| Lₘₐₓ | N_{LR-RLM} | N_{RLM} |
|---|---|---|
| 4 | 2 | 2 |
| 8 | 6 | 4 |
| 64 | 8 | 8 |

When the UE does not receive a configuration of higher-layer signaling RadioLinkMonitoringRS and receives a configuration of a TCI state for receiving a PDSCH in a control resource set, and at least one CSI-RS is included in the corresponding TCI state, an RLM RS may be selected according to the following RLM RS selection methods.
RLM RS selection method 1) When the activated TCI state to be used for receiving the PDCCH has one reference RS (that is, when one activated TCI state has only one of QCL-TypeA, B, or C), the UE may select the reference RS of the activated TCI state to be used for receiving the PDCCH as the RLM RS.
RLM RS selection method 2) When the activated TCI state to be used for receiving the PDCCH has two reference RSs (that is, when one activated TCI state has one of QCL-TypeA, B, or C, and additionally has QCL-TypeD), the UE may select the reference RS of the QCL-TypeD as the RLM RS. The UE does not expect a configuration of two QCL-TypeD in one activated TCI state.
RLM RS selection method 3) The UE does not expect selection of an aperiodic or semi-persistent RS as the RLM RS.
RLM RS selection method 4) When Lₘₐₓ=4, the UE may select NRLM RSs (may select two RSs since Lₘₐₓ is 4). RLM RSs may be selected from reference RSs of the TCI state configured in the control resource set for receiving the PDCCH on the basis of the RLM RS selection methods 1 to 3. The UE may determine that a search space, to which the control resource set is associated, having a short period has a high priority and perform RLM RS selection from the reference RS of the TCI state configured in the control resource set associated with the search space having the shortest period. When the number of control resource sets associated with a plurality of search spaces having the same period is plural, the UE may perform RLM RS selection from the reference RS of the TCI state configured in a higher control resource set index.

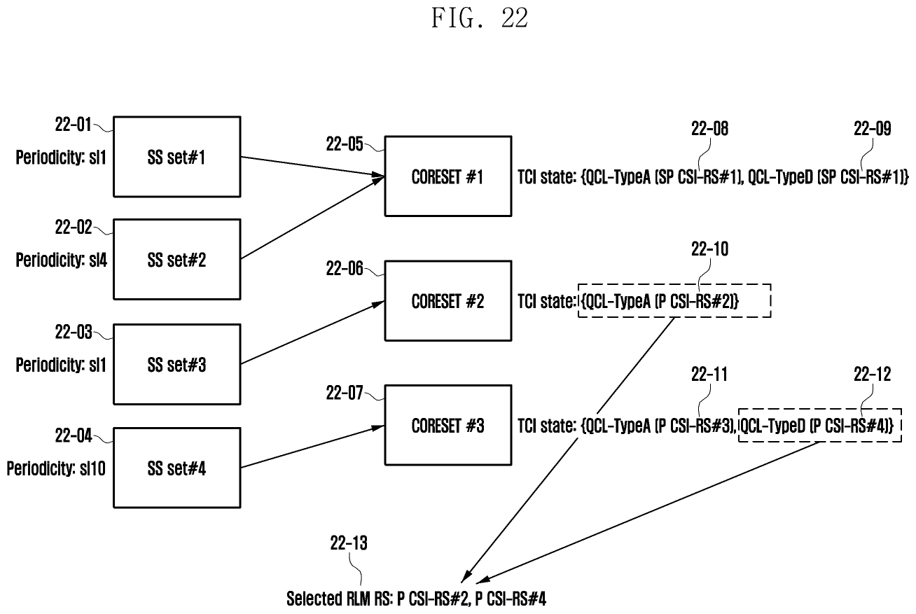

FIG. 22 illustrates an RLM RS selection process according to an embodiment of the disclosure.

Referring to FIG. 22, it illustrates control resource set #1 to control resource set #3 22-05 to 22-07 connected to search space #1 to search space #4 22-01 to 22-04 having different periods within an activated downlink bandwidth part and reference RSs of TCI states configured in the respective control resource sets. According to RLM RS selection method 4, the RLM RS selection uses a TCI state configured in a control resource set associated with a search space having the shortest period. In this case, search space #1 22-01 and search space #3 22-03 have the same period, and thus a reference RS of a TCI state configured in control resource set #2 having the highest index among control resource set #1 22-05 and control resource set #2 22-06 associated with the respective search spaces may be used as the highest priority in RLM RS selection. Further, since the TCI state configured in control resource set #2 may have only QCL-TypeA and the corresponding reference RS is a periodic RS, P CSI-RS #2 22-10 may be first selected as the RLM RS according to RLM RS selection methods 1 and 3. Among reference RSs 22-08 and 22-09 of TCI states configured in control resource set #1 having the next higher priority, a reference RS of QCL-TypeD may be selected as a selection candidate according to RLM RS selection method 2, but the corresponding RS is a semi-persistent RS as indicated by reference numeral 22-09 and thus is not selected as the RLM RS according to RLM RS selection method 3. Accordingly, reference RSs 22-11 and 22-12 of the TCI states configured in control resource set #3 may be considered as the next higher priority, the reference RS of QCL-TypeD may become the selection candidate according to RLM RS selection method 2, and the corresponding RS is a periodic RS, and thus P CSI-RS #4 22-12 may be secondly selected as the RLM RS according to RLM RS selection method 3. Accordingly, the finally selected RLM RS may be P CSI-RS #2 and P CSI-RS #4 as indicated by reference numeral 22-13.

Referring to the description about the PDCCH transmission and reception configuration and the transmission beam configuration, PDCCH repetitive transmission is not supported in current Rel-15/16 NR, and thus it may be difficult to achieve requirement reliability in a scenario requiring high reliability such as URLLC. Meanwhile, in Rel-17 further enhanced MIMO (FeMIMO), a method of improving reception reliability of the PDCCH through repetitive transmission of the PDCCH is being standardized. The PDCCH repetitive transmission methods may include a non-SFN method of dividing time or frequency resources through different TRPs in control resource sets explicitly connected to a plurality of search spaces representatively through higher-layer signaling and repeatedly transmitting the PDCCH and a method of configuring a plurality of TCI states in one control resource set and repeatedly transmitting the PDCCH in an SFN scheme. In the non-SFN method among them, different control resource sets may be connected to a plurality of search spaces explicitly connected through higher-layer signaling, or the same control resource set may be connected to all search spaces. At this time, a method of connecting different control resource sets may be considered as a multi-TRP-based PDCCH repetitive transmission method since transmission is performed in different TRPs for respective control resource sets. Further, at this time, the method of connecting the control resource set to all search spaces may be considered as a single-TRP-based PDCCH repetitive transmission method since all transmissions are performed in the same TRP.

Meanwhile, in the RLM RS selection method, when the UE does not receive the RLM RS configuration in current Rel-15/16 NR, only the RLM RS selection method of the UE is defined in the case in which the number of TCI states configured in the control resource set is 1 and the selection method is not defined in the case in which a plurality of TCI states are configured or activated such as the control resource set in which there is a PDCCH transmitted in the SFN scheme. Further, a specific control resource set may change the number of activated TCI states to 1 or plural through MAC-CE signaling in order to determine whether the SFN scheme is supported. In this case, when the number of TCI states are reduced due to TCI state activation, a method how to process already selected RLM RSs has not been defined. In the disclosure, a method of selecting a link monitoring reference signal when there are control resource sets in which a plurality of TCI states are configured/activated is described in detail.

A cell, a TRP, a panel, a beam, and/or a transmission direction distinguished by an indicator such as a higher layer/L1 parameter of a TCI state and spatial relation information, a cell ID, a TRP ID, or a panel ID, etc. is commonly described as a TRP. Accordingly, in the actual application, the TRP can be appropriately replaced with one of the terms.

When determining whether to apply cooperative communication, the UE can use various methods by which PDCCH(s) allocating PDSCHs to which cooperative communication is applied have specific formats, PDCCH(s) allocating PDSCHs to which cooperative communication is applied include a specific indicator informing of whether cooperative communication is applied, PDCCH(s) allocating PDSCHs to which cooperative communication is applied are scrambled by a specific RNTI, or the application of cooperative communication to a specific section indicated by a higher layer is assumed. Thereafter, for convenience of description, reception of, by the UE, a PDSCH to which cooperative communication is applied on the basis of conditions similar to the above conditions is referred to as an NC-JT case.

Hereinafter, embodiments of the disclosure will be described in detail with reference to the accompanying drawings. In the following description, a BS is an entity that allocates resources to terminals, and may be at least one of a gNode B, an eNode B, a Node B, a BS, a wireless access unit, a BS controller, or a node on a network. A terminal may include a UE, a mobile station (MS), a cellular phone, a smartphone, a computer, or a multimedia system capable of performing communication functions. Further, although the following description may be directed to a 5G system by way of example, embodiments of the disclosure may also be applied to other communication systems having similar technical backgrounds or channel types to the embodiments of the disclosure. Examples of other communication systems may include LTE, LTE-A and communication system developed beyond 5G. In addition, based on determinations by those skilled in the art, the disclosure may be applied to other communication systems through some modifications without significantly departing from the scope of the disclosure. The contents of the disclosure are applicable to FDD and TDD systems.

Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing the disclosure below, higher-layer signaling may be singling corresponding to at least one of or a combination of one or more of the following signaling: Master Information Block (MIB)

SIB (System Information Block) or SIB X (X=1, 2, . . . )

RRC (Radio Resource Control)

MAC (Medium Access Control) CE (Control Element)

L1 signaling may be signaling corresponding to at least one of or a combination of one or more of signaling methods using the following physical layer channels or signaling.
a PDCCH;
DCI;
UE-specific DCI;
group common DCI;
common DCI;
scheduling DCI (for example, DCI used to schedule downlink or uplink data);
non-scheduling DCI (for example, DCI other than DCI used to schedule downlink or uplink data);
a PUCCH; and
UCI.

Determining priorities of A and B in the disclosure may be variously expressed as selecting one having a higher priority according to a predetermined priority rule and performing an operation corresponding thereto or omitting (or dropping) an operation for one having a lower priority.

Hereinafter, in the disclosure, the above examples are described through a plurality of embodiments, but these are not independent and one or more embodiments may be applied simultaneously or in combination.

### First Embodiment: A Method of Multi-TRP Based PDCCH Repetitive Transmission

As an embodiment of the disclosure, a PDCCH repetitive transmission method in consideration of multiple TRP will be described. For the PDCCH repetitive transmission based on multiple TRPs, various methods may exist depending on how each TCI state, which is applied when transmitting PDCCH in each TRP, to apply to the aforementioned various parameters used for PDCCH transmission. For example, various parameters used for PDCCH transmission to which different TCI states are applied may include a CCE, a PDCCH candidate, a CORESET, and a search space. In PDCCH repetitive transmission considering multiple TRPs, a reception scheme of the UE may include soft combining and a selection scheme.

There may be five methods for PDCCH repetitive transmission through multiple TRPs. The BS may configure at least one the five methods in the UE through higher-layer signaling, indicate the same through L1 signaling, or configure and indicate the same through a combination of higher-layer signaling and L1 signaling.

Method 1-1, a Repetitive Transmission Method of Multiple PDCCHs Having the Same Payload

Method 1-1 is a method of repeatedly transmitting a plurality of pieces of control information having the same DCI format and the same payload. The control information may include information for scheduling repeatedly transmitted PDSCHs, for example, {PDSCH #1, PDSCH #2, PDSCH #Y} repeatedly transmitted over a plurality of slots. The same payload of repeatedly transmitted control information may mean all pieces of PDSCH scheduling information of each control information, for example, the number of PDSCH repetitive transmissions, time domain PDSCH resource allocation information, that is, a slot offset (K₀) between control information and PDSCH #1 and the number of PDSCH symbols, frequency domain PDSCH resource allocation information, DMRS port allocation information, PDSCH-to-HARQ-ACK timing, and a PUCCH resource indicator may be the same as each other. The UE may improve reception reliability of control information by soft-combining repetitive transmission control information having the same payload.

In order to perform soft combining, the UE is required to know in advance the resource location of control information to be repeatedly transmitted and the number of repetitive transmissions. To this end, the BS may indicate in advance time domain, frequency domain, and spatial domain resource configurations of the repeatedly transmitted control information to the UE.

When control information is repeatedly transmitted in the time domain, the control information may be repeatedly transmitted over different CORESETs, repeatedly transmitted over different search space sets within one CORESET, or repeatedly transmitted over different PDCCH monitoring occasions within one CORESET and one search space set. The unit of resources repeatedly transmitted in the time domain (e.g., CORESET unit, search space set unit, or PDCCH monitoring occasion unit) and the location of repetitive transmission resources (e.g., a PDCCH candidate index) may be indicated through a higher-layer configuration of the BS. At this time, the number of PDCCH repetitive transmissions and/or a list of TRPs participating in repetitive transmission, and a transmission pattern may be explicitly indicated, and a higher-layer indication or a MAC-CE/L1 signaling may be used as an explicit indication method. The list of TRPs may be indicated by the TCI state or in the form of QCL assumption.

When control information is repeatedly transmitted in the frequency domain, the control information may be repeatedly transmitted over different CORESETs, repeatedly transmitted over different PDCCH candidates within one CORESET, or repeatedly transmitted for each CCE. The unit of resources repeatedly transmitted in the frequency domain and the location of resources of repetitive transmission may be indicated through a higher-layer configuration. Further, the number of repetitive transmissions and/or a list of TRPs participating in repetitive transmission, and a transmission pattern may be explicitly indicated, and a higher-layer indication or a MAC-CE/L1 signaling may be used as an explicit indication method. The list of TRPs may be indicated by the TCI state or in the form of QCL assumption.

When control information is repeatedly transmitted in the spatial domain, the control information may be repeatedly transmitted over different CORESETs or two or more TCI states may be configured in one CORESET and the control information may be repeatedly transmitted.

As an embodiment of the disclosure, a method by which the BS repeatedly transmits a PDCCH is described. In a wireless communication system, DCI including scheduling information for a PUSCH or a PDSCH may be transmitted from the BS to the UE through a PDCCH.

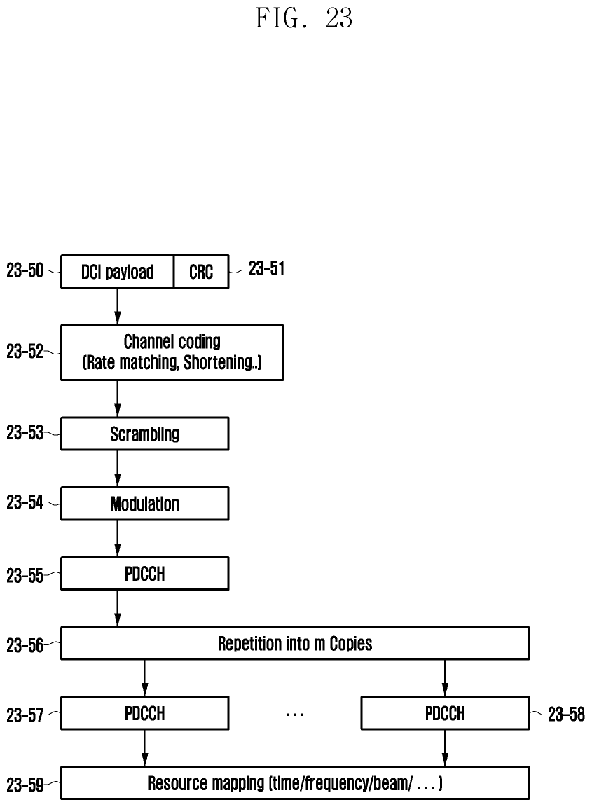

FIG. 23 illustrates a process of generating a PDCCH repeatedly transmitted through two TRPs according to an embodiment of the disclosure.

Referring to FIG. 23, the BS may generate a DCI payload in operation 23-50, attach a CRC to the DCI payload in operation 23-51, perform channel coding in operation 23-52, scrambling in operation 23-53, and modulation in operation 23-54, and generate a PDCCH in operation 23-55. Thereafter, the BS may copy the generated PDCCH multiple times in operations 23-56, 23-57, and 23-58 and transmit the PDCCHs through specific resources (for example, time, frequency, transmission beam, and the like) in operation 23-59. That is, all coded bits for the repeatedly transmitted PDCCH in respective TRPs may be the same as each other. In order to make all of the coded bits the same, information values for respective DCI fields within the PDCCHs may be configured to be the same. For example, all fields (e.g., TDRA, FDRA, TCI, Antenna ports, and the like) included in the DCI may be configured to have the same value. The same value may be interpreted as one meaning, but may be analyzed as a plurality of meanings if the value implies or corresponds to a plurality of (for example, two) values. A detailed description therefor is made below.

As illustrated in FIG. 23, for example, when the BS repeatedly transmits the PDCCH twice (for example, m=2), the BS may repeatedly transmit the PDCCH on the basis of the same or different beams in an aspect of a spatial domain by mapping one PDCCH to each of a TRP A and a TRP B. At this time, PDCCH repetitive transmission may be performed on the basis of CORESETs connected to two search spaces explicitly that are connected through higher-layer signaling. When IDs of the CORESETs connected to the search spaces are the same or TCI states of the CORESETs are the same, PDCCH repetitive transmission may be performed on the basis of a single TRP. When all IDs of the CORESETs connected to the search spaces are different or all TCI states of the CORESETs are different, PDCCH repetitive transmission may be performed on the basis of multiple TRPs.

When the BS repeatedly transmits the PDCCH four times, the BS may map two PDCCHs to each of the TRP A and the TRP B, in which case the two PDCCHs of each TRP may be transmitted to be divided in the time domain. PDCCH repetitive transmission divided in the time domain can be repeated in units of time based on a slot, s subslot, or a mini-slot.

The above-described method is only an example and the disclosure is not limited thereto. In the disclosure, the UE and the BS may consider the following methods for the PDCCH repetition operation.
PDCCH repetition in an aspect of time/frequency/spatial domain within the same slot within the same CORESET.
PDCCH repetition in an aspect of time/frequency/spatial domain between different slots within the same CORESET.
PDCCH repetition in an aspect of time/frequency/spatial within the same slot between different CORESETs.
PDCCH repetition in an aspect of time/frequency/spatial domain between different slots between different CORESETs.

Further, when CORESETPoolindex is configured, CORESETPoolindex may also be considered in addition to the CORESET. Further, the number of PDCCH repetitions may independently increase, and accordingly the methods may be combined and considered at the same time.

The BS may pre-configure information on a domain through which the PDCCH is repeatedly transmitted in the UE through an RRC message. For example, in the case of PDCCH repetitive transmission in the time domain, the BS may pre-configure information on the time slot corresponding to one of the slot, the subslot, or the mini-slot according to which the repetitive transmission is performed in the UE. In the case of PDCCH repetitive transmission in the frequency domain, the BS may pre-configure information on one of the CORESET, the bandwidth part (BWP), or component carrier (CC) according to which the repetitive transmission is performed in the UE. In the case of PDCCH repetitive transmission in the spatial domain, the BS may pre-configure information related to a beam for PDCCH repetitive transmission through a configuration for each QCL type in the UE. Alternatively, the BS may combine the listed information and transmit the same to the UE through the RRC message. Accordingly, the BS may repeatedly transmit the PDCCH according to pre-configured information through the RRC message, and the UE may repeatedly receive the PDCCH according to the pre-configured information through the RRC message.

Method 1-2, a Method of Repeatedly Transmitting a Plurality of Pieces of Control Information Having Different DCI Formats and/or Payloads

Method 1-2 is a method of repeatedly transmitting a plurality of pieces of control information having different DCI formats and/or payloads. The control information schedules repetitive transmission PDSCHs, and the number of PDSCH repetitive transmissions indicated by each pieces of the control information may be different. For example, while PDCCH #1 may indicate information scheduling {PDSCH #1, PDSCH #2, PDSCH #Y}, PDCCH #2 may indicate information scheduling {PDSCH #2, PDSCH #Y}, . . . , and PDCCH #X may indicate information scheduling {PDSCH Y}. The method of repeatedly transmitting the control information has an advantage of reducing a total of delay time required for control information and PDSCH repetitive transmission compared to method 1-1. On the other hand, in the method, since payloads of repeatedly transmitted control information may be different from each other, soft combining of the repeatedly transmitted control information is impossible, and thus reliability may be lower than that of method 1-1.

In method 1-2, the UE may not need to know in advance the location of resources of control information to be repeatedly transmitted and the number of repetitive transmissions, and may independently decode and process each piece of the repeatedly transmitted control information. When the UE decodes a plurality of pieces of repeatedly transmitted control information scheduling the same PDSCH, only the first repeatedly transmitted control information may be processed and the other repeatedly transmitted control information from the second control information may be ignored. Alternatively, the BS may indicate in advance the location of resources of control information to be repeatedly transmitted and the number of repetitive transmissions, and an indication method may be the same as the method described in method 1-1.

Method 1-3, a Method of Repeatedly Transmitting Each Piece of Plurality of Control Information Having Different DCI Formats and/or Payloads

Method 1-3 is a method of repeatedly transmitting each piece of a plurality of control information having different DCI formats and/or payloads. At this time, each piece of repeatedly transmitted control information may have the same DCI format and payload. Since the plurality of pieces of control information in method 1-2 may not be soft-combined, it may have lower reliability than method 1-1, and method 1-1 may have a longer total delay time required for control information and PDSCH repetitive transmission. Method 1-3 is a method that makes use of the advantages of method 1-1 and method 1-2, and may transmit control information with higher reliability compared to method 1-2 while reducing the total delay time required for control information and PDSCH repetitive transmission compared to method 1-1.

In order to decode and soft-combine repeatedly transmitted control information, method 1-3 may use soft combining of method 1-1 and individual decoding of method 1-2. For example, in repetitive transmission of a plurality of pieces of control information having different DCI formats and/or payload, the first transmitted control information may be decoded through method 1-2 and repetitive transmission of the decoded control information may be soft-combined through method 1-1.

Meanwhile, the BS may select and configure one of method 1-1, method 1-2, or method 1-3 for repetitive transmission of control information. The method of repeatedly transmitting control information may be explicitly indicated to the UE by the BS through higher-layer signaling. Alternatively, the method of repeatedly transmitting control information may be indicated after a combination with other configuration information. For example, a higher-layer configuration indicating the PDSCH repetitive transmission scheme may be combined with an indication of control information repetitive transmission. When repetitive transmission of the PDSCH in a frequency division multiplexing (FDM) scheme is indicated, control information may be repeatedly transmitted only through method 1-1, and the reason thereof is that there is no effect of reduction in the delay time for PDSCH repetitive transmission in the FDM scheme by method 1-2. For a similar reason, when repetitive transmission of the PDSCH in an intra-slot time division multiplexing (TDM) scheme is indicated, control information may be repeatedly transmitted through method 1-1. On the other hand, when repetitive transmission of the PDSCH in an inter-slot TDM scheme is indicated, method 1-1, method 1-2, or method 1-3 for control information repetitive transmission may be selected through higher-layer signaling or L1 signaling.

Meanwhile, the BS may explicitly indicate the unit of control information repetitive transmission to the UE through a configuration such as higher layer. Alternatively, the unit of control information repetitive transmission may be combined with other configuration information and indicated. For example, the higher-layer configuration indicating the PDSCH repetitive transmission scheme may be combined with the unit of control information repetitive transmission. When repetitive transmission of the PDSCH in the FDM scheme is indicated, control information may be repeatedly transmitted in the FDM or spatial domain multiplexing (SDM) scheme, and the reason thereof is that, if control information is repeatedly transmitted in the inter-slot TDM scheme, there is no effect of reduction in the delay time by the PDSCH repetitive transmission in the FDM scheme. For a similar reason, when repetitive transmission of the PDSCH in the intra-slot TDM scheme is indicated, control information may be repeatedly transmitted in the TDM, FDM or SDM scheme. On the other hand, when repetitive transmission of the PDSCH in the inter-slot TDM scheme is indicated, higher-layer signaling may be selected for repetitive transmission of control information in the inter-slot TDM scheme or the intra-slot TDM, FDM, or SDM scheme.

Method 1-4, a Method of a PDCCH Transmission Scheme Applying Respective TCI States to Different CCEs within the Same PDCCH Candidates

In order to improve reception performance of the PDCCH without PDCCH repetitive transmission, method 1-4 may perform transmission after applying different TCI states, meaning transmission from multiple TRPs to different CCEs within PDCCH candidates. The corresponding scheme is not PDCCH repetitive transmission, but is transmission after the application of different TCI states to different CCEs within PDCCH candidates by respective TRPs, and thus may be a scheme of acquiring spatial diversity within the PDCCH candidates. Different CCEs to which different TCI states are applied may be separated in a time or frequency dimension, and the UE needs to know in advance the location of resources to which different TCI states are applied. The UE may receive different CCEs to which different TCI states are applied within the same PDCCH candidates, and independently decode the CCEs or simultaneously decode the CCEs.

Method 1-5, a Method of a PDCCH Transmission Scheme Applying a Plurality of TCI States to all CCEs within Same the PDCCH Candidates (e.g., an SFN Scheme)

In order to improve PDCCH reception performance without PDCCH repetitive transmission, method 1-5 may perform transmission in an SFN scheme after the application of a plurality of TCI states to all CCEs within the PDCCH candidates. The corresponding scheme is not PDCCH repetitive transmission but may be scheme of acquiring spatial diversity through SFN transmission at the same CCE location within a PDCCH candidate group. The UE may receive CCEs at the same location to which different TCI states are applied within the same PDCCH candidate group, and independently decode the CCEs by using some or all of the plurality of TCI states or simultaneously decode the CCEs.

### Second Embodiment: A Soft Combining-Related UE Capability Report for PDCCH Repetition Transmission

A UE may report, to a BS, a soft combining-related UE capability for PDCCH repetition transmission, and several methods relating thereto may exist. A UE capability reporting method will now be described.

UE capability report method 1, a UE may report, to a BS, only on whether soft combining is possible during PDCCH repetition transmission in the form of possibility or impossibility via a UE capability.

For example, if the UE has reported information that soft combining is possible during PDCCH repetition transmission to the BS via the UE capability, the BS may determine whether soft combining of the UE is possible as the most flexible degree (for example, determine that the UE can perform soft combining at a log likelihood ratio (LLR) level), and notify the UE of PDCCH repetition transmission-related configuration as flexibly as possible at the time of PDCCH transmission-related configuration. As an example related to PDCCH repetition configuration, the BS may assume that the UE can perform soft combining between control resource sets or search spaces having different configurations, soft combining between PDCCH candidates in the same aggregation level, or soft combining between PDCCH candidates between different aggregation levels, and notify the UE of the corresponding configuration.

For another example, if the UE has reported information that soft combining is possible during PDCCH repetition transmission to the BS via the UE capability, the BS may most conservatively determine a level at which the UE can perform soft combining (for example, determine that the UE can perform soft combining at an OFDM symbol level), and most restrictively notify the UE of PDCCH repetition transmission-related configuration at the time of PDCCH transmission-related configuration. As an example related to PDCCH repetition configuration, the BS may assume that the UE can perform soft combining between multiple control resource sets having the same configuration or soft combining between PDCCH candidates having the same aggregation level, and notify the UE of the corresponding configuration.

UE capability report method 2, in order to express an operation of soft combining which can be performed in a UE as a UE capability in more detail compared to the UE capability report method 1 described above, the UE may report, as a UE capability, levels divided with respect to the degree of possibility of soft combining during PDCCH repetition transmission to a BS. That is, among the respective signal levels generated from reception operation processes of the UE, the UE may identify a signal level at which soft combining can be applied with respect to PDCCH repetition transmission, and the UE may report such information to the BS as the UE capability. For example, the UE may inform that soft combining is possible at an OFDM symbol level, as a signal level at which soft combining can be applied, may inform that soft combining is possible at a modulation symbol level, and may inform that soft combining is possible at an LLR level. According to each signal level reported by the UE, the BS may notify the UE of an appropriate configuration such that the UE can perform soft combining, according to the reported UE capability.

UE capability report method 3, a UE may transmit, via a UE capability, restrictions necessary for allowing soft combining to be possible at the UE side during PDCCH repetition transmission to a BS. For example, the UE may report, to the BS, that configurations of respective control resource sets including two repeated PDCCHs are required to be the same. In addition, the UE may report, to the BS, that two repeated PDCCH candidates are required to at least have the same aggregation level.

UE capability report method 4, when a UE receives PDCCH repetition transmission from a BS, the UE may report supported a PDCCH repetition transmission scheme, via a UE capability. For example, the UE may report information about supporting the method 1-5 (an SFN transmission scheme) to the BS. For another example, the UE may report, to the BS, information about supporting an intra-slot TDM, inter-slot TDM, or FDM scheme of the method 1-1 (a method for repeatedly transmitting a plurality of PDCCHs having the same payload). In particular, in the case of TDM, the UE may report the maximum value (or, minimum value) of a time interval between two repeated PDCCHs to the BS. For example, if the UE has reported the maximum value of the time interval between the two repeated PDCCHs as 4 OFDM symbols, in the case of performing TDM-based PDCCH repetition transmission to the UE, based on the corresponding information, the BS may be required to adjust the time interval between the two repeated PDCCHs to 4 OFDM symbols or less.

UE capability report method 5, when receiving PDCCH repetitive transmission from the BW, the UE may report the number of blind decodings to the BS through a UE capability. For example, the UE may report the number of blind decodings consumed during reception of the PDCCH repetitive transmission to the BS as 1, 2, or 3 regardless of a UE reception method (for example, individual decoding, soft combining, other reception methods, or a combination thereof). When the UE receives PDCCH repetitive transmission, the BS may assume that the UE consumes the number of reported blind decodings and transmit a configuration for searches and control resource sets that do not exceed the number of blind decodings which can be maximally used by the UE within the slot or span to the UE.

The above-described UE capability report methods can be configured in combinations of two or more in actual application. For example, the UE may report that soft combining is possible at an LLR level by the UE capability report method 2 and report that two repeated PDCCH candidates are required to have the same aggregation level by the UE capability report method 3, and support PDCCH repetition transmission TDMed by the UE capability report method 4, but report the maximum value of a time interval between two repeated PDCCHs as 4 OFDM symbols. In addition, applications based on various combinations of the UE capability reporting methods are possible, but a detailed description thereof is omitted.

### Third Embodiment: A Method of Configuring an Explicit Linkage and PDCCH Repetitive Transmission

As an embodiment of the disclosure, a method for configuring repetitive PDCCH transmission for enabling soft combining during PDCCH repetitive transmission will be described. When a BS performs PDCCH repetition transmission to a UE, based on the method 1-1 (a method for repeatedly transmitting a plurality of PDCCHs having the same payload) among various PDCCH repetition transmission methods described above, the BS may configure and indicate, to the UE, information indicating that an explicit connection (linkage or association) is established between repeated PDCCH candidates, so as to reduce the number of blind decodings based on whether soft combining of the UE is possible. The information indicating that an explicit connection (linkage or association) is established between repeated PDCCH candidates may be configured via higher layer signaling, indicated via L1 signaling, or configured and indicated via a combination of higher layer signaling and L1 signaling. In more detail, various linkage methods may exist as follows.

There may be various methods for configuring PDCCH repetitive transmission and explicit linkage via higher layer signaling as follows.

PDCCH repetition configuration method 1, when configuration information exists in higher layer signaling PDCCH-config

A BS may transmit, to a UE, configuration information (e.g., a PDCCH-repetition-config) in a PDCCH-config, which is higher layer signaling (e.g., an RRC), in order to configure PDCCH repetition transmission and explicit linkage-related configuration. For example, the configuration information (e.g., a PDCCH-repetition-config) in PDCCH-config may include the following information:
a PDCCH repetition transmission scheme—one of TDM, FDM, and SFN;
control resource set-search space combination(s) to be used during PDCCH repetition transmission;
   optionally, control resource set index(es);
   optionally, search space index(es);
optionally, aggregation level(s) for explicit linkage;
optionally, PDCCH candidate index(es) for explicit linkage; and
optionally, a frequency resource for explicit linkage.

Based on the above information, the BS may configure PDCCH repetition transmission to the UE via higher layer signaling.

For example, if a PDCCH repetition transmission scheme is configured as an SFN, a control resource set index is configured to be 1 and a search space index is not configured as a control resource set-search space combination to be used during PDCCH repetition transmission, the UE may expect that a PDCCH is to be repeatedly transmitted via the method 1-5 (a SFN transmission scheme) in a control resource set having index 1. In this case, in the configured control resource set, one or more of a plurality of different TCI states may be configured via higher layer signaling, indicated via L1 signaling or MAC-CE signaling, or configured and indicated via a combination of higher layer signaling and L1 signaling or MAC-CE signaling. In addition, if the PDCCH repetition transmission scheme is configured as the SFN, the UE may not expect that a search space index is configured in the control resource set-search space combination to be used during PDCCH repetition transmission.

For another example, the PDCCH repetition transmission scheme may be configured as a TDM or FDM scheme, and a total of two control resource set-search space combinations to be used during PDCCH repetition transmission may be configured. For example, control resource set index 1 and search space index 1 may be configured for the first combination, and control resource set index 2 and search space index 2 may be configured for the second combination. In this case, the UE may expect that a PDCCH is to be repeatedly transmitted in a TDM or FDM scheme via the method 1-1 by using two control resource set-search space combinations. In this case, in each of configured control resource sets, a plurality of TCI states which are the same or different from each other may be configured via higher layer signaling, indicated via L1 signaling or MAC-CE signaling, or configured and indicated via a combination of higher layer signaling and L1 signaling or MAC-CE signaling. In addition, if the PDCCH repetition transmission scheme is configured as TDM or FDM, the UE may expect that up to two control resource set-search space combinations to be used during PDCCH repetition transmission are configured, and expect that both a control resource set index and a search space index are configured in each combination.

Additionally, a value of at least one of the five pieces of information may be updated based on MAC-CE without RRC reconfiguration. If the BS does not configure the PDCCH-repetition-config for the UE, the UE does not expect the PDCCH to be repeatedly transmitted, and only a single PDCCH transmission can be expected. All of the above-described aggregation level, PDCCH candidate index, and frequency resources for explicit linkage may not be configured, or at least one may be configured according to an explicit linkage method to be described later.

PDCCH repetition configuration method 2, when configuration information exists in higher layer signaling (e.g., RRC) for a search space

A BS may add a higher layer signaling parameter in a searchSpace information element (IE), which is higher layer signaling for a search space, to configure PDCCH repetition transmission, and notify a UE of the same. For example, a parameter referred to as repetition, which is additional higher layer signaling, may be included in the searchSpace IE, which is higher layer signaling, and the repetition parameter may be configured to be on or off, and thus whether the corresponding search space is used for PDCCH repetition transmission may be configured. For example, a search space in which repetition is configured to be on may be one or two. For example, if, in the searchSpace IE, which is higher layer signaling for search space index 1, searchSpaceId is configured to be 1, controlResourceSetId is configured to be 1, and repetition is configured to be on, the UE may expect that PDCCH repetition transmission is performed according to the method 1-5 (an SFN transmission method) in control resource set 1 linked to search space 1.

As another example, if in searchSpace IE, which is higher layer signaling for search space index 1, searchSpaceId is configured to be 1, controlResourceSetId is configured to be 1, and repetition is configured to be on, and in searchSpace IE, which is higher layer signaling for search space index 2, searchSpaceId is configured to be 2, controlResourceSetId is configured to be 2, and repetition is configured to be on, the UE may identify that PDCCH repetition transmission is performed by TDM or FDM by using the method 1-1 between a combination of control resource set 1 and search space 1, and a combination of control resource set 2 and search space 2. TDM and FDM may be divided according to time and frequency configurations via higher layer signaling of control resource sets 1 and 2 and search spaces 1 and 2. In addition, in higher layer signaling for the search space in which repetition is configured to be on, an aggregation level or PDCCH candidate indexes for explicit linkage specified in the PDCCH repetition configuration method 1 may be configured, both of the aggregation level and PDCCH candidate indexes may not be configured, only one of them may be configured, or both of them may be configured according to an explicit linkage method to be described later.

### Embodiment 4: Multi-TRP-Based PDSCH SFN Transmission Method

As an embodiment of the disclosure, an indication and configuration method of the BS through a combination of L1 signaling and higher-layer signaling for multi-TRP-based PDSCH SFN transmission and a reception method of the UE are described. When the BS schedules a multi-TRP-based PDSCH SFN transmission method in the UE through DCI, DCI field conditions and higher-layer signaling conditions may be described below.
TCI state field within DCI: indicates a codepoint of a TCI state field including two TCI states.
Antenna port field within DCI: the number of CDM groups may be fixed to 1 or may be larger than or equal to 1.
Time domain resource allocation field within DCI: there may be no restriction on the corresponding field (for example, one of conditions 1, 2, or 3 for the time domain resource allocation field in Table 31 may be possible). Alternatively, only condition 3 (for example, the case in which all TDRA entries do not receive a configuration of higher-layer signaling repetitionNumber) in Table 31 may be possible
Higher-layer signaling repetitionScheme: may be configured or may not be configured.
New higher-layer signaling for the multi-TRP-based PDSCH SFN scheme may be additionally configured. Meanwhile, in order to support the multi-TRP-based PDSCH SFN scheme (for example, multi-TRP SDM, FDM scheme A, FDM scheme B, TDM scheme A, or TDM scheme B), the UE may expect that no new higher-layer signaling for the multi-TRP-based PDSCH SFN scheme is configured.

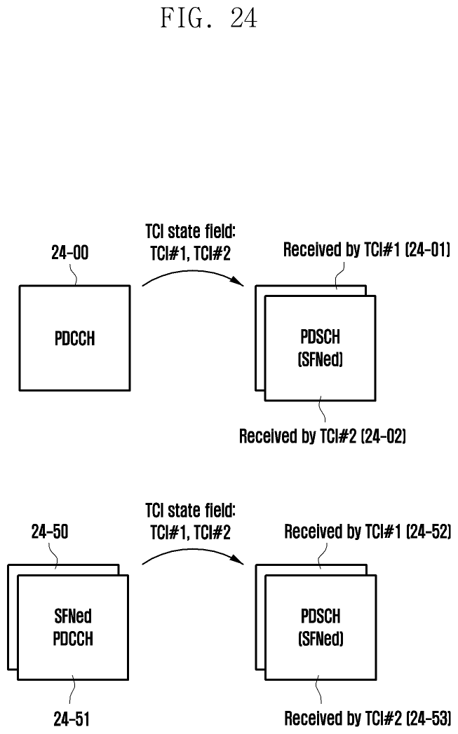

FIG. 24 illustrates an example of a multi-TRP-based PDSCH SFN transmission method according to an embodiment of the disclosure.

After indicating and configuring values of the DCI fields and higher-layer signaling to the UE, the BS may transmit a PDCCH to the UE in operation 24-00. Two TCI states (e.g., TCI states #1 and #2) are indicated through the TCI state field within the corresponding PDCCH, and time and frequency resource allocation information may be indicated through one time domain resource allocation field and one frequency domain resource allocation field, respectively. The UE may receive SFN-transmitted PDSCHs through different TCI states (e.g., TCI state #1 and #2) at resource locations based on the corresponding time and frequency resource allocation information in operations 24-01 and 24-02.

This may be equally applied to SFN-based PCCH repetitive transmission. The UE may apply two different TCI states within one control resource set and receive the SFN-transmitted PDCCHs in operations 24-50 and 24-51. The UE may receive SFN-transmitted PDSCHs through two different TCI states (e.g., TCI state #1 and #2) at resource locations based on the corresponding time and frequency resource allocation information on the basis of information of DCI fields included in the corresponding SFN-transmitted PDCCHs in operations 24-52 and 24-53.

### Embodiment 4-1: Multi-TRP-Based SFN PDCCH and SFN PDSCH Transmission Method Signaling or Restrictions

As an embodiment of the disclosure, an indication and configuration method of the BS through a combination of L1 signaling and higher-layer signaling for multi-TRP-based SFN PDCCH and SFN PDSCH transmission method or restrictions are described.

The UE may receive, from the BS, a configuration of one SFN transmission scheme of the BS among an SFN transmission scheme of the BS (hereinafter, referred to as a BS-based SFN scheme) through BS-based Doppler correction through higher-layer signaling or an SFN transmission scheme of the BS (hereinafter, referred to as a UE-based SFN scheme) through UE-based Doppler correction. The corresponding configuration may be performed for each bandwidth part or each carrier. Further, the corresponding configuration may use configuration information for each of the PDCCH and the PDSCH and use one piece of common configuration information for the PDCCH and the PDSCH. With respect to types of the SFN transmission schemes of the BS, the UE may not expect that different schemes are applied to the PDCCH and the PDSCH. That is, the UE may expect that the same SFN transmission scheme is applied to the PDCCH and the PDSCH when the SFN transmission scheme of the BS is applied to transmission of the PDCCH and the PDSCH from the BS. Further, the UE may expect that the same SFN transmission scheme is configured and applied to all control resource sets when the SFN transmission scheme of the BS is applied to transmission of the PDCCH from the BS. That is, the UE may not expect that the BS-based SFN scheme is configured and applied to some control resource sets and the UE-based SFN scheme is configured and applied to the remaining control resource sets.

The UE may transmit information indicating whether the reception operation for single-TRP-based PDSCH single transmission of the BS or SFN PDSCH transmission can be dynamically changed to the BS through a UE capability report. The corresponding UE capability report can be performed for each carrier or each UE. The BS may transmit the enhanced PDSCH TCI state activation/deactivation MAC-CE to a UE which has not reported the corresponding UE capability such that all codepoints of the TCI field within DCI indicate two TCI states. That is, when the UE does not report the corresponding UE capability, the UE may not expect that at least one codepoint of the TCI field within DCI indicate one TCI state. For the UE having reported the corresponding UE capability, the BS may configure whether the reception operation for single-TRP-based PDSCH single transmission or multi-TRP-based PDSCH SFN transmission can be dynamically changed through higher-layer signaling and the UE may receive an indication of one or two TCI states through a TCI field within DCI according to whether corresponding higher-layer signaling is configured. Further, for the UE having reported or having not reported the corresponding UE capability, higher-layer signaling indicating whether the reception operation for single-TRP-based PDSCH single transmission or multi-TRP-based PDSCH SFN transmission can be dynamically changed may not exist, and the BS may indicate one or two TCI states through a TCI field within DCI by using a TCI state activation MAC-CE for a PDSCH for the UE having reported the corresponding UE capability and indicate such that all TCI codepoints have one TCI state or all TCI codepoints have two TCI states through a TCI field within DCI by using a TCI state activation MAC-CE for a PDSCH for the UE having not reported the corresponding UE capability.

The UE may transmit information indicating whether the reception operation for single-TRP-based PDCCH single transmission of the BS or SFN PDCCH transmission can be dynamically changed to the BS through the UE capability report. The corresponding UE capability report can be performed for each carrier or each UE. The BS may configure higher-layer signaling indicating whether a control resource set in which one TCI state is activated and a control resource set in which two TCI states are activated coexist in the UE which has not reported the corresponding UE capability. The corresponding higher-layer signaling may be configured for each bandwidth part or each carrier. In the UE which has not reported the UE capability, the corresponding configuration information may not be configured or information indicating that the coexistence of control resource sets in which the different numbers of TCI states are activated is not possible may be configured by the BS. In the UE which has reported the UE capability, the corresponding configuration information may be configured such that the coexistence of control resource sets in which the different numbers of TCI states are activated is possible by the BS. Further, higher-layer signaling indicating whether control resource sets in which the different numbers of TCI states are activated coexist may not exist for the UE having reported the corresponding UE capability, and the BS may activate some control resource sets to have one TCI and the remaining control resource sets to have two TCI states through a TCI state activation MAC-CE for a PDCCH so that the control resources sets in which the different numbers of TCI states are activated can coexist for the UE having reported the corresponding UE capability and may activate all control resource sets to have one TCI state or all control resource sets to have two TCI states through a TCI state activation MAC-CE for a PDCCH so that control resource sets in which the different numbers of TCI states are activated do not coexist for the UE having not reported the corresponding UE capability. At this time, all control resource sets may be all control resource sets within the carrier according to a UE capability report unit (for each carrier or each UE) or all control resource sets of all carriers configured in the UE.

For the two UE capabilities of the UE (the UE capability about whether the reception operation for single-TRP-based PDSCH signal-transmission or SFN PDSCH transmission can be dynamically changed and the UE capability about whether the reception operation for single-TRP-based PDCCH single transmission or SFN PDCCH transmission can be dynamically changed), the UE may insert two pieces of information into one UE capability report and transmit the UE capability. Further, the two UE capabilities may be defined as independent UE capabilities. In addition, through the report on the UE capability for the PDSCH (the UE capability about whether the reception operation for single-TRP-based PDSCH single transmission or SFN PDSCH transmission can be dynamically changed), the UE capability information for the PDCCH (whether the reception operation for single-TRP-based PDCCH single transmission or SFN PDCCH transmission can be dynamically changed) can also be reported.

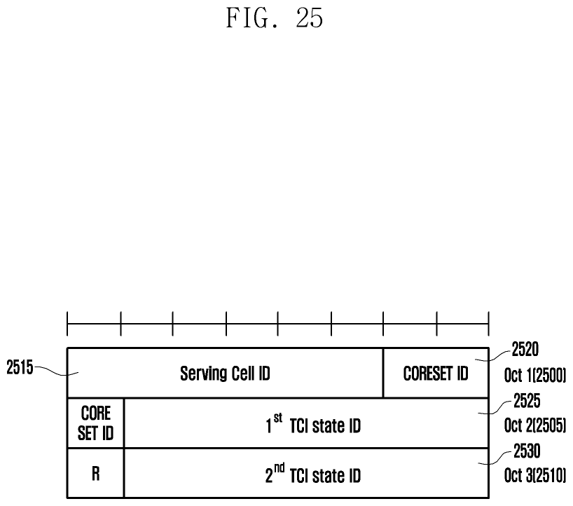

FIG. 25 illustrates an enhanced PDCCH TCI activation/deactivation MAC-CE format according to an embodiment of the disclosure.

Referring to FIG. 25, it illustrates the format of FIG. 9 to which a third octet 2510 is added, and it may be noted that a second TCI state ID may be additionally indicated to activate a first TCI state ID 2525 in a second octet 2505 and the second TCI state ID 2530 indicated by the corresponding MAC-CE for an indicated serving cell ID 2515 and a control resource set index 2520 in a first octet 2500. When the serving cell ID indicated by the corresponding enhanced PDCCH TCI state activation/deactivation MAC-CE is included in higher-layer signaling simultaneousTCI-UpdateList1-r16 or simultaneousTCI-UpdateList2-r16, the first TCI state ID and the second TCI state ID indicated by the corresponding MAC-CE may be simultaneously applied to a control resource set index indicated by the corresponding MAC-CE for another serving cell ID included in simultaneousTCI-UpdateList1-r16 or simultaneousTCI-UpdateList2-r16. For example, when the serving cell ID included in simultaneousTCI-UpdateList1-r16 is 1 to 4, and the serving cell ID indicated through the corresponding MAC-CE, the control resource set index, the first TCI state ID, and the second TCI state ID are 2, 1, 0, and 1, respectively, TCI state IDs 0 and 1 may be simultaneously activated for control resource set 1 existing in serving cells 1, 3, and 4 through the corresponding MAC-CE.

### Embodiment 5: RLM RS Selection Method Considering Multi-TRP-Based SFN PDCCH Transmission

As an embodiment of the disclosure, a method of selecting an RLM RS by the UE is described in detail when no RadioLinkMonitoringRS is configured and when a plurality of (two or more) TCI states are activated for all control resource sets according to a UE capability report or whether higher-layer signaling is configured or not. Methods described below can be applied to the case in which Lₘₐₓ is 4, 8, or 64 according to Table 33 above, and may be additionally applied to values of Lₘₐₓ or N_{RLM} which have not been mentioned in Table 33.

Method 5-1, Only TCI States Having the Specific Order are Used for all Control Resource Sets

When the UE receives a PDCCH TCI state activation MAC-CE from the BS and thus two TCI states are activated for all control resource sets, the UE may perform RLM RS selection by using the TCI states having the specific order. For example, the UE may perform RLM RS selection by using reference RSs of first TCI states for all control resource sets. In another example, the UE may perform RLM RS selection by using reference RSs of second TCI states for all control resource sets. In another example, the UE may receive configuration information for each control resource set indicating which TCI state can be used for selecting the RLM RS through higher-layer signaling for each control resource set, and accordingly, may perform RLM RS selection by using a reference RS for one TCI state for each control resource set but perform RLM RS selection by using TCI states having different specific orders for respective control resource sets.

When the RLM RS is selected using only the TCI states having the specific order for all control resource sets, if the TCI states having the specific order are determined for each control resource set, the RLM RS may be selected on the basis of RLM RS selection methods 1 to 4 used for the existing RLM RS selection.

Method 5-2, RLM RSs are Selected on the Basis of First States for all Control Resource Sets and then the Selection is Repeated for the Next TCI States for all Control Resource Sets

When the UE receives a MAC-CE from the BS and two TCI states are activated for all control resource sets, the UE may first select RLM RSs from among reference RSs of first TCI states of all control resource sets to perform RLM RS selection. When N_{RLM} RLM RSs have been already selected, the UE may end the RLM RS selection process. When the UE performs RLM RS selection on the basis of the first TCI states of all control resource sets and the number of RLM RSs smaller than N_{RLM} are selected, the UE may perform RLM RS selection until the number of RLM RSs reach N_{RLM} on the basis of second TCI states of all control resource sets. According to RLM RS selection method 4, when a control resource set connected to a search space having the shortest period has the highest priority, the number of search spaces having the shortest period is plural, and the number of control resource sets connected to the corresponding search spaces is plural, the selection may be performed from a TCI state having the lowest index for all control resource sets when all control resource sets have two activated TCI states in addition to the rule indicating that a higher control resource set index has a higher priority. In contrast, the selection may be performed from a TCI state having a higher index, and whether to preferentially select a TCI state having a specific order for each control resource set may be configured through higher-layer signaling.

Method 5-3, RLM RSs are Selected for all TCI States for Each Control Resource Set and then the Selection is Repeated for the Next Control Resource Set

When the UE receives a MAC-CE from the BS and all control resource sets have two activated TCI states, if a control resource set is selected when the UE may use a method of performing RLM RS, the UE may perform RLM RS selection for all TCI states of the corresponding control resource set and then applying the same to the next priority control resource set. According to RLM RS selection method 4, when a control resource set connected to a search space having the shortest period has the highest priority, the number of search spaces having the shortest period is plural, and the number of control resource sets connected to the corresponding search spaces, a control resource set may be first selected according to the rule indicating that a highest control resource set index has a high priority and RLM RS selection may be performed on the basis of a reference RS of a first TCI state within the corresponding control resource set, and when the number of RLM RSs smaller than N_{RLM} are selected, RLM RS selection may be performed on the basis of a reference RS of a second TCI state of the corresponding control resource set. At this time, when the number of RLM RSs smaller than N_{RLM} are still selected, RLM RS selection may be sequentially performed on the basis of reference RSs of first and second TCI states of the next priority control resource set.

Method 5-4, Combined TCI State or QCL Assumption is Used

When the UE receives a MAC-CE from the BS and two TCI states are activated for each of all control resource sets, the UE may perform RLM RS selection by using combined TCI state or QCL assumption. The TCI state combination may refer to combination of QCL-Type A, B, or C, and QCL-TypeD included in two TCI states.

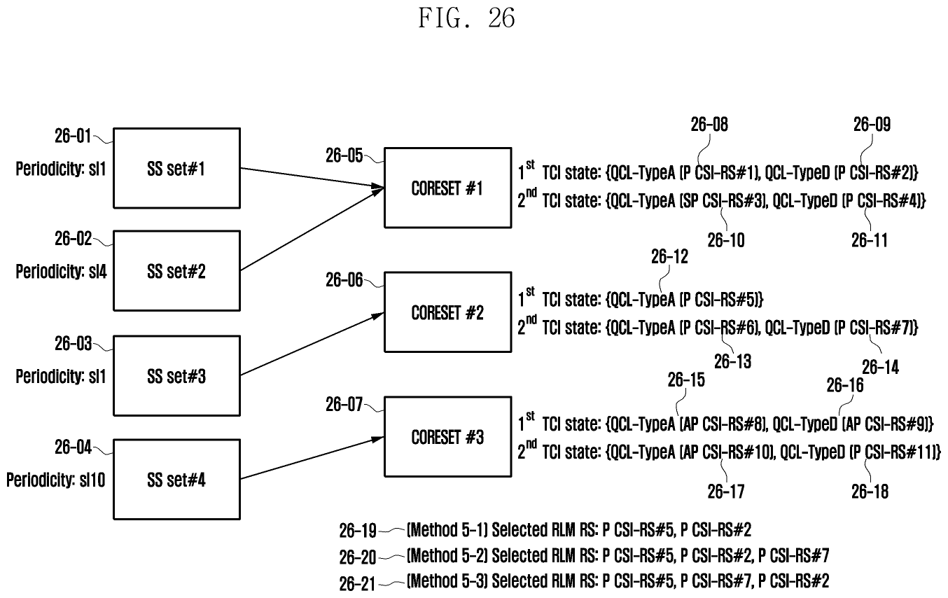

FIG. 26 illustrates another RLM RS selection process according to an embodiment of the disclosure.

Referring to FIG. 26, first and second TCI states of control resource set #1 26-05 may have P CSI-RS #1 26-08 and SP CSI-RS #3 26-10 as reference RSs of QCL-TypeA and has P CSI-RS #2 26-09 and P CSI-RS #4 26-11 as reference RSs of QCL-TypeD. At this time, combining two reference RSs of QCL-Type A may refer to a method of generating a new channel parameter by combining channel parameters (for example, Doppler frequency, Doppler spread, average delay, and delay spread) which can be obtained from the respective reference RSs through a series of operations (for example, sum, difference, arithmetic mean, geometric mean, maximum value, and minimum value of two channel parameters, and the like). When the UE mentions the reference RS made through the combination of two TCI states, the reference RS may indicate a pair of existing reference RSs (for example, {P CSI-RS #1 and SP CSI-RS #3}) or a selected reference RS (for example, P CSI-RS #20) of a TCI state having a channel parameter which is most similar to a new channel parameter made through the combination of TCI states among already configured TCI states.

The UE may combine TCI states for RLM RS selection. The UE may combine reference RSs of two of QCL-TypeA, B, or C configured in the control resource set or included in two activated TCIs and combine reference RSs of two QCL-TypeD. When combining TCI states, the UE may expect only combination between the same QCL-Type. When combining TCI states, the UE may expect only combination between reference RSs having the same time domain behavior. For a UE expecting only combination between the same QCL-Type or only combination between the same time domain behavior, when TCI state combination is not possible for two TCI states configured in the control resource set or activated (for example, reference RSs of different QCL-Types or different time domain behaviors), no TCI state combination may be performed and RLM selection may be performed as each reference RS.

The UE may first perform combination of two TCI states configured in the control resource set of activated like in the above-described method. When combination of two TCI states of all control resource sets is possible, the UE may select RLM RSs according to RLM RS selection methods 1 to 4 by using the combined TCI states. When combination of some TCI states is not possible, the UE may select RLM RSs by preferentially using combined TCI states for control resource sets and, if N_{RLM} RLM RSs have not been selected during the corresponding selection process, may continuously perform RLM RS selection by applying methods 5-1 to 5-3 using the remaining TCI states.

Referring to FIG. 26, control resource set #1 to control resource set #3 26-05 to 26-07 connected to search space #1 to search space #4 26-01 to 26-04 having different periods within an activated downlink bandwidth part and reference RSs of two TCI states configured in each control resource set are illustrated. In FIG. 26, it may be assumed that N_{RLM}=3. According to RLM RS selection method 4, the RLM RS selection uses a TCI state configured in a control resource set connected to a search space having the shortest period. In this case, search space #1 26-01 and search space #3 26-03 have the same period, and thus a reference RS of a TCI state configured in control resource set #2 having the highest index among control resource set #1 26-05 and control resource set #2 26-06 connected to the respective search spaces may be used as the highest priority in RLM RS selection. Accordingly, priorities of control resource sets may become lower in the order of control resource set #2 26-06, control resource set #1 26-05, and control resource set #3 26-07 in consideration of periods of connected search spaces and control resource set indexes.

At this time, when RLM RS selection is performed according to method 5-1, the UE may select RLM RSs by using only first TCI states of control resource set #2 26-06, control resource set #1 26-05 and control resource set #3 26-07. The first TCI state of control resource set #1 26-05 may have P CSI-RS #1 26-08 as a reference RS of QCL-TypeA and P CSI-RS #2 26-09 as a reference RS of QCL-TypeD. The first TCI state of control resource set #2 26-06 may have P CSI-RS #5 26-12 as a reference RS of QCL-TypeA. The first TCI state of control resource set #3 26-07 may have AP CSI-RS #8 26-15 as a reference RS of QCL-TypeA and AP CSI-RS #9 26-16 as a reference RS of QCL-TypeD. Since the reference RS of the first TCI state of control resource set #2 is a periodic RS as indicated by reference numeral 26-12, the reference RS may be selected as the RLM RS according to RLM RS selection method 3. Further, since the reference RS of the first TCI state of control resource set #1 has both QCL-TypeA and D, the reference RS of QCL-TypeD is prioritized according to RLM RS selection method 2 and is a periodic RS as indicated by reference numeral 26-09, and thus the reference RS may be selected as the RLM RS according to RLM RS selection method 3. The reference RS of the first TCI state of control resource set #3 is not a periodic RS, and thus cannot be selected as the RLM RS according to RLM RS selection method 3. Accordingly, the selected RLM RSs may be P CSI-RS #5 and P CSI-RS #2 according to method 5-1 as indicated by reference numeral 26-19.

Further, when RLM RS selection is performed according to method 5-2, the UE may perform RLM RS by preferentially using the first TCI state according to the order of control resource set #2 26-06, control resource set #1 26-05, and control resource set #3 26-07, and then perform RLM RS selection by using the second TCI state according to the same order of control resource sets. The first TCI state of control resource set #1 26-05 may have P CSI-RS #1 26-08 as a reference RS of QCL-TypeA and P CSI-RS #2 26-09 as a reference RS of QCL-TypeD. The first TCI state of control resource set #2 26-06 may have P CSI-RS #5 26-12 as a reference RS of QCL-TypeA. The first TCI state of control resource set #3 26-07 may have AP CSI-RS #8 26-15 as a reference RS of QCL-TypeA and AP CSI-RS #9 26-16 as a reference RS of QCL-TypeD. The second TCI state of control resource set #1 26-05 may have SP CSI-RS #3 26-10 as a reference RS of QCL-TypeA and P CSI-RS #4 26-11 as a reference RS of QCL-TypeD. The second TCI state of control resource set #2 26-06 may have P CSI-RS #6 26-13 as a reference RS of QCL-TypeA and P CSI-RS #7 26-14 as a reference RS of QCL-TypeD. The second TCI state of control resource set #3 26-07 may have AP CSI-RS #10 26-17 as a reference RS of QCL-TypeA and P CSI-RS #11 26-18 as a reference RS of QCL-TypeD. Since the reference RS of the first TCI state of control resource set #2 is a periodic RS as indicated by reference numeral 26-12, the reference RS may be selected as the RLM RS according to RLM RS selection method 3. Further, since the reference RS of the first TCI state of control resource set #1 has both QCL-TypeA and QCL-TypeD, the reference RS of QCL-TypeD is prioritized according to RLM RS selection method 2 and is a periodic RS as indicated by reference numeral 26-09, and thus the reference RS may be selected as the RLM RS according to RLM RS selection method 3. The reference RS of the first TCI state of control resource set #3 is not a periodic RS, and thus cannot be selected as the RLM RS according to RLM RS selection method 3. Thereafter, since the reference RS of the first TCI state of control resource set #2 has both CQL-TypeA and D, the reference RS of QCL-TypeD is prioritized according to RLM RS selection method 2 and is a periodic RS as indicated by reference numeral 26-18, and thus the reference RS may be selected as the RLM RS according to RLM RS selection method 3. Accordingly, the selected RLM RSs may be P CSI-RS #5, P CSI-RS #2, and P CSI-RS #7 according to method 5-2 as indicated by reference numeral 26-20.

Further, when RLM RS selection is performed according to method 5-3, the UE may perform RLM RS selection by first using the first TCI or second TCI state of control resource set #2 having the highest priority and then continuously perform RLM RS selection by using first and second TCI states for control resource set #1 and control resource set #3 having the next higher priority. Since the reference RS of the first TCI state of control resource set #2 is a periodic RS as indicated by reference numeral 26-12, the reference RS may be selected as the RLM RS according to RLM RS selection method 3. Further, since the reference RS of the second TCI state of control resource set #2 has both CQL-TypeA and D, the reference RS of QCL-TypeD is prioritized over the reference RS of QCL-TypeA 26-13 according to RLM RS selection method 2 and is a periodic RS as indicated by reference numeral 26-14, and thus the reference RS may be selected as the RLM RS according to RLM RS selection method 3. Further, since the reference RS of the first TCI state of control resource set #1 has both CQL-TypeA and D, the reference RS of QCL-TypeD is prioritized according to RLM RS selection method 2 and is a periodic RS as indicated by reference numeral 26-09, and thus the reference RS may be selected as the RLM RS according to RLM RS selection method 3. Accordingly, the selected RLM RSs may be P CSI-RS #5, P CSI-RS #7, and P CSI-RS #2 according to method 5-3 as indicated by reference numeral 26-21.

### Embodiment 6: RLM RS Selection Method in Single TRP-Based Single PDCCH Transmission or Multi-TRP-Based SFN PDCCH Transmission

As an embodiment of the disclosure, an RLM RS selection method of the UE is described in detail when no RadioLinkMonitoringRS is configured, some control resource sets have one TCI state and the remaining control resource sets have two TCI states within an activated downlink bandwidth part according to various conditions such as the UE capability report or whether higher-layer signaling is configured or not in Embodiment 4-1. Methods described below can be applied to the case in which Lₘₐₓ is 4, 8, or 64 according to Table 33 above, and may be additionally applied to values of Lₘₐₓ or N_{RLM} which have not been mentioned in Table 33.

Method 6-1, Only TCI States Having the Specific Order are Used for all Control Resource Sets

When the UE receives a PDCCH TCI state activation MAC-CE from the BS and thus some control resource sets have one TCI state and the remaining control resources sets have two TCI states, the UE may perform RLM RS selection by using TCI states of a specific order for all control resource sets. For example, RLM RS selection may be performed using one TCI state for control resource sets in which one TCI state is activated, and configuration information indicating the first or second TCI state or which TCI state can be used for RLM RS selection through higher-layer signaling for each control resource set may be received for each of the control resource sets in which two TCI states are activated. Accordingly, the UE perform RLM RS selection by using a reference RS for one TCI state for each control resource set, but may perform RLM RS selection by using TCI states having different specific orders for respective control resource sets. When the RLM RS is selected using only the TCI states having the specific order for all control resource sets in which the two TCI states are activated, if the TCI states having the specific order are determined for each control resource set, the RLM RS selection may be performed on the basis of RLM RS selection methods 1 to 4 used for the existing RLM RS selection.

Method 6-2, Only Control Resource Sets in which Two TCI States are Activated are Used

When the UE receives a PDCCH TCI state activation MAC-CE from the BS and thus some control resource sets have one TCI state and the remaining control resources sets have two TCI states, the UE may perform RLM RS selection by using only control resource sets in which two TCI states are activated without using control resource sets in which only one TCI state is activated. At this time, methods 5-1 to 5-4 may be used as detailed methods.

Method 6-3, Different Priorities are Applied to Control Resource Sets in which the Different Numbers of TCI States are Activated.

When the UE receives a PDCCH TCI state activation MAC-CE from the BS and thus some control resource sets have one TCI state and the remaining control resources sets have two TCI states, the UE may perform RLM RS selection ay applying different priorities to control resource sets in which the different numbers of TCI states are activated. When a set of control resources sets in which one TCI state is activated is CORESET set 1 and a set of control resource sets in which two TCI states are activated is CORESET set 2, the UE may perform RLM RS selection by preferentially using control resource sets existing in CORESET set 1, and if N_{RLM} RLM RSs have not been selected even though RLM RS selection is performed using CORESET set 1, may continuously perform RLM RS selection by using control resource sets existing CORESET set 2. Further, RLM RS selection may be performed using the opposite priority (CORESET set 2 is first used and then CORESET set 1 is used). The priority may be configured through higher-layer signaling. At this time, with respect to CORESET set 2, methods 5-1 to 5-4 may be used as detailed methods to be used for RLM RS selection.

### Embodiment 7: RLM RS Selection Method when Number of TCI States is Maintained Due to MAC-CE

As an embodiment of the disclosure, an RLM RS selection method is described in detail when no RadioLinkMonitoringRS is configured, some control resource sets have one TCI state and the remaining control resource sets have two TCI states within an activated downlink bandwidth part, all control resource sets should have the same number of TCI states, and the number of TCI states of control resource sets are maintained through a PDCCH TCI state activation/deactivation MAC-CE according to various conditions such as the UE capability report or whether higher-layer signaling is configured or not in Embodiment 4-1.

Method 7-1, Method of Varying Number of Total RLM RSs According to MAC-CE Activation

When the number of TCI states of control resource sets are maintained through a PDCCH TCI state activation/deactivation MAC-CE, the number of TCI state of a specific control resource set may be maintained from 1 to 2 or from 2 to 2, but information on activated TCI states may be changed.

At this time, when the number of TCI states of the control resource set is 1, a reference RS of the existing one TCI state is selected as the RLM RS, and a reference RS for a newly activated one TCI state does not satisfy an RLM RS selection reference, the reference RS of the existing one TCI state activated in the corresponding control resource set may be removed from the RLM RS set and thus the number of total RLM RSs may be reduced by 1. Further, when the reference RS for the newly activated one TCI state satisfies the RLM RS selection reference, the existing one TCI state activated in the corresponding control resource set may be removed from the RLM RS set and one reference RS satisfying the RLM RS selection reference may be selected as a new RLM RS from among reference RSs for the newly activated one TCI state.

In another example, when the number of TCI states of the control resource set is 2, all reference RSs of the existing two TCI states of the corresponding control resource set are selected as the RLM RSs (that is, two RLM RSs are selected in the corresponding control resource set), and all reference RSs for the newly activated two TCI states do not satisfy an RLM RS selection reference, the reference RSs of the existing two TCI states activated in the corresponding control resource set may be removed from the RLM RS set and thus the number of total RLM RSs may be reduced by 2. Further, when one of the reference RSs for the newly activated two TCI states satisfies the RLM RS selection reference, the reference RSs of the existing two TCI states activated in the corresponding control resource set are removed from the RLM RS set and one reference RS satisfying the RLM RS selection reference may be selected as an RLM RS from among the reference RSs for a newly activated one TCI state. That, the number of total RLM RSs may be reduced by 1. Further, when all of the reference RSs for the newly activated two TCI states satisfy the RLM RS selection reference, the reference RSs of the existing two TCI states activated in the corresponding control resource are removed from the RLM RS set and two reference RSs satisfying the RLM RS selection reference may be selected as new RLM RSs from among the reference RSs for the newly activated two TCI states. In another example, when one of the reference RSs of the existing two TCI states of the corresponding control resource set is selected as an RLM RS (that is, one RLM RS is selected in the corresponding control resource set), all reference RSs of the newly activated two TCI states do not satisfy an RLM RS selection reference, the reference RS of the existing one TCI state activated in the corresponding control resource set may be removed from the RLM RS set and thus the number of total RLM RSs may be reduced by 1. Further, when one of the reference RSs for the newly activated two TCI states satisfies the RLM RS selection reference, the reference RS of the existing one TCI state activated in the corresponding control resource is removed from the RLM RS set and one reference RS satisfying the RLM RS selection reference may be selected as a new RLM RS from among the reference RSs for the newly activated one TCI state, and thus the number of total RLM RSs may be maintained. When all reference RSs for the newly activated two TCI states satisfy the RLM RS selection reference, the reference RS of the existing one TCI state activated in the corresponding control resource set is removed from the RLM RS set and two reference RSs satisfying the RLM RS selection reference may be selected as new RLM RSs from among the reference RSs for the newly activated two TCI states, and thus the number of total RLM RSs may be increased.

Method 7-2, Method of Controlling Number of Total RLM RSs to not Vary According to MAC-CE Activation

When the number of TCI states of control resource sets are maintained through a PDCCH TCI state activation/deactivation MAC-CE, the number of TCI state of a specific control resource set may be maintained from 1 to 2 or from 2 to 2, but information on activated TCI states may be changed.

At this time, when the number of TCI states of the control resource set is 1, a reference RS of the existing one TCI state of the corresponding control resource set is selected as the RLM RS, and a reference RS for a newly activated one TCI state does not satisfy an RLM RS selection reference, the reference RS of the existing one TCI state activated in the corresponding control resource set may be removed from the RLM RS set and the removed number of RLM RSs may be additionally selected according to the various RLM RS selection methods (in the corresponding example, one RLM RS may be additionally selected). When there is no RLM RS selected through an additional RLM RS selection method, the number of total RLM RSs may be reduced by 1 (or the UE may not expect that the number of total RLM RSs is changed). Further, when a reference RS for newly activated one TCI state satisfies the RLM RS selection reference, the reference RS of the existing one TCI state activated in the corresponding control resource is removed from the RLM RS set and one reference RS satisfying the RLM RS selection reference may be selected as a new RLM RS from among the reference RSs for newly activated one TCI state, in which case an additional RLM RS may not be selected.

In another example, when the number of TCI states of the control resource set is 2, all reference RS of the existing two TCI states of the corresponding control resource set are selected as RLM RSs (that is, two RLM RSs are selected in the corresponding control resource set), and all reference RS for the newly activated two TCI states do not satisfy an RLM RS selection reference, the reference RSs of the existing two TCI states activated in the corresponding control resource set may be removed from the RLM RS set and the removed number of RLM RSs may be additionally selected according to the various RLM RS selection methods (in the corresponding example, two RLM RSs may be additionally selected). When there is no RLM RS selected through an additional RLM RS selection method, the number of total RLM RSs may be reduced by 2 or 1 (or the UE may not expect that the number of total RLM RSs is changed). Further, when one of the reference RSs for the newly activated two TCI states satisfies the RLM RS selection reference, the reference RSs of the existing two TCI states activated in the corresponding control resource are removed from the RLM RS set and one reference RS satisfying the RLM RS selection reference may be selected as a new RLM RS from among the reference RSs for the newly activated two TCI states and the removed number of RLM RSs may be additionally selected according to the various RLM RS selection methods (in the corresponding example, one RLM RS may be additionally selected). When there is no RLM RS selected through an additional RLM RS selection method, the number of total RLM RSs may be reduced by 1 (or the UE may not expect that the number of total RLM RSs is changed). Further, when two reference RSs satisfy the RLM RS selection reference among the reference RSs for the newly activated two TCI states, the reference RSs of the existing two TCI states activated in the corresponding control resource are removed from the RLM RS set and reference RSs for the newly activated two TCI states may be selected as new RLM RSs and thus the number of total RLM RSs may not be changed. In another example, when one of the reference RSs of the existing two TCI states of the control resource set is selected as the RLM RS (that is, one RLM RS is selected in the corresponding control resource set), all reference RS for the newly activated two TCI states do not satisfy an RLM RS selection reference, the reference RS of the existing one TCI state activated in the corresponding control resource set may be removed from the RLM RS set and the removed number of RLM RSs may be additionally selected according to various RLM RS selection methods (in the corresponding example, one RLM RS may be additionally selected). Further, when one of the reference RSs for the newly activated two TCI states satisfies the RLM RS selection reference, the reference RS of the existing one TCI state activated in the corresponding control resource is removed from the RLM RS set and one reference RS satisfying the RLM RS selection reference may be selected as a new RLM RS from among the reference RSs for the newly activated one TCI state, and thus the number of total RLM RSs may be maintained. In addition, when reference RSs for the newly activated two TCI states satisfy the RLM RS selection reference, the reference RS of the existing one TCI state activated in the corresponding control resource may be removed from the RLM RS set and new RLM RSs may be selected to not exceed the number of existing RLM RSs selected from the corresponding control resource set in consideration of priorities of two or more reference RSs satisfying the RLM RS selection reference among the reference RSs for the newly activated two TCI states. At this time, as the priority, a specific order of TCI states activated in the control resource set (first or second TCI state is prioritized), a TCI state index (higher or lower TCI state index is prioritized), a reference RS period (shorter or longer period is prioritized), and the like may be considered.

### Embodiment 8: RLM RS Selection Method when Number of TCI States is Changed Due to MAC-CE

As an embodiment of the disclosure, an RLM RS selection method is described in detail when no RadioLinkMonitoringRS is configured, some control resource sets have one TCI state and the remaining control resource sets have two TCI states within an activated downlink bandwidth part and when the number of TCI states of the control resource set is changed through a PDCCH TCI state activation/deactivation MAC-CE according to various conditions such as the UE capability report or whether higher-layer signaling is configured or not in Embodiment 4-1.

Method 8-1, Method of Varying Number of Total RLM RSs According to MAC-CE Activation

When the number of TCI states of the control resource set is changed through a PDCCH TCI state activation/deactivation MAC-CE, the number of TCI state of a specific state may increase from 1 to 2 or decrease from 2 to 1.

At this time, when the number of TCI states of the control resource set increases 1 to 2, a reference RS of the existing one TCI state of the corresponding control resource set is selected as the RLM RS, and all reference RSs for the newly activated two TCI states do not satisfy an RLM RS selection reference, the reference RS of the existing one TCI state activated in the corresponding control resource set may be removed from the RLM RS set and thus the number of total RLM RSs may be reduced by 1. Further, when one of the reference RSs for the newly activated two TCI states satisfies the RLM RS selection reference, the reference RS of the existing one TCI state activated in the corresponding control resource may be removed from the RLM RS set and one reference RS satisfying the RLM RS selection reference may be selected as a new RLM RS from among the reference RSs for the newly activated two TCI states. In addition, when two or more reference RSs for the newly activated two TCI states satisfy the RLM RS selection reference, the reference RS of the existing one TCI state activated in the corresponding control resource set may be removed from the RLM RS set and all of the two or more reference RSs satisfying the RLM RS selection reference may be selected as the RLM RSs from among the reference RSs for the newly activated two TCI states. That is, the total number of RLM RSs may increase.

In another example, when the number of TCI states of the control resource set decreases from 2 to 1, all reference RSs of the existing two TCI states of the corresponding control resource set are selected as the RLM RSs (that is, two RLM RSs are selected in the corresponding control resource set), and a reference RS for newly activated one TCI state does not satisfy an RLM RS selection reference, the reference RSs of the existing two TCI states activated in the corresponding control resource set may be removed from the RLM RS set and thus the number of all RLM RSs may be reduced by 2. Further, when one of the reference RSs for the newly activated one TCI state satisfies the RLM RS selection reference, the reference RSs of the existing two TCI states activated in the corresponding control resource are removed from the RLM RS set and one reference RS satisfying the RLM RS selection reference may be selected as an RLM RS from among the reference RSs for newly activated one TCI state. That, the number of total RLM RSs may be reduced by 1. In another example, when one of the reference RSs of the existing two TCI states of the corresponding control resource set is selected as an RLM RS (that is, one RLM RS is selected in the corresponding control resource set) and reference RSs for newly activated one TCI state do not satisfy an RLM RS selection reference, the reference RS of the existing one TCI state activated in the corresponding control resource set may be removed from the RLM RS set and thus the number of total RLM RSs may be reduced by 1. Further, when one of the reference RSs for the newly activated one TCI state satisfies the RLM RS selection reference, the reference RS of the existing one TCI state activated in the corresponding control resource may be removed from the RLM RS set and one reference RS satisfying the RLM RS selection reference may be selected as a new RLM RS from among the reference RSs for the newly activated one TCI state, and thus the number of total RLM RSs may be maintained.

Method 8-2, Method of Controlling Number of Total RLM RSs to not Vary According to MAC-CE Activation

When the number of TCI states of the control resource set is changed through a PDCCH TCI state activation/deactivation MAC-CE, the number of TCI state of a specific state may increase from 1 to 2 or decrease from 2 to 1.

At this time, when the number of TCI states of the control resource set increases from 1 to 2, a reference RS of the existing one TCI state of the corresponding control resource set is selected as the RLM RS, and all reference RSs for the newly activated two TCI states do not satisfy an RLM RS selection reference, the reference RS of the existing one TCI state activated in the corresponding control resource set may be removed from the RLM RS set and the removed number of RLM RSs may be additionally selected according to the various RLM RS selection methods (in the corresponding example, one RLM RS may be additionally selected). When there is no RLM RS selected through an additional RLM RS selection method, the number of total RLM RSs may be reduced by 1 (or the UE may not expect that the number of total RLM RSs is changed). Further, when one of the reference RSs for the newly activated two TCI states satisfies the RLM RS selection reference, the reference RS of the existing one TCI state activated in the corresponding control resource may be removed from the RLM RS set and one reference RS satisfying the RLM RS selection reference may be selected as a new RLM RS from among the reference RSs for the newly activated two TCI states, in which case an additional RLM RS may not be selected. In addition, when two or more reference RSs for the newly activated two TCI states satisfy the RLM RS selection reference, the reference RS of the existing one TCI state activated in the corresponding control resource set may be removed from the RLM RS set and new RLM RSs may be selected to not exceed the number of existing RLM RSs selected from the corresponding control resource set in consideration of priorities of two or more reference RSs satisfying the RLM RS selection reference among the reference RSs for the newly activated two TCI states. At this time, as the priority, a specific order of TCI states activated in the control resource set (first or second TCI state is prioritized), a TCI state index (higher or lower TCI state index is prioritized), a reference RS period (shorter or longer period is prioritized), and the like may be considered.

When the number of TCI states of the control resource set decreases from 2 to 1, all reference RSs for the existing two TCI states of the corresponding control resource set are selected as RLM RSs (that is, two RLM RSs are selected in the corresponding control resource set), and the reference RS for newly activated one TCI state does not satisfy the RLM RS selection reference, reference RSs of the existing two TCI states activated in the corresponding control resource set may be removed from the RLM RS set and RLM the removed number of RLM RSs may be additionally selected according to the various RLM selection methods (in the corresponding example, two RLM RSs may be additionally selected). When there is no RLM RS selected through an additional RLM RS selection method, the number of total RLM RSs may be reduced by 2 or 1 (or the UE may not expect that the number of total RLM RSs is changed). Further, when the reference RS for newly activated one TCI state satisfies the RLM RS selection reference, reference RSs of the existing two TCI states activated in the corresponding control resource set may be removed from the RLM RS set, one reference RS satisfying the RLM RS selection reference may be selected as a new RLM RS from among the reference RSs for newly activated one TCI state, and the removed number of RLM RSs may be additionally selected according to the various RLM RS selection methods (in the corresponding example, one RLM RS may be additionally selected). When there is no RLM RS selected through an additional RLM RS selection method, the number of total RLM RSs may be reduced by 1 (or the UE may not expect that the number of total RLM RSs is changed). In another example, when one of the reference RSs of the existing two TCI states of the control resource set is selected as the RLM RS (that is, one RLM RS is selected in the corresponding control resource set), the reference RS for newly activated one TCI state does not satisfy an RLM RS selection reference, the reference RS of the existing one TCI state activated in the corresponding control resource set may be removed from the RLM RS set and the removed number of RLM RSs may be additionally selected according to various RLM RS selection methods (in the corresponding example, one RLM RS may be additionally selected). Further, when one of the reference RSs for the newly activated one TCI state satisfies the RLM RS selection reference, the reference RS of the existing one TCI state activated in the corresponding control resource may be removed from the RLM RS set and one reference RS satisfying the RLM RS selection reference may be selected as a new RLM RS from among the reference RSs for the newly activated one TCI state, and thus the number of total RLM RSs may be maintained.

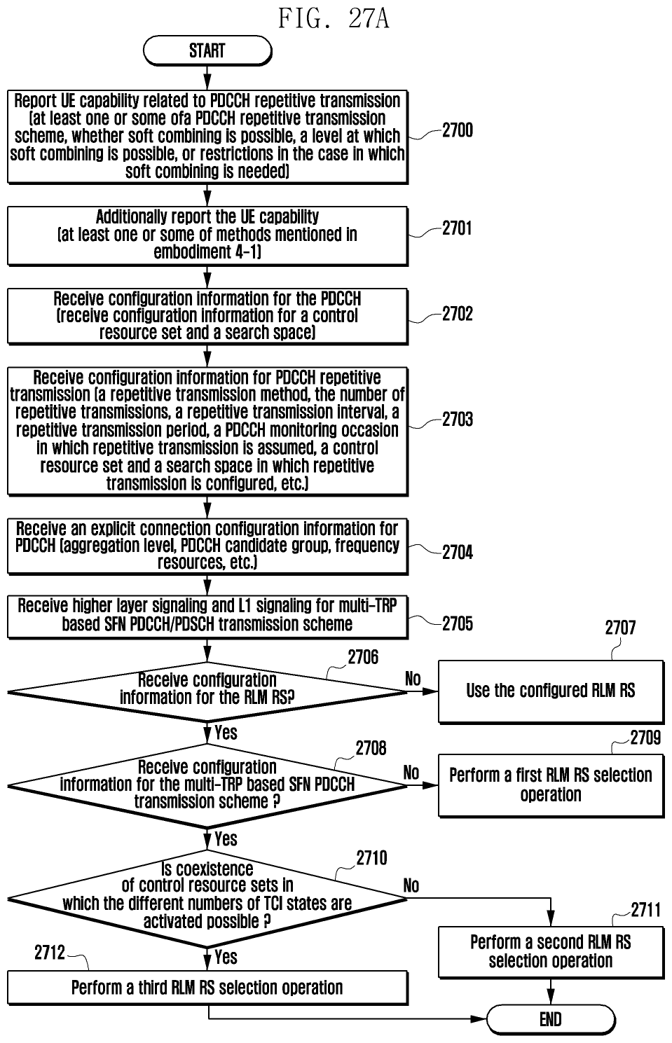

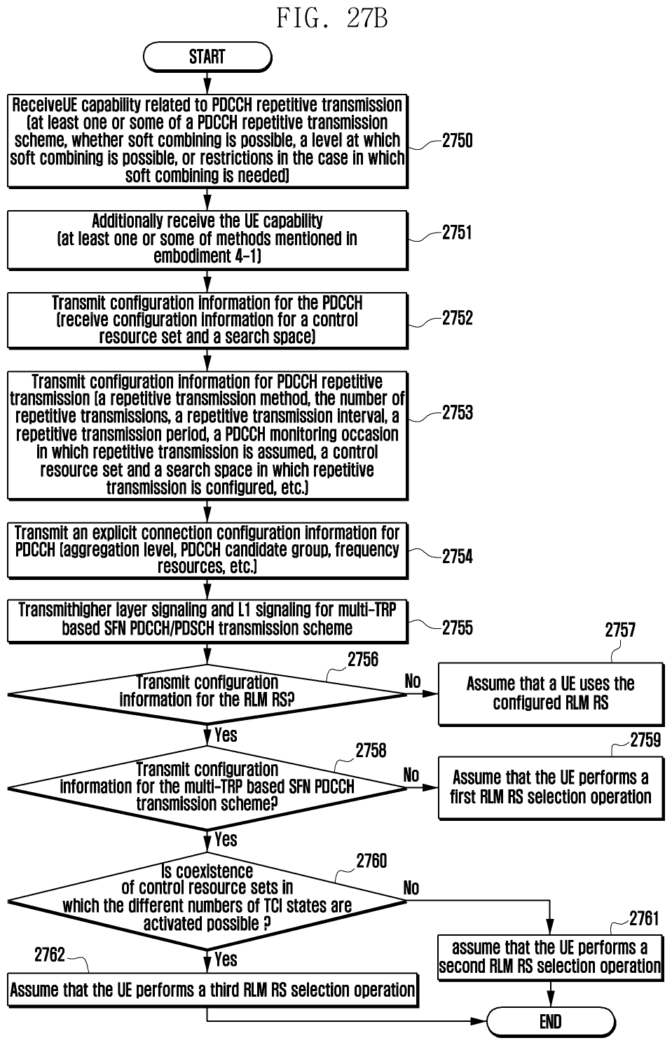

FIG. 27A illustrates operations of a UE for an RLM RS selection method according to an embodiment of the disclosure. FIG. 27B illustrates operations of a BS for an RLM RS selection method according to an embodiment of the disclosure.

Referring to FIGS. 27A and 27B, the UE may report information related to PDCCH repetitive transmission to the BS through a UE capability in operation 2700. That is, the BS may receive the UE capability including information related to PDCCH repetitive transmission in operation 2750. For example, the information related to the PDCCH repetitive transmission may include at least one of a PDCCH repetitive transmission scheme, whether soft combining is possible, a level at which soft combining is possible, or restrictions in the case in which soft combining is needed.

The UE may additionally report the UE capability for multi-TRP-based SFN PDCCH and PDSCH transmission (for example, at least one or some of the UE capabilities mentioned in embodiment 4-1) to the BS in operation 2701. That is, the BS may additionally receive the UE capability for multi-TRP-based SFN PDCCH and PDSCH transmission (for example, at least one or some of the UE capabilities mentioned in embodiment 4-1) from the UE in operation 2751.

The UE may receive configuration information for the PDCCH from the BS in operation 2702. That is, the BS may transmit the configuration information for the PDCCH to the UE on the basis of the UE capability in operation 2752. For example, the configuration information for the PDCCH may include configuration information for a control resource set and a search space.

The UE may receive configuration information for PDCCH repetitive transmission from the BS in operation 2703. That is, the BS may additionally transmit the configuration information for PDCCH repetitive transmission to the UE in operation 2753. For example, the configuration information for PDCCH repetitive transmission may include a repetitive transmission method, the number of repetitive transmissions, a repetitive transmission interval, a repetitive transmission period, a PDCCH monitoring interval in which repetitive transmission is assumed, a control resource set and a search space in which repetitive transmission is configured, and the like.

The UE may receive information related to an explicit connection configuration for the PDCCH repetitive transmission from the BS in operation 2704. That is, the BS may additionally transmit the information related to explicit connection configuration for the PDCCH repetitive transmission in operation 2754. For example, the information related to explicit connection configuration for the PDCCH repetitive transmission may include an aggregation level, a PDCCH candidate group, frequency resources, and the like.

The UE may receive a configuration for a multi-TRP-based SFN PDCCH/PDSCH transmission scheme from the BS in operation 2705. That is, the BS may transmit the configuration for the multi-TRP-based SFN PDCCH/PDSCH transmission scheme to the UE in operation 2755. The configuration may be indicated and configured by L1 signaling, higher-layer signaling, or a combination of L1 signaling and higher-layer signaling. This may be based on at least one of the various schemes mentioned in embodiment 4 above.

When the UE receives configuration information for the RLM RS from the BS in operation 2706, the UE may perform a link monitoring operation using the RLM RS on the basis of the corresponding configuration information in operation 2707. That is, when the BS transmits configuration information for the RLM RS to the UE in operation 2756, the BS may assume that the UE performs a link monitoring operation using the RLM RS on the basis of the corresponding configuration information in operation 2757.

When the UE does not receive the configuration information for the RLM RS from the BS in operation 2706 and does not receive configuration information for the multi-TRP-based SFN PDCCH transmission scheme in operation 2708, the UE may perform a first RLM RS selection operations in operation 2709. That is, when the BS does not transmit the configuration information for the RLM RS to the UE in operation 2756 and does not transmit configuration information for the multi-TRP-based SFN PDCCH transmission scheme in operation 2758, the BS may assume that the UE performs a first RLM RS selection operations in operations 2759. The first RLM RS selection operations may be a method based on RLM RS selection methods 1 to 4 which have been described as the method that can be used when one TCI state is activated for all control resource sets.

When the UE receives the configuration information for the multi-TRP-based SFN PDCCH transmission scheme in operation 2708 and coexistence of control resource sets in which the different numbers of TCI states are activated is not possible in operation 2710, the UE may perform a second RLM RS selection operation in operation 2711. That is, when the BS transmits the configuration information for the multi-TRP-based SFN PDCCH transmission scheme to the UE in operation 2758 and coexistence of control resource sets in which the different numbers of TCI states are activated is not possible in operation 2760, the BS may assume that the UE performs a second RLM RS selection operation in operation 2761. The second RLM RS selection operation may be available as one of methods 5-1 to 5-4 mentioned in embodiment 5 and one of methods 7-1 to 7-2 mentioned in embodiment 7.

When the UE receives the configuration information for the multi-TRP-based SFN PDCCH transmission scheme in operation 2708 and coexistence of control resource sets in which the different numbers of TCI states are activated is possible in operation 2710, the UE may perform a third RLM RS selection operation in operation 2712. That is, when the BS transmits the configuration information for the multi-TRP-based SFN PDCCH transmission scheme to the UE in operation 2758 and coexistence of control resource sets in which the different numbers of TCI states are activated is possible in operation 2760, the BS may assume that the UE performs the third RLM RS selection operation in operation 2762. The third RLM RS selection operation may be available as one of methods 6-1 to 6-3 mentioned in embodiment 6, and one of methods 7-1 to 7-2 mentioned in embodiment 7, and one of methods 8-1 to 8-2 mentioned in embodiment 8.

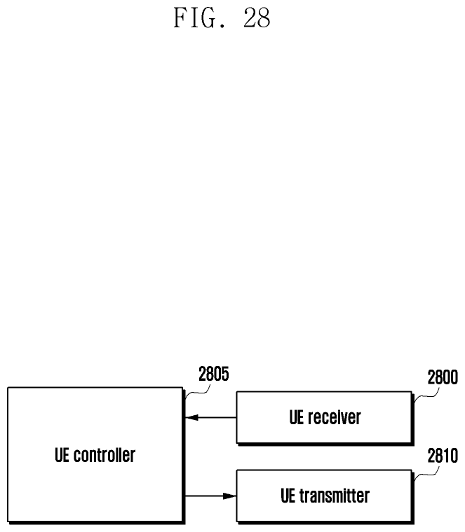

FIG. 28 illustrates a structure of a UE in a wireless communication system, according to an embodiment of the disclosure.

Referring to FIG. 28, the UE may include a transceiver including a UE receiver 2800 and a UE transmitter 2810, a memory, and a UE processor 2805 (or a UE controller or a processor). The transceiver is made up of the receiver 2800 and the UE transmitter 2810. The memory and the UE processor 2805 may operate according to the above-described communication method of the UE. However, the elements of the UE are not limited to the above example. For example, the UE may include more or fewer elements than the above elements. Also, the transmitter 2810, the memory, and the processor may 2805 be implemented in the form of a single chip.

The transceiver 2800, 2810 may transmit and receive a signal to and from the BS. The signal may include control information and data. To this end, the transceiver 2800, 2810 may include a radio frequency (RF) transmitter for up-converting and amplifying a frequency of the transmitted signal and an RF receiver for low-noise amplifying the received signal and down-converting the frequency. However, this is only an example of the transceiver, and elements of the transceiver are not limited to the RF transmitter and the RF receiver.

The transceiver 2800, 2810 may receive a signal through a radio channel, output the signal to the processor 2805, and transmit the signal output from the processor 2805 through the radio channel.

The memory may store a program and data required for the operation of the UE. Further, the memory may store control information or data included in the signal transmitted and received by the UE. The memory may be configured by storage media such as a read only memory (ROM), a random access memory (RAM), a hard disc, a compact disc (CD)-ROM, and a digital versatile disc (DVD), or a combination of the storage media. The number of memories may be plural.

The processor 2805 may control a series of processes to allow the UE to operate according to the above embodiments. For example, the processor 2805 may control elements of the UE to receive DCI including two layers and simultaneously receive a plurality of PDSCHs. For example, the processor 2805 may configured to receive, via the transceiver 2800, 2810, an activation information for indicating at least one transmission configuration indicator (TCI) state for a control resource set (CORESET), identify a first plurality of TCI states corresponding to a first CORESET and a second plurality of TCI states corresponding to a second CORESET, based on the activation information, and select a reference signal for radio link monitoring based on the first plurality of TCI states and the second plurality of TCI states. The number of processors 2805 may be plural, and the processor 2805 may perform an operation of controlling the elements of the UE by executing the program stored in the memory.

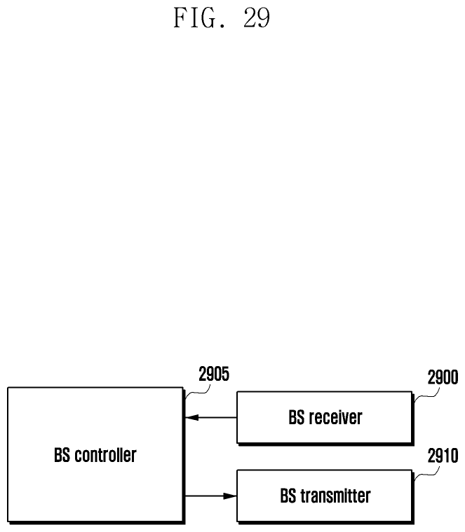

FIG. 29 illustrates a structure of a BS in a wireless communication system, according to an embodiment of the disclosure.

Referring to FIG. 29, the BS may include a transceiver including a BS receiver 2900 and a BS transmitter 2910, a memory, and a BS processor 2905 (or a BS controller or a processor). The transceiver may include the receiver 2900 and the transmitter 2910 of the BS, the memory, and the BS processor 2905 may operate according to the communication method of the BS. However, the elements of the BS are not limited to the above example. For example, the BS may include more or fewer elements than the above-described elements. Also, the transceiver 2910, the memory, and the processor 2905 may be implemented in the form of a single chip.

The transceiver 2900, 2910 may transmit and receive a signal to/from the UE. The signal may include control information and data. To this end, the transceiver 2900, 2910 may include an RF transmitter for up-converting and amplifying a frequency of the transmitted signal and an RF receiver for low-noise amplifying the received signal and down-converting the frequency. However, this is only an example of the transmitter 2900, 2910, and elements of the transceiver are not limited to the RF transmitter and the RF receiver.

The transceiver 2900, 2910 may receive a signal through a radio channel, output the signal to the processor 2905, and transmit the signal output from the processor through the radio channel.

The memory may store a program and data required for the operation of the BS. The memory may store control information or data included in a signal transmitted and received by the BS. The memory may be configured by storage media such as ROM, RAM, hard disc, CD-ROM, and DVD, or a combination of the storage media. The number of memories may be plural.

The processor 2905 may control a series of processes to allow the BS to operate according to the embodiments of the disclosure. For example, the processor 2905 may configure to control each element of the BS to configure DCI of two layers including allocation information of a plurality of PDSCHs and transmit the DCI. For example, the processor 2905 may configured to transmit, via the transceiver 2900, 2910, an activation information for indicating at least one transmission configuration indicator (TCI) state for a control resource set (CORESET), and identify that a terminal selects a reference signal for radio link monitoring based on the first plurality of TCI states and the second plurality of TCI states. The first plurality of TCI states corresponds to a first CORESET and the second plurality of TCI states corresponds to a second CORESET, based on the activation information. The number of processors 2905 may be plural, and the processor 2905 may perform an operation of controlling the elements of the BS by executing the program stored in the memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable read only memory (EEPROM), a magnetic disc storage device, a CD-ROM, DVDs, other type optical storage devices, or a magnetic cassette. Alternatively, any combination of some or all of the memory devices may form a memory in which the program is stored. Further, a plurality of such memories may be included in the electronic device.

In addition, the programs may be stored in an attachable storage device which may access the electronic device through communication networks such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with other embodiments to operate a BS and a terminal. As an example, a first and second embodiment of the disclosure may be combined with each other to operate a BS and a terminal. Further, although the above embodiments have been described on the basis of the FDD LTE system, other variants based on the technical idea of the embodiments may also be implemented in other communication systems such as TDD LTE, 5G, or NR systems.

In the drawings in which methods of the disclosure are described, the order of the description does not always correspond to the order in which steps of each method are performed, and the order or relationship between the steps may be changed or the steps may be performed in parallel.

Alternatively, in the drawings in which methods of the disclosure are described, some elements may be omitted and only some elements may be included therein without departing from the essential spirit and scope of the disclosure.

Further, in methods of the disclosure, some or all of the contents of each embodiment may be combined without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving an activation information for indicating at least one transmission configuration indicator (TCI) state for a control resource set (CORESET);
identifying a first plurality of TCI states corresponding to a first CORESET and a second plurality of TCI states corresponding to a second CORESET, based on the activation information; and
selecting a reference signal for radio link monitoring based on the first plurality of TCI states and the second plurality of TCI states.

2. The method of claim 1, further comprising:
identifying a number of reference signals for the radio link monitoring based on a maximum number of SS/PBCH blocks within a half frame,
wherein the selecting of the reference signal comprises selecting reference signals corresponding to the number of reference signals.

3. The method of claim 2, wherein the reference signals are selected based on a first TCI state of each of the first plurality of TCI states and the second plurality of TCI states.

4. The method of claim 1, further comprising:
receiving configuration information on each CORESET including information indicating a TCI state used for selecting the reference signal,
wherein the reference signal is selected based on the TCI state indicated by the information.

5. The method of claim 1,
wherein TCI states used for selecting the reference signal are determined based on priorities of CORESETs,
wherein the priorities of CORESETs are ordered from a CORESET associated with a search space set with a shortest periodicity,
wherein for CORESETs associated with search space sets having same periodicity, the priorities of CORESETs are ordered from a CORESET with a highest CORESET index, and
wherein two TCI states corresponding the CORESET with the highest CORESET index are used in an order from a TCI state with a lower index.

6. The method of claim 1, further comprising:
combining a first reference signal corresponding to a first TCI state of the first CORESET and a second reference signal corresponding to a second TCI state of the first CORESET,
wherein the reference signal is selected based on combining of the first reference signal and the second reference signal.

7. The method of claim 6, wherein the first reference signal and the second reference signal correspond to a same quasi-co located (QCL) type.

8. The method of claim 1, further comprising:
identifying a single TCI state corresponding to a third CORESET based on the activation information,
wherein the reference signal for radio link monitoring is selected based on the first plurality of TCI states, the second plurality of TCI states, and the single TCI state.

9. The method of claim 8,
wherein TCI states used for selecting the reference signal are determined based on priorities of CORESETs, and
wherein the third CORESET with the single TCI state has a higher priority than the first CORESET and the second CORESET.

10. A terminal in a wireless communication system, the terminal comprising:
a transceiver; and
a processor coupled with the transceiver and configured to:
receive, via the transceiver, an activation information for indicating at least one transmission configuration indicator (TCI) state for a control resource set (CORESET),
identify a first plurality of TCI states corresponding to a first CORESET and a second plurality of TCI states corresponding to a second CORESET, based on the activation information, and
select a reference signal for radio link monitoring based on the first plurality of TCI states and the second plurality of TCI states.

11. The terminal of claim 10, wherein the processor is further configured to:
receive configuration information on each CORESET including information indicating a TCI state used for selecting the reference signal,
wherein the reference signal is selected based on the TCI state indicated by the information.

12. The terminal of claim 10,
wherein TCI states used for selecting the reference signal are determined based on priorities of CORESETs,
wherein the priorities of CORESETs are ordered from a CORESET associated with a search space set with a shortest periodicity,
wherein for CORESETs associated with search space sets having same periodicity, the priorities of CORESETs are ordered from a CORESET with a highest CORESET index, and
wherein two TCI states corresponding the CORESET with the highest CORESET index are used in an order from a TCI state with a lower index.

13. The terminal of claim 10, wherein the processor is further configured to:
combine a first reference signal corresponding to a first TCI state of the first CORESET and a second reference signal corresponding to a second TCI state of the first CORESET,
wherein the reference signal is selected based on combining of the first reference signal and the second reference signal.

14. The terminal of the claim 13, wherein the first reference signal and the second reference signal correspond to a same quasi-co located (QCL) type.

15. The terminal of claim 10, wherein the processor is further configured to:
identify a single TCI state corresponding to a third CORESET based on the activation information,
wherein the reference signal for radio link monitoring is selected based on the first plurality of TCI states, the second plurality of TCI states, and the single TCI state,
wherein TCI states used for selecting the reference signal are determined based on priorities of CORESETs, and
wherein the third CORESET with the single TCI state has a higher priority than the first CORESET and the second CORESET.
